(19) United States
(12) Patent Application Publication
(10) Pub. No.: US 2004/0111672 A1
(43) Pub. Date: Jun. 10, 2004

(54) System and method for extending scalable vector graphics capabilities

(75) Inventors: Gordon Bowman, Kemptville (CA); Peter Barrett, Ottawa (CA)

Correspondence Address: Norman P. Soloway, HAYES SOLOWAY P.C., 130 W. Cushing Street, Tucson, AZ, 85701, US

(73) Assignee: COREL CORPORATION

(21) Appl. No.: 10/678,842

(22) Filed: Oct. 3, 2003

(30) Foreign Application Priority Data
Dec. 9, 2002 (CA) 2,414,047

(51) Int. Cl. G06F 15/00

(52) U.S. Cl. 715/513

(57) ABSTRACT

A system for extending interactivity of a presentation markup language is provided. The system comprises a collection of designated elements, and a collection of associated instructions for performing functions on elements in the document object model. Each designated element comprises a namespace, and attributes for describing features of the designated element. The instructions associated with the designated elements.

### FIELD OF THE INVENTION

The invention relates to web application development. In particular, the invention relates to a system and method for extending scalable vector graphics capabilities.

### BACKGROUND OF THE INVENTION

Scalable Vector Graphics (SVG) has the potential to become the platform (markup language) of choice for building robust, dynamic and interactive web applications. However, SVG lacks many features that are desired for building such web applications. Features that are missing in SVG include coordinate mapping, projection mapping, mouse tracking, zooming, panning, selection ability, flow control, moving objects, zoom/pan immunity, and constraints.

Since these features are missing from SVG, building robust web applications requires extensive scripting. For example, a scripting language such as European Computer Manufacturers Association Script (ECMAScript) is required. There are many problems with using script. One problem is the fact that most web designers do not have the programming skills required for scripting.

One way to manipulate a DOM is to use scripting. However, many web designers do not have the programming skills required for DOM manipulation via scripting. Thus, programmers are needed to create the scripts for the designer. Programmers can be costly, plus it can take a long time to develop stable, fast code. Thus, it is desirable to have a system or method of manipulating a DOM that a designer with minimal programming knowledge may operate, and which could also aid even an experienced programmer to rapidly develop a web application.

One way of assisting designers and developers is to have pre-canned scripts for the most commonly required functionality. However, script is difficult to auto-generate. Supporting the insertion of pre-canned scripts via an integrated development environment (IDE) is both complicated and limiting. For example, the Microsoft (™) Visual Studio IDE can create auto-generated code for its Microsoft Foundation Classes (MFC) (which abstract the programmer from the core Win32 API's), making it easier and quicker to program Windows applications. However, limits must be imposed on the user. User-modification of the auto-generated code is discouraged, because it makes it difficult to regenerate the code from the project file, or to automatically modify the pre-generated code as a result of new user-defined parameters to the abstractions. Auto-generated script cannot easily be customized afterwards, unless the IDE absolves itself of all responsibility should the designer make modifications.

Software exists that allows one to map input XML markup to output markup, automatically generating extensible stylesheet language transformation XSLT (the most commonly used XML markup language for transforming XML markup to a different form of markup). However, script is difficult to data-map.

Script relies on full DOM support. Scripts are only as powerful as the DOM methods that the viewer supports. Although it is desirable to have all viewers support the entire spectrum of DOM methods, they currently do not. Thus one must write script that only uses the API's supported by all viewers, in order to ensure that the script works on all viewers (i.e., one must program towards the lowest common denominator).

Script is complex. Abstracting the DOM methods using dSVG markup has allowed for the creation of a more direct linkage between the syntax and the intent of the author. Take the example of a designer creating a new element dynamically in the DOM. The designer wishes to create a circle at a particular location in the DOM tree. To do it in script is quite complicated, requiring over a hundred lines of code. One must first use getElementById( ) to find the target element, and then either the parent or sibling element. One then uses createElement( ) to create the circle. If inserting beneath a parent, parent.appendChild( ) is used. If inserting before a sibling, sibling.insertBefore( ) is used. If inserting after a sibling sibling.nextSibling.insertBefore( ) is used, unless there is no nextSibling, in which case sibling.parentNode.appendChild( ) is used. The author may wish to insert it as, say, the fourth sibling from the top or bottom, requiring a loop to be written which counts the siblings and accounts for the fact that maybe there are not that many siblings. Or the author may wish the new element to be the parent of existing elements, which requires removal of those elements and appending them as the children of the new one. Then finally setAttribute( ) is used to set its identifier (ID) so that you can refer to it later.

Script is slower than native code. Scripts are interpreted, and thus provide slower performance than what would be possible with a natively-implemented markup language. Just having a script interpreter is a lot of overhead for a small device.

Script must use DOM interfaces. Scripts can only manipulate the DOM via the DOM methods, which are abstractions on top of the real object model used by the viewer. Natively-implemented markup could access the real object model directly, which may improve performance even more.

Script requires more data to transfer. Scripts greatly add to the amount of data needed to be transferred. This is a problem especially for small devices.

Finally, scripts are only as powerful as the DOM API's that the viewer supports. Currently, not all viewers support the entire spectrum of DOM API's. Thus, in order to ensure that the script will work on all viewers, one must write script that only uses the API's supported by all viewers.

The algorithm for determining the polynomial coefficients from a series of point-pairs is known as Singular Value Decomposition, which solves, in a least square sense, the overdetermined set of equations:

xᵢ′=Axᵢ+Byᵢ+C

yᵢ′=Dxᵢ+Eyᵢ+F

given 3 or more coordinate pairs {xᵢ′, yᵢ′; xᵢ, yᵢ}.

There exists software that has user interface (UI) for creating the point-pairs as well as a macro language for pulling the point-pairs in from a file, calculating the coefficients and transforming one coordinate space to another. The software can also convert between many different projection systems, using known algorithms. This software, however, does not support an XML markup language.

### SUMMARY OF THE INVENTION

It is an object of the invention to provide a novel system and method of manipulating a document object model that obviates or mitigates at least one of the problems described above.

In an aspect of the present invention, there is provided a system for extending interactivity of presentation markup languages. The system comprises a collection of designated elements, a collection of associated instructions for performing functions on elements in the document object model, the instructions associated with the designated elements, and an initialization function for directing the processing of one or more designated elements in the document object model. Each designated element comprises a name following a predetermined naming convention, and attributes for describing features of the designated element.

In another aspect of the present invention, there is provided a method of extending interactivity of presentation markup languages. The method comprises one or more of controlling statement flow of a web application, coordinate mapping of a web application, manipulating viewer behavior with respect to a web application, focussing a group of elements in a web application, constraining manipulable attributes of an element in a web application, and applying passive behavior to an element of a web application.

The controlling statement flow of a web application method comprises the steps of searching for a flow control element in a document object model of the web application, generating a function name associated with the flow control element, calling the generated function name and processing child elements of the flow control element.

The coordinate mapping of a web application method comprises the steps of searching for a coordinate mapping element in a document object model of the web application, generating a function name associated with the coordinate mapping element, and calling the generated function name.

The manipulating viewer behavior with respect to a web application method comprises the steps of searching for a viewer behavior element in a document object model of the web application, generating a function name associated with the viewer behavior element, and calling the generated function name.

The focussing a group of elements in a web application method comprises the steps of searching for a focus element in a document object model of the web application, generating a function name associated with the focus element, and calling the generated function name.

The constraining manipulable attributes of an element in a web application method comprises the steps of searching for a constraint element in a document object model of the web application, generating a function name associated with the constraint element, and calling the generated function name.

The applying passive behavior to an element of a web application method comprising the steps of searching for a designated attribute of the element in a document object model of the web application, generating a function name associated with the designated attribute, and calling the generated function name.

In another aspect of the present invention, there is provided a method of extending interactivity of presentation markup languages. The method comprises the steps of searching for a designated control element in the document object model, and calling a function associated with the designated control element.

In another aspect of the present invention, there is provided a method of controlling features of a web application. The method comprises the steps of adding a behavior element as a child of a designated element, receiving an event which is equal to an event attribute setting in the behavior element, and calling a script associated with the behavior element.

### BRIEF DESCRIPTIONS OF THE DRAWINGS

FIG. 1 shows a typical web display environment for displaying web pages and web applications.

FIG. 2 shows an example of a scalable vector graphics interactivity extension system, in accordance with an embodiment of the present invention.

FIG. 3 shows another example of a scalable vector graphics interactivity extension system, in accordance with the scalable vector graphics interactivity extension system.

FIG. 4 is a flowchart of an example of a method of manipulating a document object model of a web application at load time, in accordance with the scalable vector graphics interactivity extension system.

FIG. 5 is a flowchart of a method of a method manipulating a document object model of a web application in response to an event, in accordance with the scalable vector graphics interactivity extension system.

FIG. 6 is a flowchart of another example of an method of manipulating a document object model of a web application, in accordance with the scalable vector graphics interactivity extension system.

FIG. 7

### DETAILED DESCRIPTION OF THE PREFERRED EMBODIMENTS

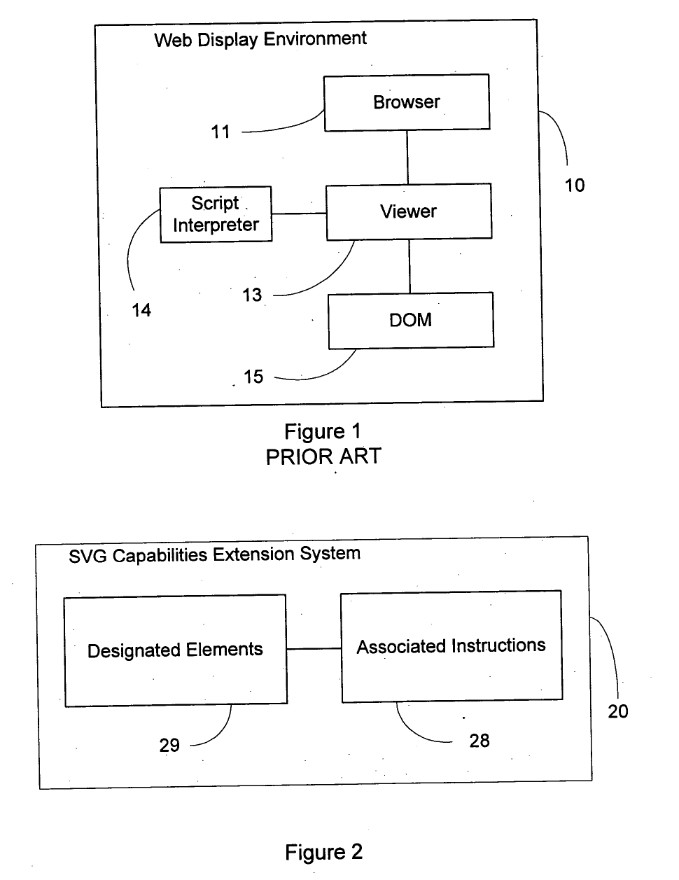

FIG. 1 shows a typical web display environment 10 for displaying web pages and web applications. A web display environment 10 comprises a browser 11, a viewer 13, a script interpreter 14, and a DOM 15. The browser 11 is the host application, which understands and visually renders hypertext markup language (HTML) and/or extensible hypertext markup language (XHTML). Examples of browsers include Netscape (™) and Internet Explorer (™). The browser 11 includes a window which is displayed on the display apparatus, such as a monitor, of an end user computer system. The browser 11 typically employs a plug-in architecture, in which third party software (known as the plug-in or viewer 13) can be associated with any file format that is not already natively supported by the browser 11 and is allowed to render that file within the host browser's 11 window. One type of file that the browser 11 may be asked to open is a Scalable Vector Graphic (SVG) file having a “.svg” extension. The browser 11 does not natively support the SVG markup language (which is an XML language) and so passes the SVG file to the SVG viewer 13, which has associated itself to the SVG file format, via the rules of the plug-in architecture of the browser 11.

The viewer 13 comprises software code for parsing the SVG markup, creating a DOM, rendering that DOM to the browser's window, listening for events and dispatching them to their assigned handler script functions, and interpreting/executing those script functions. An example of a viewer 13 is the Corel (™) SVG Viewer. The viewer 13 uses the SVG file received from the browser 11 to create a DOM 15. The DOM is a hierarchical tree structure of objects in memory, representing the hierarchical XML markup in the XML text file. The DOM also contains methods (also known as functions or application programming interfaces (API's)) that allow it to be queried or modified. The viewer 13 may also have access to a script interpreter/engine 14, which can execute script code created by a programmer for the purpose of making the document non-static (e.g., animation) and/or interactive with the user (e.g., the user can create events with the mouse or keyboard, which cause something to happen) via manipulation of the DOM.

The following common data types are used in this specification:

<boolean>: A <boolean> is specified as either ‘true’ or ‘false’.

<integer>: An <integer> is specified as an optional sign character (‘+’ or ‘−’) followed by one or more digits “0” to “9”. If the sign character is not present, the number is non-negative.

Unless stated otherwise for a particular attribute or property, the range for a <integer> encompasses (at a minimum) −2147483648 to 2147483647.

Within the SVG DOM, an <integer> is represented as an long or an SVGAnimatedInteger.

<number> (real number value): The specification of real number values is different for property values than for XML attribute values.

The Cascading Style Sheets, level 2 (CSS2) Specification—a style sheet language that allows one to attach style (e.g. fonts, spacing and aural cues) to structured documents (e.g. HTML documents and XML applications)—states that a property value which is a <number> is specified in decimal notation (i.e., a <decimal-number>), which consists of either an <integer>, or an optional sign character followed by zero or more digits followed by a dot (.) followed by one or more digits. Thus, for conformance with CSS2, any property in SVG which accepts <number> values is specified in decimal notation only.

For SVG's XML attributes, to provide as much scalability in numeric values as possible, real number values can be provided either in decimal notation or in scientific notation (i.e., a <scientific-number>), which consists of a <decimal-number> immediately followed by the letter “e” or “E” immediately followed by an <integer>.

Unless stated otherwise for a particular attribute or property, a <number> has the capacity for at least a single-precision floating point number (ICC32) and has a range (at a minimum) of −3.4e+38F to +3.4e+38F.

It is recommended that higher precision floating point storage and computation be performed on operations such as coordinate system transformations to provide the best possible precision and to prevent round-off errors.

Conforming High-Quality SVG Viewers are required to use at least double-precision floating point (ICC32) for intermediate calculations on certain numerical operations.

Within the SVG DOM, a <number> is represented as a float or an SVGAnimatedNumber.

<length>: A length is a distance measurement. The format of a <length> is a <number> optionally followed immediately by a unit identifier. (Note that the specification of a <number> is different for property values than for XML attribute values.)

If the <length> is expressed as a value without a unit identifier (e.g., 48), then the <length> represents a distance in the current user coordinate system.

If one of the unit identifiers is provided (e.g., 12 mm), then the <length> is processed according to the description in Units.

Percentage values (e.g., 10%) depend on the particular property or attribute to which the percentage value has been assigned. Two common cases are: (a) when a percentage value represents a percent of the viewport (refer to the section that discusses Units in general), and (b) when a percentage value represents a percent of the bounding box on a given object (refer to the section that describes Object bounding box units).

Within the SVG DOM, a <length> is represented as an SVGLength or an SVGAnimatedLength.

| <coordinate>: | A <coordinate> represents a <length> in the user coordinate system |
|---|---|
| | that is the given distance from the origin of the user coordinate |
| | system along the relevant axis (the x-axis for X coordinates, the |
| | y-axis for Y coordinates). |

Within the SVG DOM, a <coordinate> is represented as an SVGLength or an
SVGAnimatedLength since both values have the same syntax.

| <uri> (Uniform Resource Identifiers [URI] references): | A URI is the address |
|---|---|
| | of a resource on the |
| | Web. For the |
| | specification of URI |
| | references in SVG, |
| | see URI references. |

Within the SVG DOM, <uri> is represented as a DOMString or an SVGAnimatedString.

FIG. 2 shows a system 20 for extending the interactivity of presentation markup languages (e.g., scalable vector graphics (SVG), hypertext markup language (HTML)), in accordance with an embodiment of the present invention. The SVG interactivity extension system 20 comprises one or more designated elements 29, and one or more associated instructions (script or code) 28. Preferably, the one or more designated elements 29 map to the one or more associated instructions 28 on a one-to-one basis. The designated elements 29 comprise a namespace and attributes. The namespace of the designated elements may follow a predetermined naming convention. For example, a prefix may be added to the generic name of the designated element 29. In one example of an embodiment of an SVG interactivity extension system 20, the prefix “dsvg:” is added to the generic name of the designated element 29. Among the attributes of the element are name & xmlns (identifying that the element belongs to the dsvg). Other components may be added to the system 20, such as an initialization function having instructions for traversing each node in a DOM, searching for the designated elements 29 by searching for any element whose name is prefixed with the desired namespace (e.g., “dsvg:”), and calling the associated instructions 28 that is associated with each particular behavior element, whose name follows the predetermined naming convention.

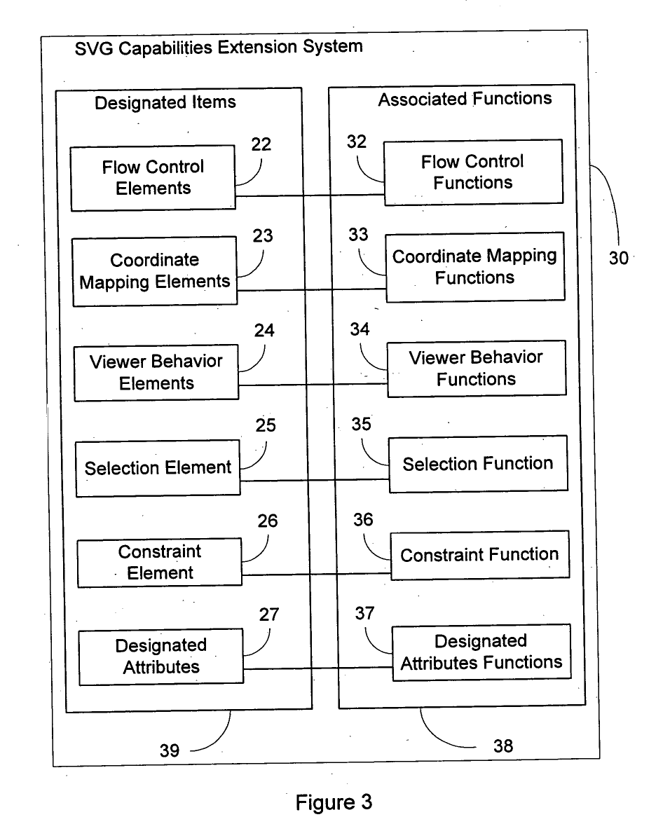

FIG. 3 shows another example of an SVG interactivity extension system 30. The SVG extension system 30 comprises a collection of designated items 39 and a collection of associated instructions (script or code) 38. The collection of designated items 39 comprises one or more of the following: flow control elements 22, coordinate mapping elements 23, viewer behavior elements 24, a focus element 25, a constraint element 26, and a set of passive attributes 27. The collection of associated instructions 38 comprise flow control instructions 32, coordinate mapping instructions 33, viewer behavior instructions 34, a focus instruction 35, a constraint instruction 36, and a set of passive attributes instruction 37. Items 38, 39 may be added or removed from the SVG interactivity extension system 30. An initialization file may be added as a component to the system 30 having instructions for traversing each node in a document object model (DOM) and for searching and calling functions associated with elements having names following a predetermined naming convention. The associated instructions 39 could be matched with the designated elements 38 through the initialization function (or file). Alternatively, the associated instructions 39 and designated elements 38 could be coded natively in a viewer 13.

Flow Control Elements 22

Flow control is desired for building web applications. With scripting, programmers have conditional evaluative expressions, such as “if” and “switch” statements, and looping.

A flow control element 22 is used to control statement flow of the web application. Flow control elements are used for conditional rendering of graphical elements or execution of behavior elements. Flow control elements 22 are inserted in a document object model (DOM) as parents of other DOM elements which are to be rendered or executed if the conditional flow statement of the parent flow control element is satisfied.

The attributes of a flow control element 22 may comprise one attribute having a complex expression representing the flow control statement. Preferably, multiple attributes are present, with each attribute representing one item in the expression representing the flow control statement. Having such a one-to-one mapping of multiple attributes to flow control statement items is advantageous for data mapping, where a web application designer desires to define variables from one data type into extensible markup language (XML). The associated instruction 32 performs actions associated with the flow control element 22.

Flow control elements 22 include the ‘if’ element, the ‘switch’ element, the ‘case’ element, the ‘default’ element, and the ‘loop’ element.

The ‘if’ Element

The ‘if’ element defines a simple conditional statement which, if evaluated to true, results in its child behavior elements being executed. Commonly used in conjunction with dSVG expressions for referencing the real-time value of element attributes.

<!ENTITY % ifExt “” >
<!ELEMENT dsvg:if (%Behaviors;) >
<!ATTLIST dsvg:if
%stdBehaviorAttrs;

| | | |
|---|---|---|
| value1 | %Text; | #IMPLIED |
| op | %Operator; | #IMPLIED |
| value2 | %Text; | #IMPLIED > |

Attribute Definitions:

value1=‘<string>’

The first of two values to be compared.

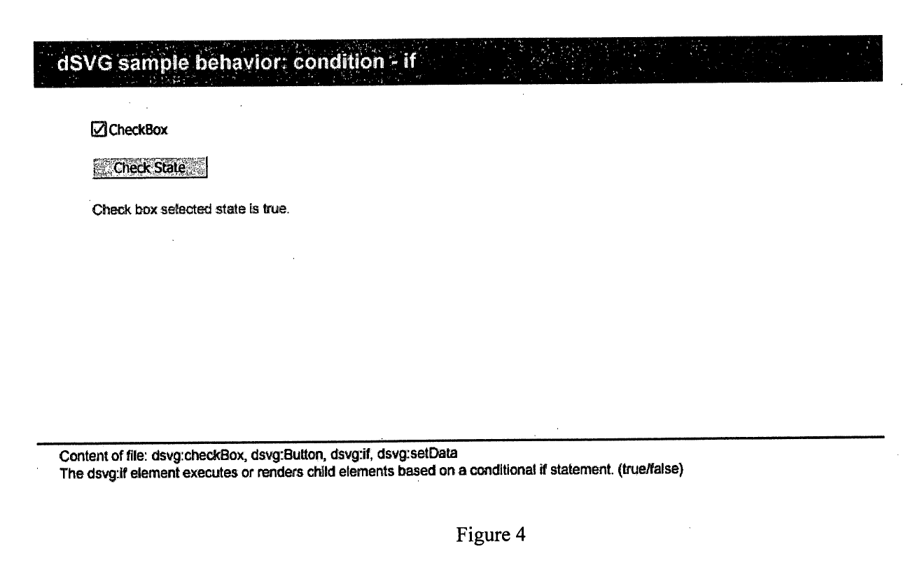

```
op = “(equal | notEqual | lessThan | greaterThan | lessThanOrEqual |
greaterThanOrEqual)”
    The operation to use in comparing the two values.
value2 =‘<string>’
    The second of two values to be compared.
    Figure 4 shows a push button 101 with associated ‘if’ behaviors. The if element
executes or renders child elements based on a conditional if statement. (true/false). The
example is provided below:
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
    <script type=“text/ecmascript” xlink:href=“dsvg11/dSVG.js”/>
    <script type=“text/ecmascript” xlink:href=“dsvg11/baseUI.js”/>
    <script type=“text/ecmascript” xlink:href=“dsvg11/constraint.js”/>
    <script type=“text/ecmascript” xlink:href=“dsvg11/button.js”/>
    <script type=“text/ecmascript” xlink:href=“dsvg11/if.js”/>
    <script type=“text/ecmascript” xlink:href=“dsvg11/setData.js”>
    <!-- template -->
    <rect height=“40” width=“744” y=“0” x=“0” fill=“#5f86B1” id=“title_rect”/>
    <text y=“25” x=“20” font-weight=“bold” font-size=“18” fill=“white”
id=“text_1”>dSVG sample behavior: condition - if
    </text>
    <line y2=“350” x2=“744” y1=“350” x1=“0” stroke-width=“2” stroke=“#5f86B1”
fill=“#5f86B1” id=“bottom_line”/>
    <text y=“365” x=“20” font-size=“12” id=“content”>Content of file:
dsvg:checkBox, dsvg:Button, dsvg:if, dsvg:setData
    </text>
    <text y=“380” x=“20” font-size=“12” id=“expected”>The dsvg:if element
executes or renders child elements based on a conditional if statement. (true/false)
    </text>
    <!-- adding behavior -->
    <dsvg:checkBox xlink:href=“dsvg11/skinCheckBox_Default.svg#skinCheckBox”
autoScale=“true” disabled=“false” selected=“false” height=“12” width=“12” y=“70”
x=“50” label=“CheckBox” id=“checkBox1”/>
    <dsvg:button xlink:href=“dsvg11/skinButton_Windows.svg#skinButton”
autoScale=“true” disabled=“false” selected=“false” toggle=“false” height=“18”
width=“100” y=“100.5” x=“50.5” label=“Check State” id=“dsvgUniqueID_1”>
        <dsvg:if value2=“true” op=“equal” value1=“%checkBox1@selected%”
id=“dsvgUniqueID_2”>
            <dsvg:setData value=“Check box selected state is true.”
elementID=“label1” id=“dsvgUniqueID_3”/>
        </dsvg:if>
        <dsvg:if value2=“true” op=“notEqual” value1=“%checkBox1@selected%”
id=“dsvgUniqueID_4”>
            <dsvg:setData value=“Check box selected state is false.”
elementID=“label1” id=“dsvgUniqueID_5”/>
        </dsvg:if>
    </dsvg:button>
    <text y=“150” x=“50” fill=“#5f86B1” id=“label1”>Label
    </text>
</svg>
```

The ‘switch’ element

The ‘switch’ element defines a conditional statement, comparing one value to other values defined in child ‘case’ elements. Commonly used in conjunction with dSVG expressions for referencing the real-time value of variables or element attributes.

| <!ENTITY % switchExt “” > | |
|---|---|
| <!ELEMENT dsvg:switch | (%Behaviors;) > |
| <!ATTLIST dsvg:switch | |
| %stdBehaviorAttrs; | |
| variable %Text; | #IMPLIED > |
| Attribute definitions: | |
| variable = ‘<string>’ | |

Specifies the value to compare against many others, which are defined in the child ‘case’ elements. Usually, ‘variable’ will be a dSVG expression.

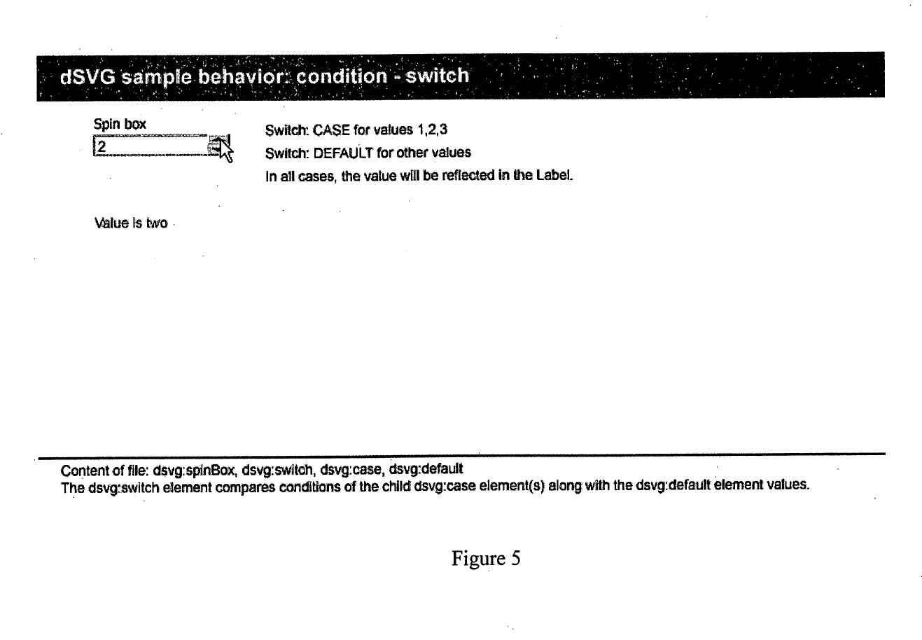

FIG. 5 shows a comboBox 105 with an associated ‘switch’ behavior, resulting in one of four ‘setData’ behaviors being run. The switch element compares conditions of the child case element(s) along with the default element values. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
    <script type=“text/ecmascript” xlink:href=“dsvg11/dSVG.js”/>
    <script type=“text/ecmascript” xlink:href=“dsvg11/baseUI.js”/>
    <script type=“text/ecmascript” xlink:href=“dsvg11/constraint.js”/>
    <script type=“text/ecmascript” xlink:href=“dsvg11/spinBox.js”/>
    <script type=“text/ecmascript” xlink:href=“dsvg11/textbox.js”/>
    <script type=“text/ecmascript” xlink:href=“dsvg11/button.js”/>
    <script type=“text/ecmascript” xlink:href=“dsvg11/switch.js”/>
    <script type=“text/ecmascript” xlink:href=“dsvg11/setData.js”/>
    <!-- template -->
    <rect height=“40” width=“744” y=“0” x=“0” fill=“#5f86B1” id=“title_rect”/>
    <text y=“25” x=“20” font-weight=“bold” font-size=“18” fill=“white”
id=“text_1”>dSVG sample behavior: condition - switch
    </text>
    <line y2=“350” x2=“744” y1=“350” x1=“0” stroke-width=“2” stroke=“#5f86B1”
fill=“#5f86B1” id=“bottom_line”/>
    <text y=“365” x=“20” font-size=“12” id=“content”>Content of file:
dsvg:spinBox; dsvg:switch, dsvg:case, dsvg:default
    </text>
    <text y=“380” x=“20” font-size=“12” id=“expected”>The dsvg:switch element
compares conditions of the child dsvg:case element(s) along with the dsvg:default
element values.
    </text>
    <!-- adding behavior -->
    <text y=“150” x=“50” fill=“#5f86B1” id=“label”>Label
    </text>
    <dsvg:spinBox selected=“false”
xlink:href=“dsvg11/skinSpinBox_Composite.svg#skinSpinBox” autoScale=“true”
disabled=“false” increment=“1” value=“1” max=“5” min=“0” height=“18” width=“118”
y=“70” x=“50” label=“Spin box” id=“spin”>
        <dsvg:switch variable=“%spin@value%” id=“dsvgUniqueID_4”>
            <dsvg:case value=“1” id=“dsvgUniqueID_5”>
                <dsvg:setData value=“Value is 1, minimum”
elementID=“label” id=“dsvgUniqueID_7”/>
            </dsvg:case>
            <dsvg:case value=“2” id=“dsvgUniqueID_6”>
                <dsvg:setData value=“Value is two” elementID=“label”
id=“dsvgUniqueID_8”/>
            </dsvg:case>
            <dsvg:case value=“3” id=“dsvgUniqueID_7”>
                <dsvg:setData value=“Value is THREE!”
elementID=“label” id=“dsvgUniqueID_9”/>
            </dsvg:case>
            <dsvg:default id=“dsvgUniqueID_8”>
                <dsvg:setData value=“value is other than one two three”
elementID=“label” id=“dsvgUniqueID_10”/>
            </dsvg:default>
        </dsvg:switch>
    </dsvg:spinBox>
    <text y=“70” x=“200” id=“text_a”>Switch: CASE for values 1,2,3
    </text>
    <text y=“90” x=“200” id=“text_b”>Switch: DEFAULT for other values
    </text>
    <text y=“110” x=“200” id=“text_c”>In all cases, the value will be reflected in the
Label.
    </text>
</svg>
```

The ‘case’ Element

The ‘case’ element is a child of the ‘switch’ element, which defines the value to compare to the ‘switch’ element's ‘value’ attribute. If it evaluates to true, its child elements are executed. Commonly used in conjunction with dSVG expressions for referencing the real-time value of variables or element attributes.

<!ENTITY % caseExt “” >
<!ELEMENT dsvg:case (%Behaviors;) >
<!ATTLIST dsvg:case
%stdBehaviorAttrs;
value %Text; #IMPLIED >
Attribute definitions:
value = ‘<string>’

Specifies the value to compare against the ‘switch’ element's ‘value’ attribute. Usually, ‘value’ will be a dSVG expression.

The ‘default’ Element

The ‘default’ element is a child of the ‘switch’ element, whose child behaviors are executed whenever none of the ‘switch’ element's ‘case’ elements evaluate to true. Commonly used in conjunction with dSVG expressions for referencing the real-time value of variables or element attributes.

<!ENTITY % defaultExt “” >
<!ELEMENT dsvg:default (%Behaviors;) >
<!ATTLIST dsvg:default
%stdBehaviorAttrs; >

The ‘loop’ Element

The ‘loop’ element allows its child behaviors to be executed iteratively (like a ‘for’ statement in ECMAscript) and/or upon multiple targets (like a ‘for-each’ statement in ECMAScript). A node list of multiple targets can be obtained from the ‘findElements’ element, which allows you to find all elements which match the specified search criteria. Optionally, the actual matching elements can be copied to a documentFragment, which can be used by the ‘postURL’ element.

| <!ENTITY % loopExt “” > | | |
|---|---|---|
| <!ELEMENT dsvg:loop ANY > | | |
| <!ATTLIST dsvg:loop | | |
| %stdBehaviorAttrs; | | |
| elementIDs | %Text;#IMPLIED | |
| nodeList | %Text;#IMPLIED | |
| elementID | ID; | #IMPLIED |
| from | %Integer; | #IMPLIED |
| to | %Integer; | #IMPLIED |
| increment | %Integer; | #IMPLIED |
| value | %Integer; | #IMPLIED > |

Attribute Definitions:

```
elementIDs = ‘<string>’
    The search string to compare against the ‘id’ attribute of every element in the
    DOM (or as a child of a specified parent element). It can contain the wildcard “*”
    character to denote “any string”. Whenever an element is found whose ID matches
    this search string, the child behaviors will be executed. For example,
    elementIDs=“myCircle*” would match elements with the ID's “myCircle1” and
    “myCircleRed”, whereas elementIDs=“*Circle*” would match elements with the
    ID's “myCircle1” and “hisCircle2”.
nodeList = ‘<string>’
    The identifier for the nodelist created by the ‘findElements’ behavior. All the child
    behaviors will be run for each node in the nodeList.
elementID = “name”
    The ‘id’ attribute of the current node. Each iteration, the ‘elementID’ attribute is
    updated to correspond to the ‘id’ attribute of the current node. The child behaviors
    can then reference that current node via the dSVG expression syntax.
    This attribute should never be provided by the markup. It is automatically
    populated for reference purposes.
from = “<integer>”
    The first value to loop on.
from = “<integer>”
```

The last value to loop on.

```
interval = “<integer>”
    The amount to increment with each itertion.
    If this attribute is not provided, the default is 1.
value = “<integer>”
    The value of the current iteration, between ‘from’ and ‘to’. Each
    iteration, the ‘value’ attribute is updated. The child behaviors can
    then reference that value via the dSVG expression syntax.
```

This attribute should never be provided by the markup. It is automatically populated for reference purposes.

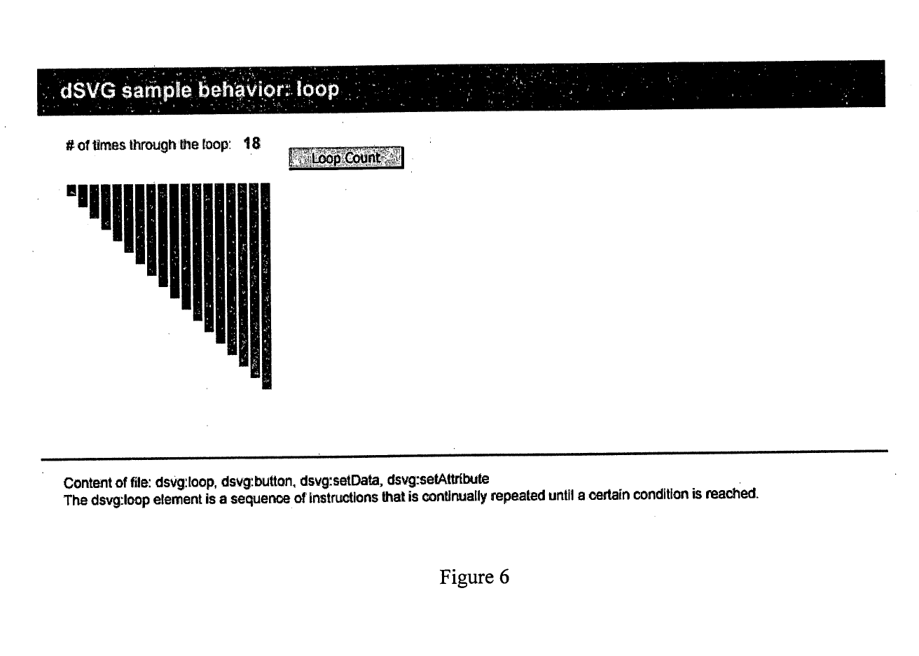

FIG. 6 shows a push button 110 that invokes the ‘loop’ behavior, storing the matches in a nodelist, and using the ‘loop’ element to display the ID's of the nodes via the ‘alert’ element. The loop element is a sequence of instructions that is continually repeated until a certain condition is reached. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http:/www.w3.org/1999/xlink” height=“410px” width=“744px”
onload=“init(evt)” viewBox=“0 0:744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/loop.js”/>
  <script type=“text/ecmascript” xlink:href=“dsvg11/button.js”/>
  <script type=“text/ecmascript” xlink:href=“dsvg11/setAttribute.js”/>
  <script type=“text/ecmascript” xlink:href=“dsvg11/setData.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
id=“text_1”>dSVG sample behavior: loop
  </text>
  <text y=“365” x=“20” font-size=“12” id=“content”>Content of file: dsvg:loop,
dsvg:button, dsvg:setData, dsvg:setAttribute
  </text>
  <text y=“380” x=“20” font-size=“12” id=“expected”>The dsvg:loop element is a
sequence of instructions that is continually repeated until a certain condition is reached.
  </text>
  <text y=“395” x=“20” font-size=“12” id=“depend”/>
  <line y2=“340” x2=“744” y1=“340” x1=“0” stroke-width=“2” stroke=“#5f86B1”
fill=“#5f86B1” id=“bottom_line”/>
  <!-- adding behavior -->
  <g id=“sizer”>
    <rect height=“8” width=“8” y=“100” x=“25” fill=“gray” id=“sizer1”/>
    <rect height=“8” width=“8” y=“100” x=“35” fill=“gray” id=“sizer2”/>
    <rect height=“8” width=“8” y=“100” x=“45” fill=“gray” id=“sizer3”/>
    <rect height=“8” width=“8” y=“100” x=“55” fill=“gray” id=“sizer4”/>
    <rect height=“8” width=“8” y=“100” x=“65” fill=“gray” id=“sizer5”/>
    <rect height=“8” width=“8” y=“100” x=“75” fill=“gray” id=“sizer6”/>
    <rect height=“8” width=“8” y=“100” x=“85” fill=“gray” id=“sizer7”/>
    <rect height=“8” width=“8” y=“100” x=“95” fill=“gray” id=“sizer8”/>
    <rect height=“8” width=“8” y=“100” x=“105” fill=“gray” id=“sizer9”/>
    <rect height=“8” width=“8” y=“100” x=“115” fill=“gray” id=“sizer10”/>
    <rect height=“8” width=“8” y=“100” x=“125” fill=“gray” id=“sizer11”/>
    <rect height=“8” width=“8” y=“100” x=“135” fill=“gray” id=“sizer12”/>
    <rect height=“8” width=“8” y=“100” x=“145” fill=“gray” id=“sizer 13”/>
    <rect height=“8” width=“8” y=“100” x=“155” fill=“gray” id=“sizer14”/>
    <rect height=“8” width=“8” y=“100” x=“165” fill=“gray” id=“sizer15”/>
    <rect height=“8” width=“8” y=“100” x=“175” fill=“gray” id=“sizer16”/>
    <rect height=“8” width=“8” y=“100” x=“185” fill=“gray” id=“sizer17”/>
    <rect height=“8” width=“8” y=“100” x=“195” fill=“gray” id=“sizer18”/>
  </g>
  <dsvg:button xlink:href=“dsvg11/skinButton_Windows.svg#skinButton”
autoScale=“true” disabled=“false” selected=“false” toggle=“false” height=“18”
width=“100” y=“70” x=“220” label=“Loop Count” id=“loop1”>
    <dsvg:loop increment=“1” to=“18” from=“1” id=“LOOP1”>
      <dsvg:setAttribute value=“%LOOP1@value * 10%”
attribute=“height” elementID=“sizer%LOOP1@value%”/>
    </dsvg:loop>
    <dsvg:setData value=“%LOOP1@value%” elementID=“iteration”
id=“data”/>
    </dsvg:button>
    <text y=“70” x=“25” fill=“#5f86B1” color=“” id=“desc”># of times through the
loop:
    </text>
    <text y=“70” x=“180” font-weight=“bold” font-size=“14” fill=“darkblue”
id=“iteration”>0
    </text>
</svg>
```

The ‘timer’ Element

The ‘timer’ element allows its child behaviors to be executed iteratively at a specified time interval until such time as its ‘break’ attribute evaluates to true. The ‘iteration’ attribute is incremented internally so that it can be referenced by the child behaviors for context.

| <!ENTITY % timerExt “” > | | |
|---|---|---|
| <!ELEMENT dsvg:timer ANY > | | |
| <!ATTLIST dsvg:timer | | |
| %stdBehaviorAttrs; | | |
| interval | %Number; | #IMPLIED |
| break | %Boolean; | #IMPLIED |
| iteration | %Integer; | #IMPLIED > |

Attribute Definitions:

interval=‘<number>’

The time, in milliseconds, between each iteration.

break=‘“(true|false)”’

A value of ‘true’ causes the timer to stop running. A value of ‘false’ causes the timer to continue running. The default is ‘false’. It is expected that either the ‘break’ attribute gets modified externally via the setAttribute behavior, or it is a dSVG expression, which gets re-evaluated every iteration.

iteration=“<number>”

The value of the current iteration, where the first iteration starts at zero, i.e. the number of times the child behaviors have been run. Each iteration, the child behaviors can reference this ‘iteration’ attribute via the dSVG expression syntax. This attribute should never be provided by the markup. It is automatically populated for reference purposes.

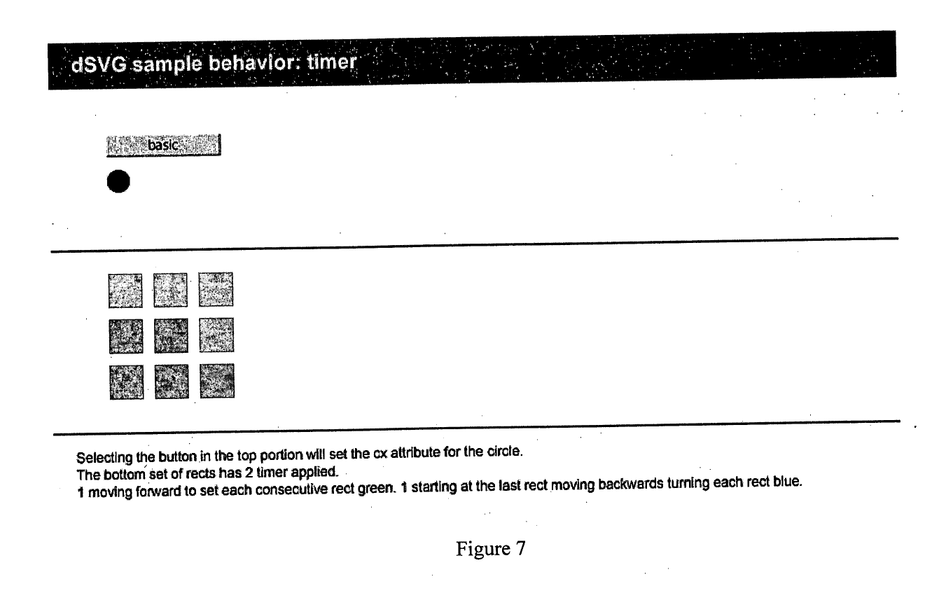

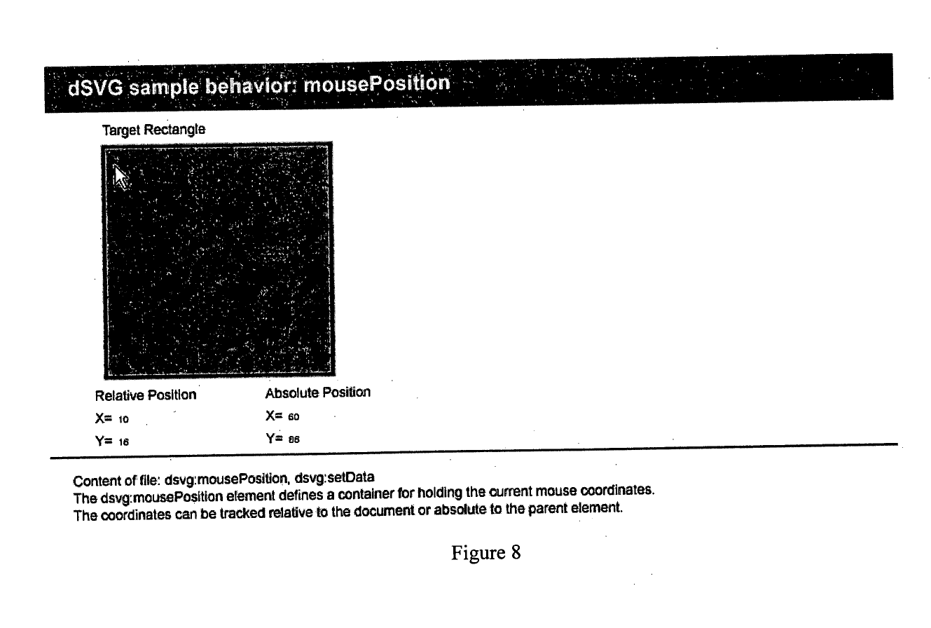

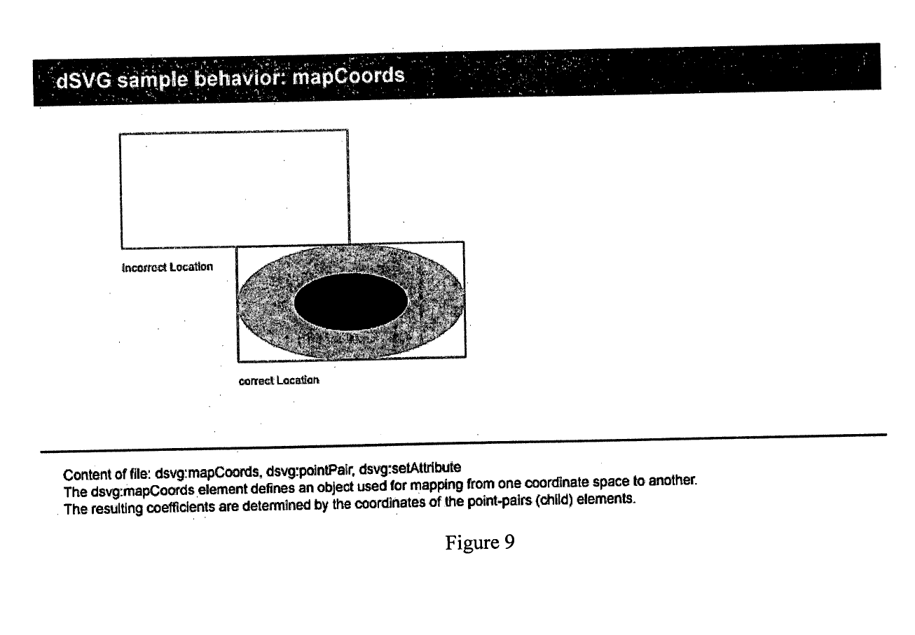

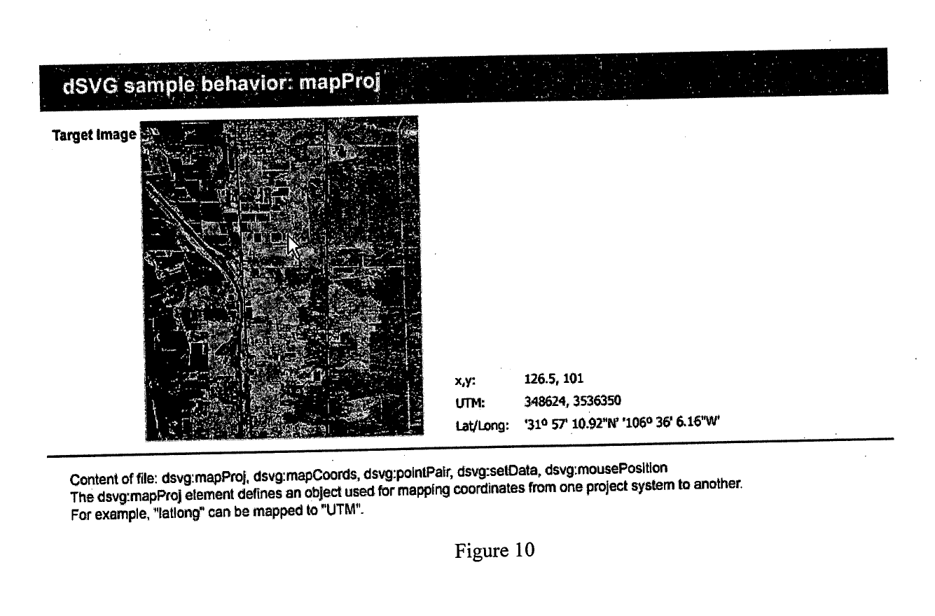

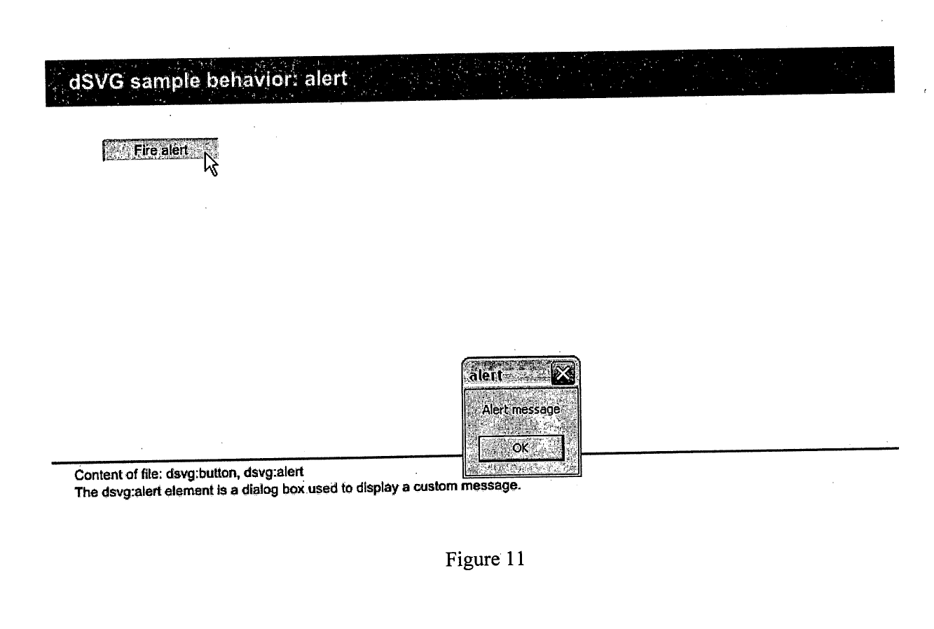

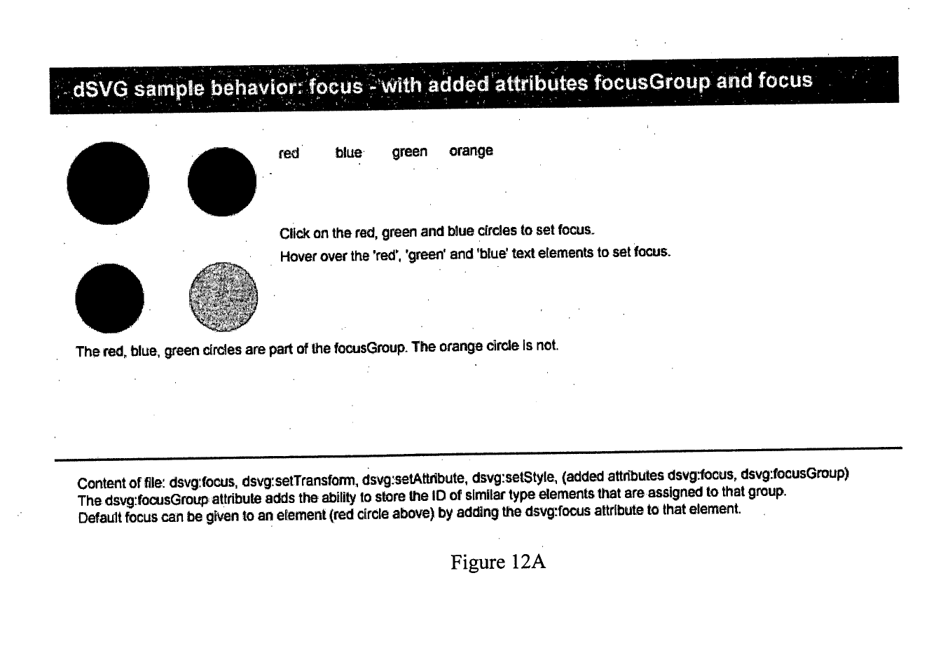

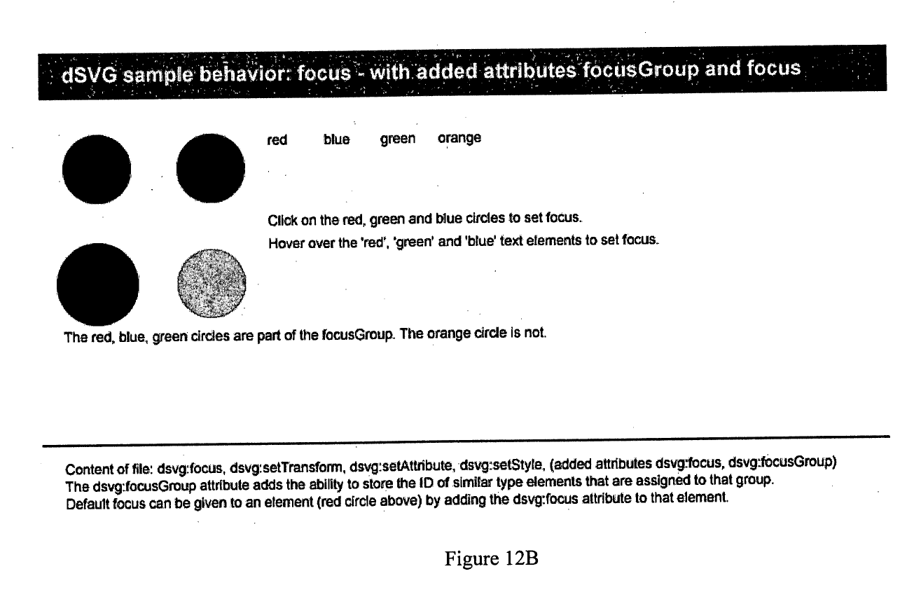

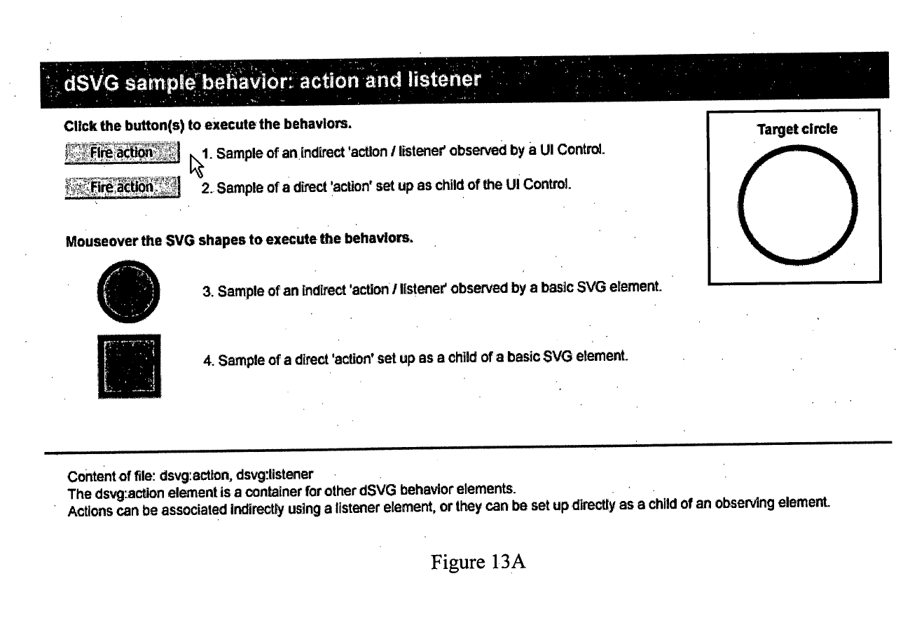

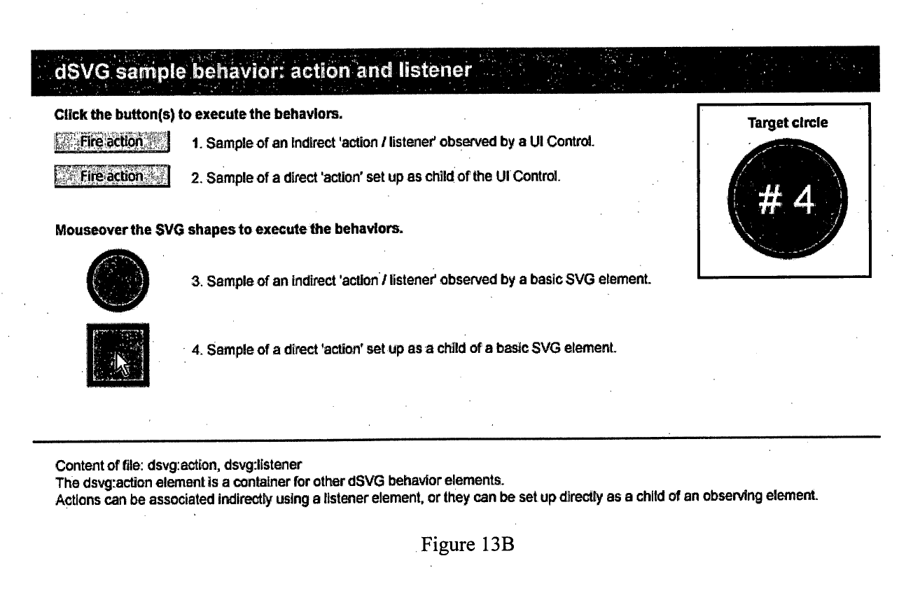

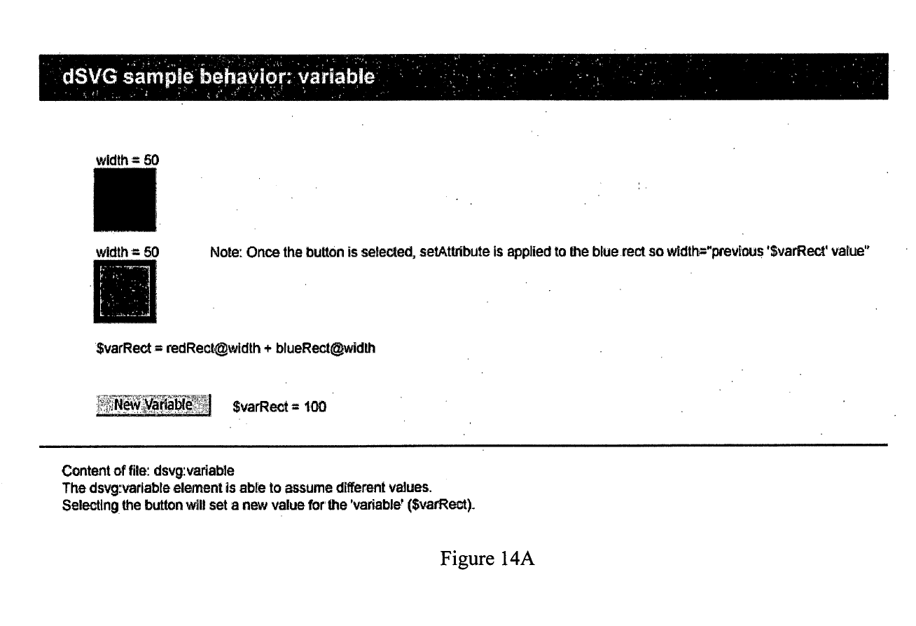

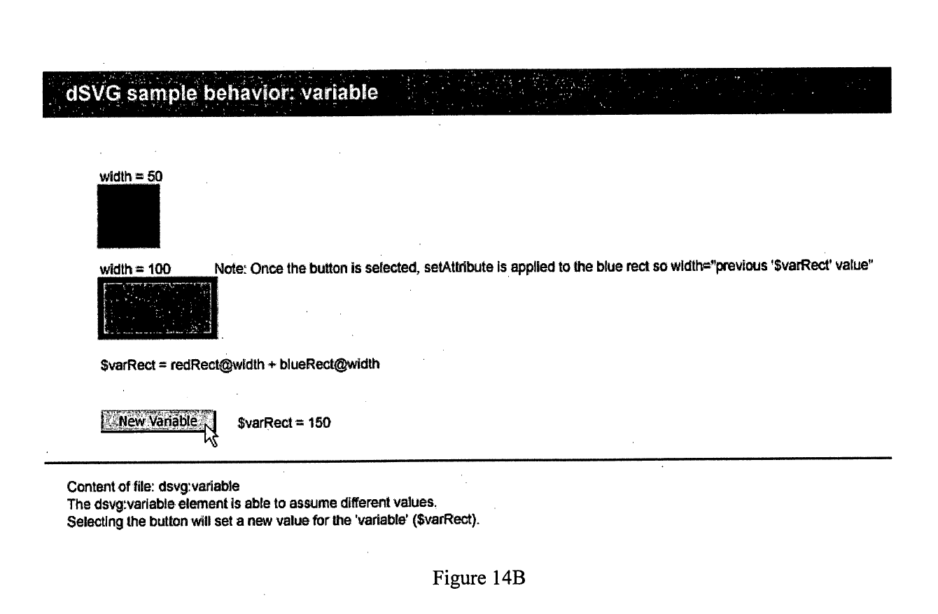

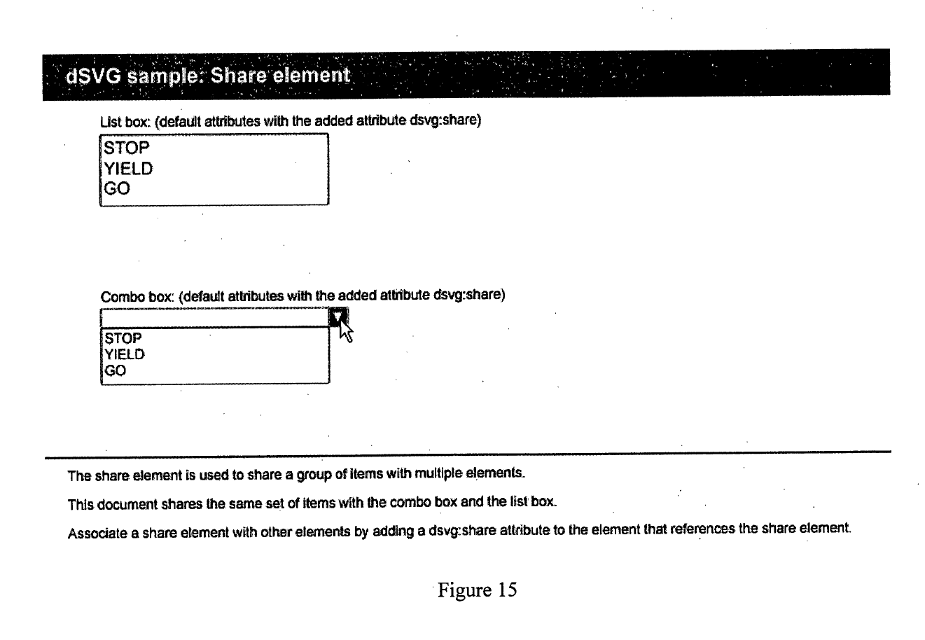

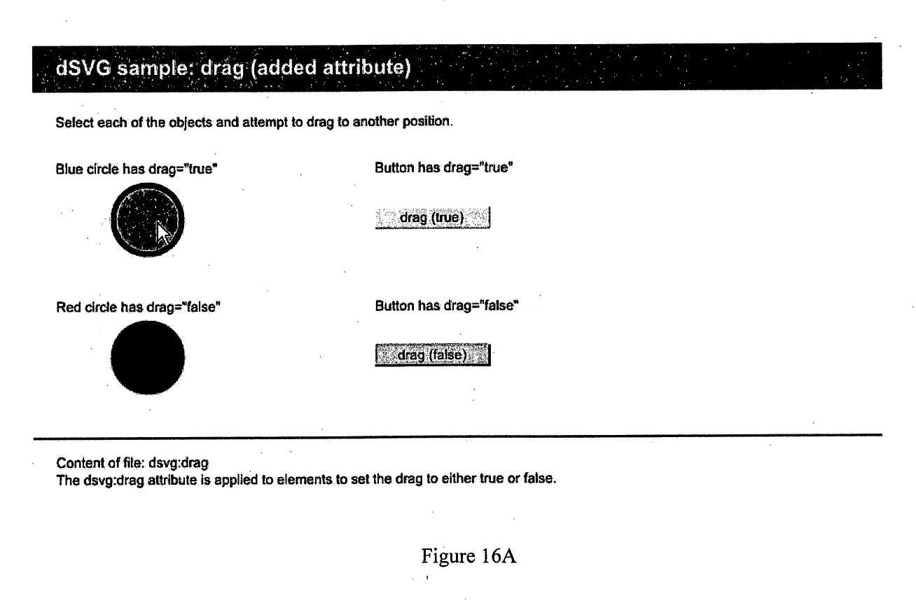

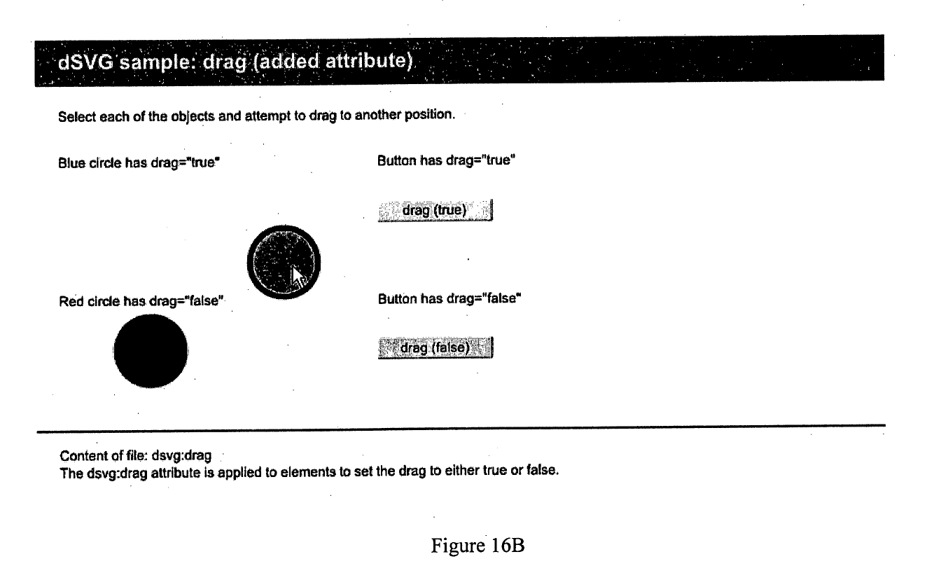

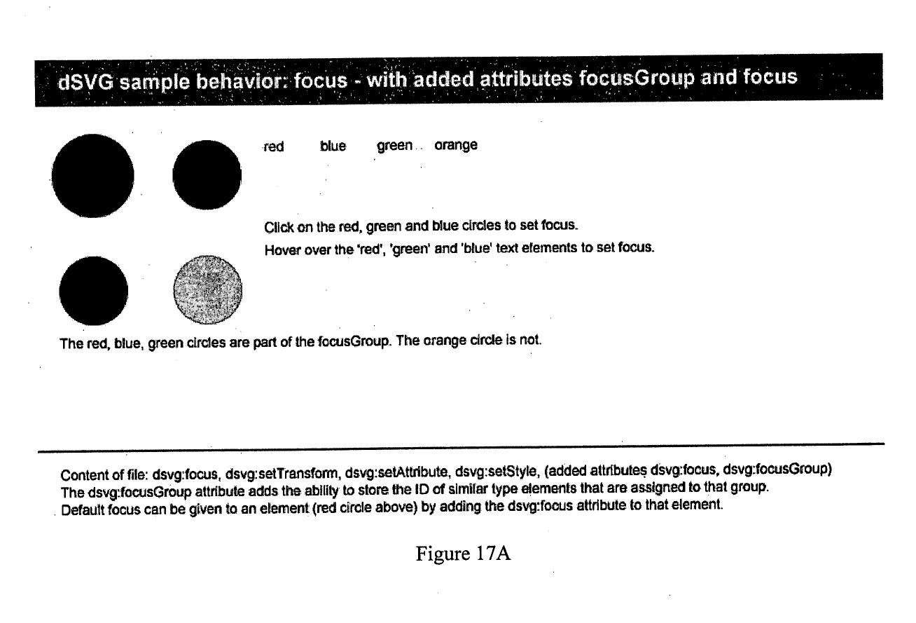

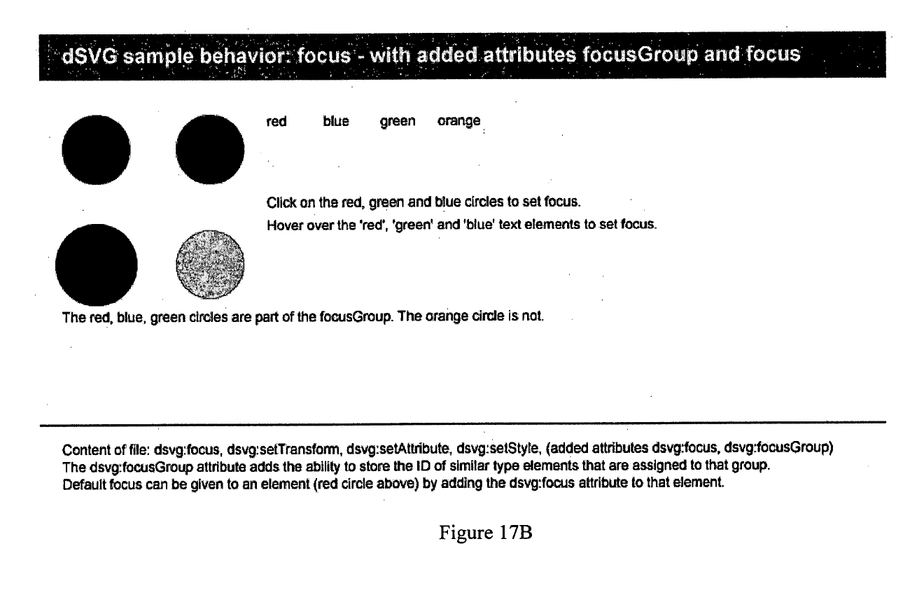

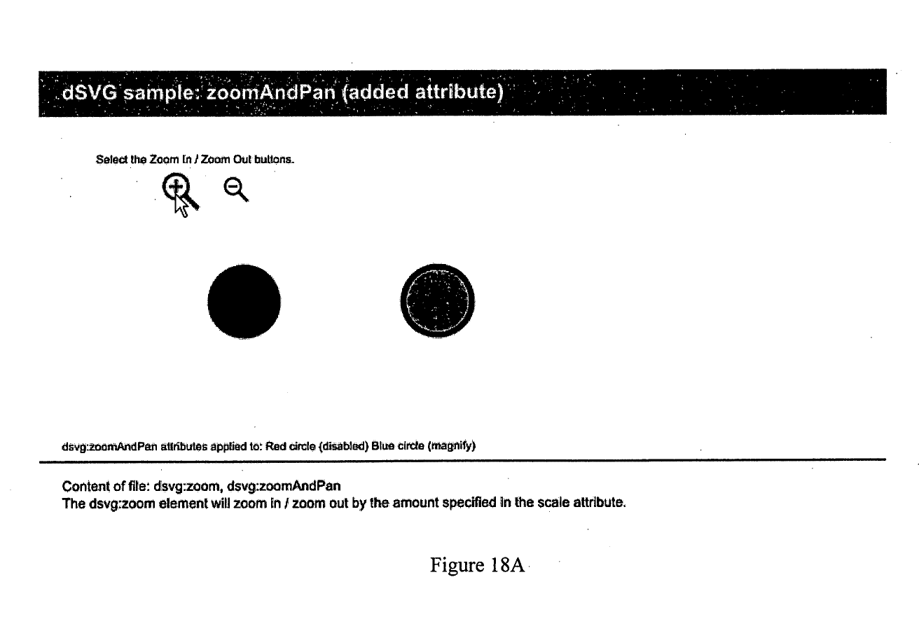

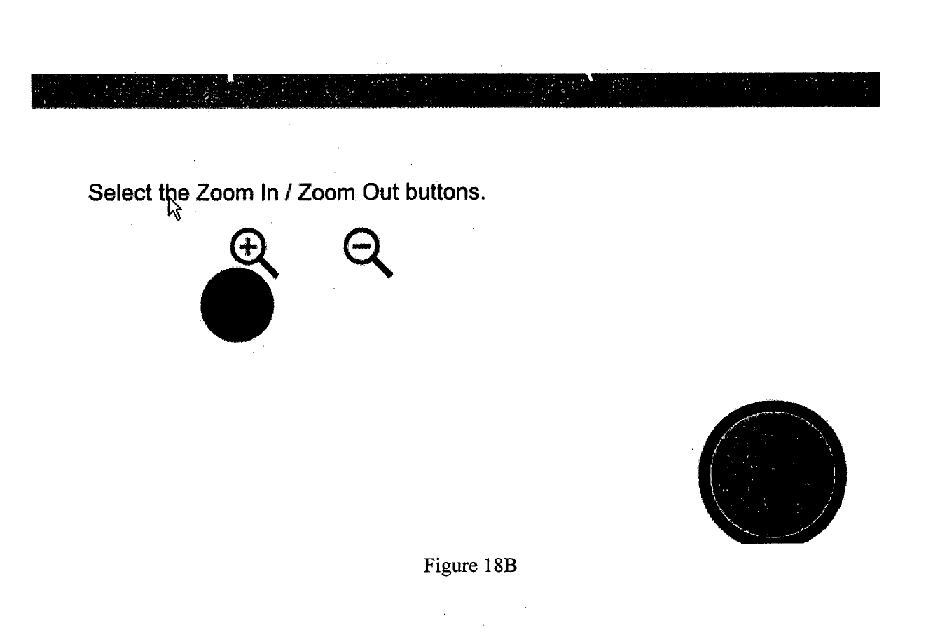

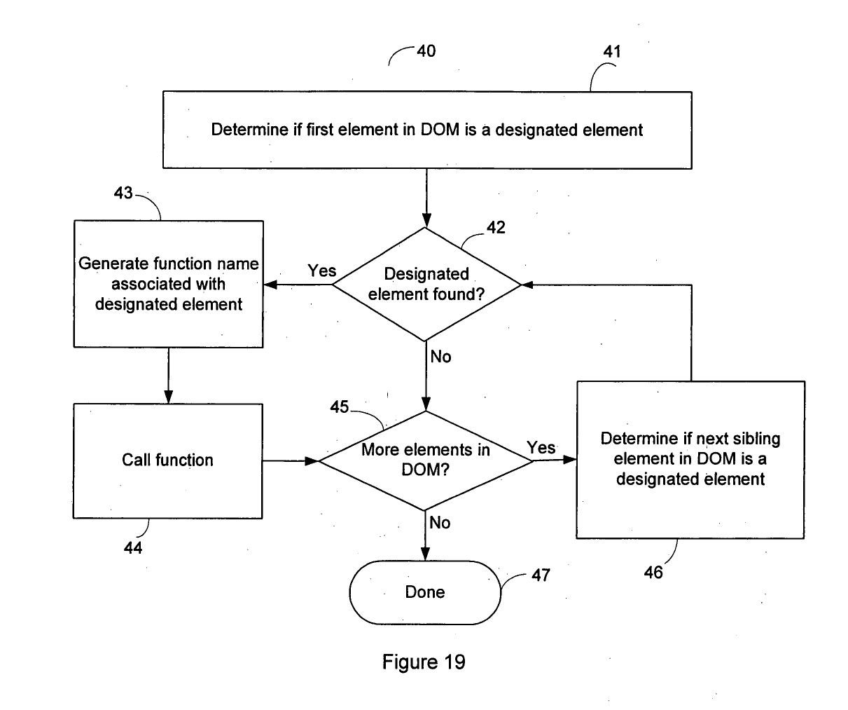

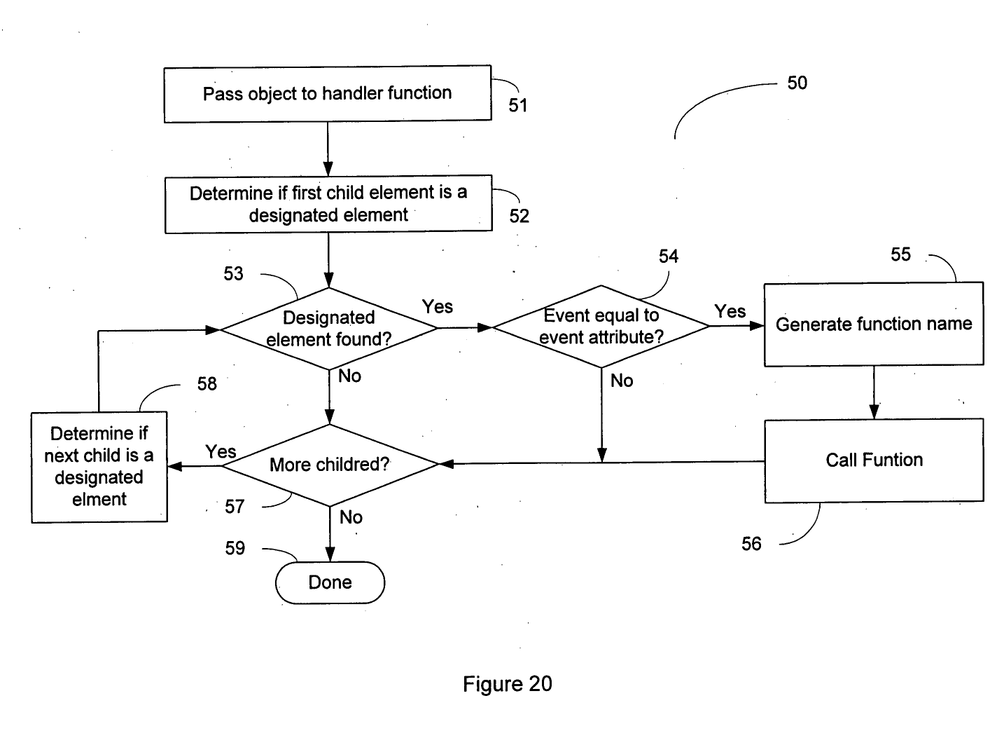

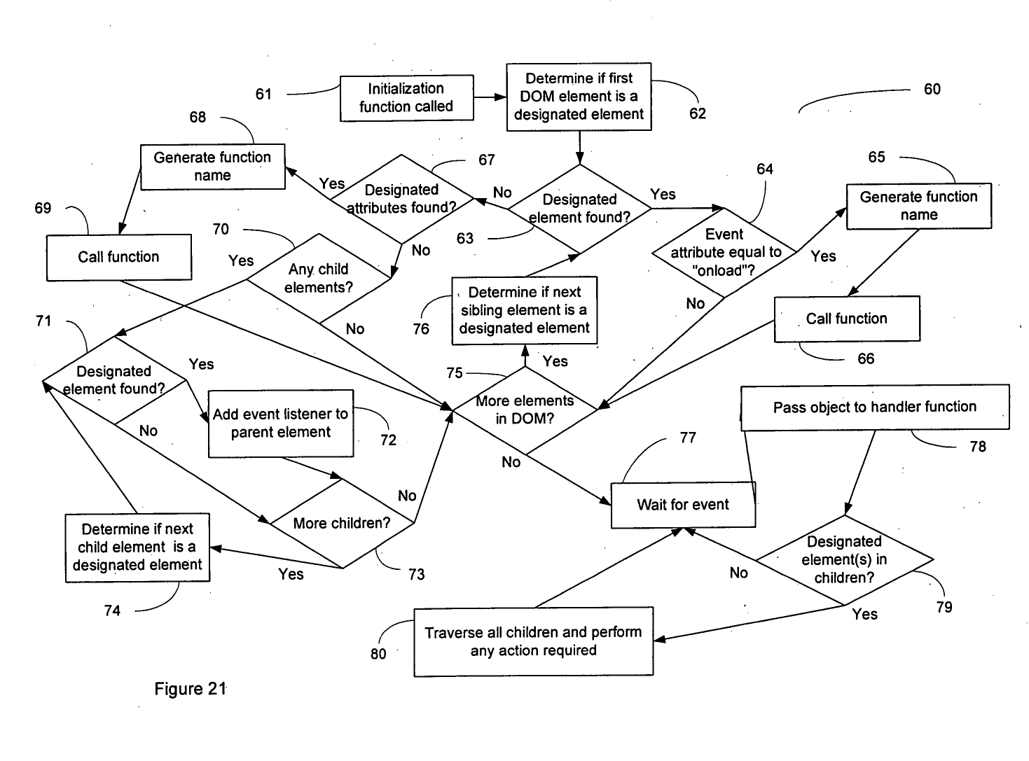

FIG. 7 shows shows a set of rectangles with 2 timers applied—one that starts at the first rectangle, setting each consecutive rectangle green, and another starting at the last rectangle, setting each previous rectangle blue. The example is provided below:

```
<?xml version=“1.0” encoding=“UTF-8” standalone=“no”?>
<!DOCTYPE svg SYSTEM “../SVGdSVG.dtd”>
<svg xmlns:dsvg=“http://www.corel.com/schemas/2002/dSVG20”
xmlns:xlink=“http://www.w3.org/1999/xlink” height=“410px” width=“744px”
onload=“init(evt)” viewBox=“0 0 744 410”>
  <script type=“text/ecmascript” xlink:href=“dSVG20/dSVG.js”/>
  <script type=“text/ecmascript” xlink:href=“dSVG20/baseUI.js”/>
  <script type=“text/ecmascript” xlink:href=“dSVG20/constraint.js”/>
  <script type=“text/ecmascript” xlink:href=“dSVG20/button.js”/>
  <script type=“text/ecmascript” xlink:href=“dSVG20/setAttribute.js”/>
  <script type=“text/ecmascript” xlink:href=“dSVG20/timer.js”/>
  <script type=“text/ecmascript” xlink:href=“dSVG20/if.js”/>
  <script type=“text/ecmascript” xlink:href=“dSVG20/alert.js”/>
  <script type=“text/ecmascript” xlink:href=“dSVG20/setData.js”/>
  <script type=“text/ecmascript” xlink:href=“dSVG20/loadXML.js”/>
  <script type=“text/ecmascript” xlink:href=“dSVG20/slider.js”/>
  <script type=“text/ecmascript” xlink:href=“dSVG20/removeElement.js”/>
  <script type=“text/ecmascript” xlink:href=“dSVG20/zoom.js”/><!-- template -->
  <defs/>
  <g id=“template”>
    <rect height=“40” width=“744” y=“0” x=“0” fill=“#5f86B1”
id=“title_rect”/>
    <text y=“25” x=“20” font-weight=“bold” font-size=“18” fill=“white”
id=“text_1”>dSVG sample behavior: timer
    </text>
    <text y=“365” x=“20” font-size=“12” id=“content”>Selecting the button in
the top portion will set the cx attribute for the circle.
    </text>
    <text y=“380” x=“20” font-size=“12” id=“expected”>The bottom set of
rects has 2 timer applied.
    </text>
    <text y=“395” x=“20” font-size=“12” id=“depend”>1 moving forward to
set each consecutive rect green. 1 starting at the last rect moving backwards turning each
rect blue.
    </text>
    <line y2=“340” x2=“744” y1=“340” x1=“0” stroke-width=“2”
stroke=“#5f86B1” fill=“#5f86B1” id=“bottom_line”/>
    <line y2=“180” x2=“744” y1=“180” x1=“0” stroke-width=“2”
stroke=“#5f86B1” fill=“#5f86B1” id=“mid_line”/>
  </g>
  <g id=“basicGroup”>
    <circle r=“10” cy=“120” cx=“60” id=“circle1”/>
    <text y=“70” x=“227” visibility=“hidden” id=“text_distance”>200
    </text>
    <dsvg:button xlink:href=“dSVG20/skinButton_Windows.svg#skinButton”
autoScale=“true” height=“18” width=“100” y=“80” x=“50” label=“basic”
id=“button_basic”>
      <dsvg:variable value=“%circle1@cx + 2.5%” name=“var_basic”
id=“var_basic”/>
      <dsvg:setAttribute value=“#5f86B1” attribute=“fill”
elementID=“circle1” id=“dsvgUniqueID_1”/>
      <dsvg:timer break=“%timer_basic@iteration > 50%” interval=“20”
event=“onclick” id=“timer_basic”>
      <dsvg:setAttribute value=“%$var_basic%” attribute=“cx”
elementID=“circle1” id=“dsvgUniqueID_3”/>
        <dsvg:if value2=“a” op=“equal” value1=“a”
id=“dsvgUniqueID_5”>
          <dsvg:setAttribute value=“visible”
attribute=“visibility” elementID=“text_distance” id=“dsvgUniqueID_7”/>
          <dsvg:setData value=“The cx position of the circle
is: %circle1@cx%” elementID=“text_distance” id=“dsvgUniqueID_8”/>
        </dsvg:if>
      </dsvg:timer>
    </dsvg:button>
  </g>
  <g id=“rectTimers”>
    <g id=“crossingTimers”>
      <dsvg:timer break=“%timer3@iteration > 4999%” interval=“357”
event=“onload” id=“timer3”>
        <dsvg:variable
value=“%substring(timer3@iteration,length(timer3@iteration),(length(timer3@iteration)-
1))%” name=“valTwo” id=“v4”/>
        <dsvg:setAttribute value=“Green” attribute=“fill”
elementID=“myRect%$valTwo%”/>
        <dsvg:setAttribute value=“0.4” attribute=“opacity”
elementID=“myRect%$valTwo%”/>
        <dsvg:setAttribute value=“blue” attribute=“fill”
elementID=“myRect%10 - $valTwo%”/>
        <dsvg:setAttribute value=“.4” attribute=“opacity”
elementID=“myRect%10 - $valTwo%”/>
      </dsvg:timer>
    </g>
    <g id=“rectGroup”>
      <rect height=“30” width=“30” y=“200” x=“50” fill=“black”
id=“myRect1”/>
      <rect height=“30” width=“30” y=“200” x=“90” fill=“black”
id=“myRect2”/>
      <rect height=“30” width=“30” y=“200” x=“130” fill=“black”
id=“myRect3”/>
      <rect height=“30” width=“30” y=“240” x=“50” fill=“black”
id=“myRect4”/>
      <rect height=“30” width=“30” y=“240” x=“90” fill=“black”
id=“myRect5”/>
      <rect height=“30” width=“30” y=“240” x=“130” fill=“black”
id=“myRect6”/>
      <rect height=“30” width=“30” y=“280” x=“50” fill=“black”
id=“myRect7”/>
      <rect height=“30” width=“30” y=“280” x=“90” fill=“black”
id=“myRect8”/>
      <rect height=“30” width=“30” y=“280” x=“130” fill=“black”
id=“myRect9”/>
    </g>
  </g>
  <g id=“insertGroup”/>
</svg>
```

Coordinate Mapping Elements 23

Often a web application requires the ability to click and drag objects, perhaps for the purposes of editing their positions. SVG does not currently have this capability. Thus, script is required which tracks the mouse movements and creates a translation transform on the object. Also, a user may desire to display coordinate information for where the mouse curser is located. Thus, the user first needs to know where the mouse cursor is in the coordinate system of the SVG document, before the user can convert the coordinate information to the coordinate system the user is using. Currently, only script can assist a user.

In order to display coordinate-based data, such as the location of cities on a background map, a user must convert those coordinates to the coordinate system of the SVG document. An example of such a conversion is a linear transformation (a scale and translation), such as a cartesian grid with parallel latitude and longitude lines. Another example of a transformation is a polynomial transformation, such as for a map with a latitude/longitude projection (i.e., curved lines of latitude, angled lines of longitude). Usually, calculations are required to determine transformations. SVG does not provide markup for creating and applying complex mathematical transformations.

Sometimes data visualized in a web application uses a projection system, such as a latitude/longitude or universal transverse mercator (UTM), which usually requires knowledge of how the projection system operates. To be able to map to the coordinate system of an SVG document usually requires knowledge of how to convert between such projections. SVG does not provide markup to specify a projection system and parameters, and automatically map any coordinate from one system to the other.

A coordinate mapping element 23 manipulates the coordinates of an object in the web application. Coordinate mapping elements 23 are used to display an object whose coordinates are in a system different from the DOM coordinate system. A coordinate mapping element 23 is inserted in a DOM as a child of another DOM elements.

The attributes of a coordinate mapping element 23 include point pair coordinates. The associate instruction 33 performs actions used to take third party XML data and position the data in a DOM. Coordinate mapping elements 23 include the ‘mousePosition’ element, the ‘mapCoords’ element, the ‘pointPair’ element, and the ‘mapProj’ element.

The ‘mousePosition’ Element

The ‘mousePosition’ element defines a container for holding the current mouse coordinates, relative to the document or to the target element. It is a persistent object in memory that should be instantiated once, and so should not be a child of any element other than the ‘svg’ root element (or a ‘g’ element).

| <!ENTITY % mousePositionExt “” > | | |
|---|---|---|
| <!ELEMENT dsvg:mousePosition EMPTY > | | |
| <!ATTLIST dsvg:mousePosition | | |
| %stdBehaviorAttrs; | | |
| elementID | ID | #IMPLIED |
| x | %Coordinate; | #IMPLIED |
| y | %Coordinate; | #IMPLIED |
| type | %Type“relative” > | |

Attribute Definitions:

elementID=“name”

The ‘id’ attribute of the target element to generate the mouse events.

x=“<coordinate>”

The current x-coordinate of the mouse cursor. Setting this attribute has no effect—it is purely a storage attribute, intended to be referenced.

y=“<coordinate>”

The current y-coordinate of the mouse cursor. Setting this attribute has no effect—it is purely a storage attribute, intended to be referenced.

type=“(relative|absolute)”

Specifies whether the mouse coordinates are to be relative to the document (absolute) or relative to the target element (relative).

FIG. 8 shows a rectangle 115 with mouse coordinates displayed relative to both the document and the rectangle. The mousePosition element defines a container for holding the current mouse coordinates. The coordinates can be tracked relative to the document or absolute to the parent element. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/mousePosition.js”/>
  <script type=“text/ecmascript” xlink:href=“dsvg11/setData.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
id=“text_1”>dSVG sample behavior: mousePosition
  </text>
  <text y=“365” x=“20” font-size=“12” id=“content”>Content of file:
dsvg:mousePosition, dsvg:setData
  </text>
  <text y=“380” x=“20” font-size=“12” id=“expected”>The dsvg:mousePosition
element defines a container for holding the current mouse coordinates.
  </text>
  <text y=“395” x=“20” font-size=“12” id=“depend”>The coordinates can be
tracked relative to the document or absolute to the parent element.
  </text>
  <line y2=“340” x2=“744” y1=“340” x1=“0” stroke-width=“2” stroke=“#5f86B1”
fill=“#5f86B1” id=“bottom_line”/>
  <!-- adding behavior -->
  <text y=“60” x=“50” id=“targetText”>Target Rectangle
  </text>
  <rect height=“200” width=“200” y=“70” x=“50” stroke-width=“3” stroke=“black”
fill=“#5f86B1” id=“rect1”>
    <dsvg:setData value=“%mouse_Relative@x%”
elementID=“relative_xpos” event=“onmousemove” id=“set_relativeX”/>
    <dsvg:setData value=“%mouse_Relative@y%”
elementID=“relative_ypos” event=“onmousemove” id=“set_relativeY”/>
    <dsvg:setData value=“%mouse_Absolute@x%”
elementID=“absolute_xpos” event=“onmousemove” id=“set_absoluteX”/>
    <dsvg:setData value=“%mouse_Absolute@y%”
elementID=“absolute_ypos” event=“onmousemove” id=“dsvgUniqueID_5”/>
  </rect>
  <dsvg:mousePosition type=“relative” elementID=“rect1” event=“onmousemove”
id=“mouse_Relative”/>
  <dsvg:mousePosition type=“absolute” elementID=“rect1” event=“onmousemove”
id=“mouse_Absolute”/>
  <text y=“290” x=“40” id=“textx_relative”>Relative Position
  </text>
  <text y=“310” x=“40” id=“relative_xlabel”>X=
  </text>
  <text y=“330” x=“40” id=“relative_ylabel”>Y=
  </text>
  <text y=“310” x=“60” font-size=“8” fill=“green” id=“relative_xpos”>x Position
  </text>
  <text y=“330” x=“60” font-size=“8” fill=“green” id=“relative_ypos”>y Position
  </text>
  <text y=“290” x=“190” id=“textx_absolute”>Absolute Position
  </text>
  <text y=“310” x=“190” id=“absolute_xlabel”>X=
  </text>
  <text y=“330” x=“190” id=“absolute_ylabel”>Y=
  </text>
  <text y=“310” x=“210” font-size=“8” fill=“green” id=“absolute_xpos”>x Position
  </text>
  <text y=“330” x=“210” font-size=“8” fill=“green” id=“absolute_ypos”>y Position
  </text>
</svg>
```

The ‘mapCoords’ Element

The ‘mapCoords’ element defines an object used for mapping coordinates in one space to another space, via a polynomial transformation, whose coefficients are determined by the coordinates of the point-pairs given in the child ‘pointPair’ elements.

| <!ENTITY % mapCoordsExt “” > | | |
|---|---|---|
| <!ELEMENT dsvg:mapCoords (dsvg:pointPair)* > | | |
| <!ATTLIST dsvg:mapCoords | | |
| %stdBehaviorAttrs; | | |
| order | %Integer; | #IMPLIED |
| inputID | ID | #IMPLIED |
| x | %Coordinate; | #IMPLIED |
| y | %Coordinate; | #IMPLIED |
| u | %Coordinate; | #IMPLIED |
| v | %Coordinate; | #IMPLIED |
| apply | %Boolean | “false” > |

Attribute Definitions:

```
order = “<integer>”
  The order of the polynomial transformation. The default is 1, which only requires
  2 point-pairs, resulting in an affine (linear) transformation.
inputID = “name”
  The ‘id’ attribute of the element that will automatically feed its coordinates into the
  ‘mapCoords’ element's ‘x’ and ‘y’ attributes whenever they update. e.g. the ID of a
  ‘mousePosition’ element.
x = “<coordinate>”
  The x-coordinate of the first coordinate system. Updating this attribute
  automatically updates the ‘u’ attribute.
y = “<coordinate>”
  The y-coordinate of the first coordinate system. Updating this attribute
  automatically updates the ‘v’ attribute.
u = “<coordinate>”
  The x-coordinate of the second coordinate system. Updating this attribute
  automatically updates the ‘x’ attribute.
v = “<coordinate>”
  The y-coordinate of the second coordinate system. Updating this attribute
  automatically updates the ‘y’ attribute.
apply = “(true | false)”
  Specifies whethr the coordinates of the element defined by ‘inputID’will be
  actually modified according to the polynomial transformation defined by the
  point-pairs (true) or not (false).
```

FIG. 9 shows two ellipses 120 and 125 transformed to another coordinate space. The mapCoords element defines an object used for mapping from one coordinate space to another. The resulting coefficients are determined by the coordinates of the point-pairs (child) elements. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/mapCoords.js”/>
  <script type=“text/ecmascript” xlink:href=“dsvg11/setAttribute.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
id=“text_1”>dSVG sample behavior: mapCoords
  </text>
  <text y=“365” x=“20” font-size=“12” id=“content”>Content of file:
dsvg:mapCoords, dsvg:pointPair, dsvg:setAttribute
  </text>
  <text y=“380” x=“20” font-size=“12” id=“expected”>The dsvg:mapCoords
element defines an object used for mapping from one coordinate space to another.
  </text>
  <text y=“395” x=“20” font-size=“12” id=“depend”>The resulting coefficients are
determined by the coordinates of the point-pairs (child) elements.
  </text>
  <line y2=“340” x2=“744” y1=“340” x1=“0” stroke-width=“2” stroke=“#5f86B1”
fill=“#5f86B1” id=“bottom_line”/>
  <!-- adding behavior -->
  <g id=“fragment”>
    <ellipse ry=“50” rx=“100” cy=“115” cx=“175” fill=“orange”
id=“fragellipse1”/>
    <ellipse ry=“25” rx=“50” cy=“115” cx=“175” fill=“blue”
id=“fragellipse2”/>
  </g>
  <rect height=“100” width=“200” y=“65” x=“75” stroke-width=“1” stroke=“red”
fill=“none”/>
  <text y=“185” x=“75” font-size=“10” fill=“red”>Incorrect Location
  </text>
  <rect height=“100” width=“200” y=“165” x=“175” stroke-width=“1”
stroke=“green” fill=“none”/>
  <text y=“285” x=“175” font-size=“10” fill=“green”>correct Location
  </text>
  <dsvg:mapCoords apply=“true” inputID=“fragment” id=“mapcoords1”>
    <dsvg:pointPair v=“100” u=“100” y=“0” x=“0”/>
    <dsvg:pointPair v=“110” u=“110” y=“10” x=“10”/>
  </dsvg:mapCoords>
  <dsvg:setAttribute value=“true” attribute=“convertNow”
elementID=“mapcoords1” id=“dsvgUniqueID_3”/>
</svg>
```

The ‘pointPair’ Element

The ‘pointPair’ element, which must be a child of the ‘mapCoords’ element, defines the x-y coordinates for the same location in two different coordinate spaces. The point-pairs are used to calculate the polynomial transformation coefficients.

| <!ENTITY % pointPairExt “” > | | |
|---|---|---|
| <!ELEMENT dsvg:pointPair EMPTY > | | |
| <!ATTLIST dsvg:pointPair | | |
| %stdBehaviorAttrs; | | |
| x | %Coordinate; | #IMPLIED |
| y | %Coordinate; | #IMPLIED |
| u | %Coordinate; | #IMPLIED |
| v | %Coordinate; | #IMPLIED > |

Attribute Definitions:

```
x = “<coordinate>”
  The x-coordinate of the first coordinate system.
y = “<coordinate>”
  The y-coordinate of the first coordinate system.
u = “<coordinate>”
  The x-coordinate of the second coordinate system.
v = “<coordinate>”
  The y-coordinate of the second coordinate system.
```

The ‘mapProj’ Element

The ‘mapProj’ element defines an object used for mapping coordinates in one space to another space, via a polynomial transformation, whose coefficients are determined by the coordinates of the point-pairs given in the child ‘pointpair’ elements.

| <!ENTITY % mapProjExt “” > | | |
|---|---|---|
| <!ELEMENT dsvg:mapProj EMPTY > | | |
| <!ATTLIST dsvg:mapProj | | |
| %stdBehaviorAttrs; | | |
| inputID | ID | #IMPLIED |
| inputProj | %Projection | “UTM” |
| outputProj | %Projection | “LatLong” |
| ellipsoid | %Ellipsoid | “WGS84” |
| zone | %Text | #IMPLIED |
| x | %Coordinate; | #IMPLIED |
| y | %Coordinate; | #IMPLIED |
| u | %Coordinate; | #IMPLIED |
| v | %Coordinate; | #IMPLIED > |

Attribute Definitions:

```
inputID = “name”
  The ‘id’ attribute of the element that will automatically feed its coordinates into the
  ‘mapProj’ element's ‘x’ and ‘y’ attributes whenever they update. e.g. the ID of a
  ‘mapCoords’ element.
inputProj = “(UTM | LatLong)”
  The input project system.
  If this attribute is not provided, the default is “UTM”.
outputProj = “(UTM | LatLong)”
  The output project system.
  If this attribute is not provided, the default is “LatLong”.
ellipsoid = “(Airy | AustralianNational | Bessel1841 | Bessel1841Nambia | Clarke1866 |
Clarke1880 | Everest | Fischer1960Mercury | Fischer1968 | GRS1967 | GRS1980 |
Helmert1906 | Hough | International | Krassovsky | ModifiedAiry | ModifiedEverest |
ModifiedFischer1960 | SouthAmerican1969 | WGS60 | WGS66 | WGS72 | WGS84)”
  The ellipsoid of the UTM projection system.
  If this attribute is not provided, the default is “WGS84”.
zone = ‘<string>’
  The zone of the UTM projection system.
x = “<coordinate>”
  The x-coordinate of the first projection system. Updating this attribute
  automatically updates the ‘u’ attribute.
y = “<coordinate>”
  The y-coordinate of the first projection system. Updating this attribute
  automatically updates the ‘v’ attribute.
u = “<coordinate>”
  The x-coordinate of the second projection system. Updating this attribute
  automatically updates the ‘x’ attribute.
v = “<coordinate>”
  The y-coordinate of the second projection system. Updating this attribute
  automatically updates the ‘y’ attribute.
```

FIG. 10 shows two ellipses transformed to another coordinate space. The mapProj element defines an object used for mapping coordinates from one project system to another. For example, “latlong” can be mapped to “UTM”. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/mousePosition.js”/>
  <script type=“text/ecmascript” xlink:href=“dsvg11/mapCoords.js”/>
  <script type=“text/ecmascript” xlink:href=“dsvg11/setData.js”/>
  <script type=“text/ecmascript” xlink:href=“dsvg11/mapProj.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
id=“text_1”>dSVG sample behavior: mapProj
  </text>
  <text y=“365” x=“20” font-size=“12” id=“content”>Content of file: dsvg:mapProj,
dsvg:mapCoords, dsvg:pointPair, dsvg:setData, dsvg:mousePosition
  </text>
  <text y=“380” x=“20” font-size=“12” id=“expected”>The dsvg:mapProj element
defines an object used for mapping coordinates from one project system to another.
  </text>
  <text y=“395” x=“20” font-size=“12” id=“depend”>For example, “latlong” can be
mapped to “UTM”.
  </text>
  <line y2=“340” x2=“744” y1=“340” x1=“0” stroke-width=“2” stroke=“#5f86B1”
fill=“#5f86B1” id=“bottom_line”/>
  <!-- adding behavior -->
  <text y=“65” x=“10” font-weight=“bold” id=“targetText”>Target Image
  </text>
  <image height=“371” width=“325” y=“0” x=“50” transform=“ translate(50 50)
scale(0.75)” xlink:href=“314_canutillo.jpg” id=“canutillo”>
    <dsvg:setData value=“%mousePosition@x%, %mousePosition@y%”
elementID=“textMousePosition” event=“onmousemove”/>
    <dsvg:setData value=“%pixelsToUTM@u%, %pixelsToUTM@v%”
elementID=“textUTM” event=“onmousemove”/>
    <dsvg:setData value=“%UTMToLatLong@latitude%
%UTMToLatLong@longitude%” elementID=“textLL” event=“onmousemove”/>
  </image>
  <dsvg:mousePosition type=“relative” elementID=“canutillo”
event=“onmousemove” id=“mousePosition”/>
  <dsvg:mapCoords inputID=“mousePosition” id=“pixelsToUTM”>
    <dsvg:pointPair v=“3534270” u=“346020” y=“0” x=“0”/>
    <dsvg:pointPair v=“3541920” u=“352710” y=“371” x=“325”/>
  </dsvg:mapCoords>
  <dsvg:mapProj zone=“13” ellipsoid=“WGS84” outputProj=“LatLong”
inputProj=“UTM” inputID=“pixelsToUTM” id=“UTMToLatLong”/>
  <text y=“285” x=“360”
style=“font-weight:normal;font-size:11;font-family:Tahoma;fill:#000000”>x,y:
  </text>
  <text y=“305” x=“360”
style=“font-weight:normal;font-size:11;font-family:Tahoma;fill:#000000”>UTM:
  </text>
  <text y=“325” x=“360”
style=“font-weight:normal;font-size:11;font-family:Tahoma;fill:#000000”>Lat/Long:
  </text>
  <text y=“285” x=“420”
style=“font-weight:normal;font-size:11;font-family:Tahoma;fill:#000000;”
id=“textMousePosition”>
  </text>
  <text y=“305” x=“420”
style=“font-weight:normal;font-size:11;font-family:Tahoma;fill:#000000;”
id=“textUTM”>
  </text>
  <text y=“325” x=“420”
style=“font-weight:normal;font-size:11;font-family:Tahoma;fill:#000000;” id=“textLL”>
  </text>
</svg>
```

Viewer Behavior Elements 24

SVG viewers allow a user to zoom in and out, and to pan, using a built-in UI, or by accessing the SVG DOM via script. There currently does not exists an SVG DOM API for playing a sound. One way to play a sound currently is via an Adobe (™) extension in the Adobe SVG Viewer.

A viewer behavior element 24 is used to manipulate viewer behavior with respect to the web application. An example of a viewer is an SVG pluggin for a web browser. In particular, the viewer behavior elements 24 assist a designer to zoom and pan the current document or a document fragment.

The attributes of a viewer behavior element 24 include an event attribute that triggers the viewer behavior element. The associated instruction 34 performs actions used to zoom and pan a document in a web application. Other actions may be performed by the associated implementation code 34.

Some behavior elements have attributes that provide the ID of other elements. For instance, <dsvg:setAttribute> uses an ‘elementID’ attribute to specify the target element whose attribute is to be modified. In such cases, the method of targeting other elements could be more robust. One example would be to have additional attributes that allow for the targeting of different frames, objects and documents in an HTML page, which would allow for behaviors in multiple SVG documents embedded in a single HTML document to interact with each other. Another example would be to use XPath expressions (http://www.w3.org/TR/xpath) rather than ID's to target elements. Using XPaths could also enable some behaviors to act upon multiple targets.

Viewer behavior elements 24 include the ‘alert’ element, the ‘function’ element, the ‘loadURL’ element, the ‘pan’ element, the ‘postURL’ element, the ‘zoom’ element, and the ‘playSound’ element. Examples of the viewer behavior elements 24 are provided below. The examples provide a syntax, a description and attributes of the viewer behavior elements 24. Other viewer behavior element 24 may be created. The provided viewer behavior elements 24 are examples of one implementation. The common attributes and viewer behavior elements 24 are presented as fragments of a sample document type definition (DTD).

Common Attributes

| <!ENTITY % stdBehaviorAttrs” | | |
|---|---|---|
| id | ID | #IMPLIED |
| event | %Text | #IMPLIED |
| eventKeyCode | %Text | #IMPLIED |
| eventKeyID | %Text | #IMPLIED |
| eventCharCode | %Text | #IMPLIED |
| eventChar | %Text | #IMPLIED > |

id = “name”

Standard XML attribute for assigning a unique name to an element.

event=‘<string>’

The name of the event that causes the behavior to be executed. This attribute can be set to either the event name or the event attribute name. The allowed values are: click, onclick, mousedown, onmousedown, mouseup, onmouseup, mouseover, onmouseover, mousemove, onmousemove, mouseout, onmouseout, SVGLoad, onload, SVGUnload, onunload, SVGResize, onresize, SVGScroll, onscroll, SVGZoom, onzoom, keydown, onkeydown, keypress, onkeypress, keyup and onkeyup. As well, it can be equal to ‘callback’, which is a dSVG semantic-level “virtual” event, triggered whenever one interacts with a UI control in such a manner as to cause its associated behaviours to be run. e.g. when a button is clicked on or when an item in a listBox is selected.

eventKeyCode=‘<string>’

The value of the ‘keyCode’ event attribute (automatically generated in response to ‘keydown’ and ‘keyup’ events) that causes the behavior to be executed. This attribute is only used if the ‘event’ attribute is set to ‘keydown’ or ‘keyup’ (or ‘onkeydown’ or ‘onkeyup’) and the actual event is equal to ‘keydown’ or ‘keyup’.

eventKeyID=‘<string>’

The key identifier for the ‘keyCode’ event attribute (automatically generated in response to ‘keydown’ and ‘keyup’ events) that causes the behavior to be executed. The keyID is a string representation of the ‘keyCode’ attribute of the ‘keydown’ or ‘keyup’ event that triggered the behavior, e.g. ‘Space’, ‘Enter’, ‘A’, etc. The keyID's resemble, as closely as possible, the key identifiers listed in the W3C Working Draft of the DOM Level 3 Events Specification. This attribute is only used if the ‘event’ attribute is set to ‘keydown’ or ‘keyup’ (or ‘onkeydown’ or ‘onkeyup’) and the actual event is equal to ‘keydown’ or ‘keyup’. If the ‘eventKeyCode’ attribute is provided, this attribute is ignored.

eventCharCode=‘<string>’

The value of the ‘charCode’ event attribute (automatically generated in response to the ‘keypress’ events) that causes the behavior to be executed. This attribute is only used if the ‘event’ attribute is set to ‘keypress’ (or ‘onkeypress’) and the actual event is equal to ‘keypress’.

eventChar=‘<string>’

The string representation of the ‘charCode’ event attribute (automatically generated in response to the ‘keypress’ events) that causes the behavior to be executed, e.g. ‘a’ or ‘A’. This attribute is only used if the ‘event’ attribute is set to ‘keypress’ (or ‘onkeypress’) and the actual event is equal to ‘keypress’. If the ‘eventCharCode’ attribute is provided, this attribute is ignored.

The ‘alert’ Element

```
  The ‘alert’ element displays a message in a popup window.
<!ENTITY % alertExt “” >
<!ELEMENT dsvg:alert EMPTY >
<!ATTLIST dsvg:alert
  %stdBehaviorAttrs;
  message %Text; #IMPLIED >
Attribute definitions:
message = ‘<string>’
```

The text to be displayed in the popup window.

FIG. 11 shows a push button 140 with an associated ‘alert’ behavior. The alert element is implemented as a dialog box 141 used to display a custom message. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px”
width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/alert.js”/>
  <script type=“text/ecmascript” xlink:href=“dsvg11/button.js”/>
  <!-- template -->
  <rect height=“40” width=“744” y=“0” x=“0”
  fill=“#5f86B1” id=“title_rect”/>
  <text y=“25” x=“20” font-weight=“bold” font-size=“18” fill=“white”
id=“text_1”>dSVG sample behavior: alert</text>
  <line y2=“350” x2=“744” y1=“350” x1=“0”
  stroke-width=“2” stroke=“#5f86B1”
fill=“#5f86B1” id=“bottom_line”/>
  <text y=“365” x=“20” font-size=“12” id=“content”>Content
  of file: dsvg:button,
dsvg:alert</text>
  <text y=“380” x=“20” font-size=“12” id=“expected”>The dsvg:alert
  element is a
dialog box used to display a custom message.</text>
  <!-- adding behavior -->
  <dsvg:button xlink:href=“dsvg/skinButton_Windows.svg#skinButton”
selected=“false” disabled=“false” toggle=“false” y=“70” x=“50”
label=“Fire alert” id=“dsvgUniqueID_0”>
    <dsvg:alert message=“Alert message” id=“dsvgUniqueID_2”/>
  </dsvg:button>
</svg>
```

The ‘function’ Element

The ‘function’ element is used to call an existing script function.

| <!ENTITY % functionExt “” > | | |
|---|---|---|
| <!ELEMENT dsvg:function EMPTY > | | |
| <!ATTLIST dsvg:function | | |
| name | %Text; | #IMPLIED |
| parameters | %Text; | #IMPLIED > |

Attribute Definitions:

name=‘<string>’

The name of the script function to call, not including brackets.

parameters=‘<string>’

The parameters, separated by commas, to be passed into the script function.

The function element example provided below shows a push button that invokes the ‘function’ behavior, which calls a script function.

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px”
width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/button.js”/>
  <script type=“text/ecmascript” xlink:href=“dsvg11/function.js”/>
  <!-- template -->
  <rect height=“40” width=“744” y=“0” x=“0”
  fill=“#5f86B1” id=“title_rect”/>
  <text y=“25” x=“20” font-weight=“bold” font-size=“18”
  fill=“white” id=
“text_1”>dSVG sample behavior:
  function</text>
  <text y=“365” x=“20” font-size=“12” id=“content”>Content of file:
dsvg:function,
  dsvg:button</text>
  <text y=“380” x=“20” font-size=“12” id= “expected”>The
  dsvg:function element
is a named procedure that performs a distinct set of
  parameters.</text>
  <line y2=“340” x2=“744” y1=“340” x1=“0” stroke-width=“2”
  stroke=“#5f86B1”
fill=“#5f86B1” id=“bottom_line”/>
  <!-- adding behavior -->
  <dsvg:button xlink:href=“dsvg/skinButton_Windows.svg#skinButton”
autoScale=“true” disabled=“false” selected=“false”
toggle=“false” height=“18”
width=“100” y=“70” x=“50” label=“Call
function” id=“dsvgUniqueID_0”>
    <dsvg:function parameters=“sample of dsvg:function” name=“alert”
id=“dsvgUniqueID_1”/>
  </dsvg:button>
</svg>
```

The ‘loadURL’ Element

The ‘loadURL’ element loads an SVG document and uses it to completely replace the existing SVG document.

<!ENTITY % loadURLExt “” >
<!ELEMENT dsvg:loadURL (%behaviors;) >
<!ATTLIST dsvg:loadURL
%stdBehaviorAttrs;

| | | |
|---|---|---|
| xmlns:xlink | CDATA | #FIXED ‘http://www.w3.org/1999/xlink’ |
| xlink:href | %URI; | #IMPLIED > |

Attribute Definitions:

xlink:href=“<uri>”

A reference to the URI that the data will be loaded from.

If the attribute is not specified, nothing will be loaded.

The loadURL element example provided below shows a push button with the associated ‘loadURL’ behavior.

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px”
width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/button.js”/>
  <script type=“text/ecmascript” xlink:href=“dsvg11/loadURL.js”/>
  <!-- template -->
  <rect height=“40” width=“744” y=“0” x=“0” fill=“#5f86B1” id=
  “title_rect”/>
  <text y=“25” x=“20” font-weight=“bold” font-size=“18”
  fill=“white” id=
“text_1”>dSVG sample behavior:
  loadURL</text>
  <text y=“365” x=“20” font-size=“12” id=“content”>Content of file:
dsvg:loadURL,
  dsvg:button</text>
  <text y=“380” x=“20” font-size=“12” id=“expected”>The
  dsvg:loadURL element
loads an SVG file.</text>
  <text y=“395” x=“20” font-size=“12” id=“depend”/>
  <line y2=“340” x2=“744” y1=“340” x1=“0” stroke-width=“2”
  stroke=“#5f86B1”
fill=“#5f86B1” id=“bottom_line” />
  <!-- adding behavior -->
  <dsvg:button xlink:href=“dsvg/skinButton_Windows.svg#skinButton”
autoScale=“true” disabled=“false” selected=“false” toggle=“false”
height=“18”
width=“100” y=“70” x=“50” label=“loadURL” id=“dsvgUniqueID_0”>
    <dsvg:loadURL xlink:href=“310.svg” id=“dsvgUniqueID_1”/>
  </dsvg:button>
</svg>
```

The ‘pan’ Element

The ‘pan’ element scrolls the document by the specified amount. Internally, this sets the SVG DOM's currentTranslate.x and currentTranslate.y variables, which should trigger a ‘scroll’ event.

| <!ENTITY % panExt “” > | | |
|---|---|---|
| <!ELEMENT dsvg:pan EMPTY > | | |
| <!ATTLIST dsvg:pan | | |
| %stdBehaviorAttrs; | | |
| x | %Integer; | #IMPLIED |
| y | %Integer; | #IMPLIED |
| type | %Type; | ‘relative’ > |

Attribute Definitions:

x=“<integer>”

The amount to scroll in the x-direction.

y=“<integer>”

The amount to scroll in the y-direction.

type=“(absolute|relative)”

Specifies whether to set the document's current translation to the specified ‘x’ and ‘y’ amounts (absolute) or to modify the document's current translation by the specified ‘x’ and ‘y’ amounts (relative).

If this attribute is not provided, the default is “relative”.

The pan element example provided below shows 4 buttons that invoke the ‘pan’ behavior to scroll the document in all 4 directions.

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/button.js”/>
  <script type=“text/ecmascript” xlink:href=“dsvg11/pan.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white” id=
“text_1”>dSVG sample behavior:
  pan</text>
  <text y=“365” x=“20” font-size=“12” id= “content”>Content of file:
  dsvg:pan</text>
  <text y=“380” x=“20” font-size=“12” id= “expected”>The dsvg:pan element
translates the x,y coordinates of a document by a specified
  amout.</text>
  <text y=“395” x=“20” font-size=“12” id= “depend”>The type of pan can be either
relative or
  absolute.</text>
  <line y2=“340” x2=“744” y1=“340” x1=“0” stroke-width=“2” stroke=“#5f86B1”
fill=“#5f86B1” id=“bottom_line”/>
  <!-- adding behavior -->
  <dsvg:button xlink:href=“dsvg/skinButton_Windows.svg#skinButton”
autoScale=“true” disabled=“false” selected=“false” toggle=“false” height=“18”
width=“100” y=“125” x=“100” label=“left” id=“dsvgUniqueID_0”>
    <dsvg:pan type=“relative” y=“0” x=“50” id=“dsvgUniqueID_1”/>
  </dsvg:button>
  <dsvg:button xlink:href=“dsvg/skinButton_Windows.svg#skinButton”
autoScale=“true” disabled=“false” selected=“false” toggle=“false” height=“18”
width=“100” y=“125” x=“300” label=“right” id=“dsvgUniqueID_5”>
    <dsvg:pan type=“relative” y=“0” x=“−50” id=“dsvgUniqueID_2”/>
  </dsvg:button>
  <dsvg:button xlink:href=“dsvg/skinButton_Windows.svg#skinButton”
autoScale=“true” disabled=“false” selected=“false” toggle=“false” height=“18”
width=“100” y=“100” x=“200” label=“up” id=“dsvgUniqueID_6”>
    <dsvg:pan type=“relative” y=“50” x=“0” id=“dsvgUniqueID_3”/>
  </dsvg:button>
  <dsvg:button xlink:href=“dsvg/skinButton_Windows.svg#skinButton”
autoScale=“true” disabled=“false” selected=“false” toggle=“false” height=“18”
width=“100” y=“150” x=“200” label=“down” id=“dsvgUniqueID_7”>
    <dsvg:pan type=“relative” y=“−50” x=“0” id=“dsvgUniqueID_4”/>
  </dsvg:button>
</svg>
```

The ‘postURL’ Element

The ‘postURL’ element loads a document or fragment (an element, possibly with children) and inserts it into the specified location in the DOM or into a new documentFragment (a lightweight document useful for storing XML data of a non-native format).

<!ENTITY % postURLExt “” >
<!ELEMENT dsvg:postURL (%behaviors;) >
<!ATTLIST dsvg:postURL
%stdBehaviorAttrs;

| | | |
|---|---|---|
| xmlns:xlink | CDATA | #FIXED ‘http://www.w3.org/1999/ |
| | | xlink’ |
| xlink:href | %URI; | #IMPLIED |
| collection | %Text; | IMPLIED |
| mimeType | %Text; | IMPLIED |
| synchronous | %Boolean; | “false” |
| elementID | ID; | #IMPLIED |
| insertAs | %InsertAs; | “child” |
| from | %From; | #IMPLIED |
| offset | %Integer; | #IMPLIED |
| ignoreText | %Boolean; | ‘false’ |
| ignoreCData | %Boolean; | ‘false’ |
| ignoreComments | %Boolean; | ‘false’ > |

Attribute Definitions:

xlink:href=“<uri>”

A reference to the URI that the data will be posted to.

If the attribute is not specified, the post will not occur.

collection=‘<string>’

The name of the collection group to post. All variables and aliases belonging to this collection group will be posted.

If this attribute is not provided, no data will be posted.

mimeType=‘<string>’

The mime type to be reported to the server.

synchronous=“(true|false)”

Specifies whether the returned XML data should be loaded synchronously or asynchronously. If synchronously, the next behavior will not be executed until after the XML has successfully loaded. If asynchronously, the next behavior will be executed immediately, without waiting for the XML to be loaded. For best performance, synchronous loading should only be used when subsequent behaviors will be accessing the XML data being loaded.

If this attribute is not provided, the default is “false”.

elementID=“name”

The ‘id’ attribute of the element at which the loaded element is to be inserted.

insertAs=“(parent|sibling|child|replacement|newDOM)”

Specifies whether the returned XML data is to be inserted as a child of the target element, as the parent of the target element, as a sibling of the target element, as a replacement to the target element, or as a replacement for the entire DOM.

If this attribute is not provided, the default is “child”.

offset=“<integer>”

If inserting as a child, ‘offset’ specifies the number of nodes (not including comment nodes) from the top or bottom (i.e. first or last child) where the returned XML data will be inserted. A negative value specifies up towards the first child. A positive value specifies down towards the last child. If there are fewer nodes than specified by ‘offset’, the returned element(s) will be inserted as either the first child or the last child.

If inserting as a sibling, ‘offset’ specifies the number of nodes (not including comment nodes) before (if ‘offset’ is negative) or after (if ‘offset’ is positive) the target element where the returned element(s) will be inserted. If there are fewer nodes than specified by ‘offset’, the element will be inserted as either the first child or the last child of the parent.

If inserting as a parent or replacement, ‘offset’ is ignored.

If this attribute is not provided, the default is 0.

from=“(top|bottom)”

If inserting as a child, ‘from’ specifies whether ‘offset’ is relative to the top (first child) or bottom (last child).

If inserting as a parent, sibling or replacement, ‘from’ is ignored.

If this attribute is not provided, the default is “bottom”.

ignoreText=“(true|false)”

Specifies whether text nodes should be ignored or not when counting ‘offset’ nodes from the target element.

If this attribute is not provided, the default is ‘false’.

ignoreCData=“(true|false)”

Specifies whether CDATA nodes should be ignored or not when counting ‘offset’ nodes from the target element.

If this attribute is not provided, the default is ‘false’.

ignorecomments=“(true|false)”

Specifies whether comment nodes should be ignored or not when counting ‘offset’ nodes from the target element.

If this attribute is not provided, the default is ‘false’.

The postURL element example provided below shows a textBox and comboBox whose data and selection gets posted to a URL.

```
<svg xmlns:dsvg=“http://www.corel.com/schemas/2002/dSVG11”
xmlns:xlink=“http://www.w3.org/1999/xlink” height=“420px” width=“760px”
onload=“init(evt)” viewBox=“0 0 760 420”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/textbox.js”/>
  <script type=“text/ecmascript” xlink:href=“dsvg11/combobox.js”>
  <script type=“text/ecmascript” xlink:href=“dsvg11/button.js”/>
  <script type=“text/ecmascript” xlink:href=“dsvg11/contextMenu.js”/>
  <script type=“text/ecmascript” xlink:href=“dsvg11/slider.js”/>
  <script type=“text/ecmascript” xlink:href=“dsvg11/listBox.js”/>
  <script type=“text/ecmascript” xlink:href=“dsvg11/scrollbar.js”/>
  <script type=“text/ecmascript” xlink:href=“dsvg11/postURL.js”/>
  <dsvg:variable saveState=“session” collection=“project”
value=“%‘text1’@value%” name=“text”/>
  <dsvg:variable saveState=“session” collection=“project”
value=“%‘cboColor’@value%” name=“fill”/>
  <dsvg:textBox xlink:href=“dsvg/skinTextbox_Default.svg#skinTextBox”
autoScale=“true” height=“22” width=“256.615” y=“105” x=“181” label=“Enter the text
that will appear on the third page” id=“text1”/>
  <dsvg:comboBox
xlink:href=“dsvg/skinComboBox_Composite.svg#SkinComboBox” autoScale=“true”
height=“17” width=“256.615” y=“179” x=“178” label=“Enter the color you want for the
rectangle” id=“cboColor”>
    <dsvg:item value=“blue” data=“blue” id=“item1”/>
    <dsvg:item value=“green” data=“green” id=“item2”/>
    <dsvg:item value=“red” data=“red” id=“item3”/>
    <dsvg:item value=“purple” data=“purple” id=“item4”/>
    <dsvg:item value=“navy” data=“navy” id=“item5”/>
  <dsvg:comboBox>
  <dsvg:button xlink:href=“dsvg/skinButton_Windows.svg#skinButton”
autoScale=“true” height=“18” width=“100” y=“247” x=“258” label=“postURL”
id=“postURL”>
    <dsvg:postURL insertAs=“newDOM” collection=“project”
xlink:href=“http://myURL.com/SessionTest/sgproxy.asp?CXS=Page2”
id=“dsvgUniqueID_10”/>
  </dsvg:button>
</svg>
```

The ‘zoom’ Element

The ‘zoom’ element scales the document by the specified amount. Internally, this sets the SVG DOM's currentScale variable, which should trigger a ‘zoom’ event.

| <!ENTITY % zoomExt “” > | | |
|---|---|---|
| <!ELEMENT dsvg:zoom EMPTY > | | |
| <!ATTLIST dsvg:zoom | | |
| %stdBehaviorAttrs; | | |
| scale | %Number; | #IMPLIED |
| cx | %Coordinate; | #IMPLIED |
| cy | %Coordinate; | #IMPLIED |
| type | %Type; | ‘relative’ > |

Attribute Definitions:

scale=“<number>”

The scale factor to zoom in or out by. A factor greater than 1 results in zooming in. A factor less than 1 results in zooming out.

cx=“<coordinate>”

The x-coordinate of the location in the document that will stay preserved after the zoom, with respect to the browser window.

y=“<coordinate>”

The y-coordinate of the location in the document that will stay preserved after the zoom, with respect to the browser window.

type=“(absolute|relative)”

Specifies whether to set the document's current scale to the specified ‘scale’ amount (absolute) or to modify the document's current scale by the specified ‘scale’ amount (relative).

If this attribute is not provided, the default is “relative”.

The zoom example provided below shows two buttons that invoke ‘zoom’ behaviors—one to zoom the document in by a factor of 2 and one to zoom the document out by a factor of 2.

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/zoom.js”/>
  <script type=“text/ecmascript” xlink:href=“dsvg11/attributeZoomAndPan.js”/>
  <script type=“text/ecmascript” xlink:href=“dsvg11/button.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white” id=
“text_1”>dSVG sample
  behavior:zoom</text>
  <text y=“365” x=“20” font-size=“12” id= “content”>Content of file: dsvg:zoom,
  dsvg:zoomAndPan</text>
  <text y=“380” x=“20” font-size=“12” id= “expected”>The dsvg:zoom element
will zoom in / zoom out by the amount specified in the scale
  attribute.</text>
  <text y=“395” x=“20” font-size=“12” id=“depend”/>
  <line y2=“340” x2=“744” y1=“340” x1=“0” stroke-width=“2” stroke=“#5f86B1”
fill=“#5f86B1” id=“bottom_line”/>
  <!-- adding behavior -->
  <dsvg:button dsvg:zoomAndPan=“magnify”
xlink:href=“dsvg/skinButtonZoomIn.svg#skinButtonZoomIn” autoScale=“true”
disabled=“false” selected=“false” toggle=“false” height=“21” width=“20” y=“100”
x=“120” label=“zoom in” id=“button_in”>
    <dsvg:zoom type=“relative” cy=“50.5” cx=“50.5” scale=“2”
id=“dsvgUniqueID_2”/>
  </dsvg:button>
  <dsvg:button xlink:href=“dsvg/skinButtonZoomOut.svg#skinButtonZoomOut”
autoScale=“true” disabled=“false” selected=“false” toggle=“false” height=“21”
width=“20” y=“100” x=“170” label=“zoom out” id=“button_out”>
    <dsvg:zoom type=“relative” cy=“50.5” cx=“50.5” scale=“0.5”
id=“dsvgUniqueID_3”/>
  </dsvg:button>
  <circle dsvg:zoomAndPan=“disable” r=“30” cy=“200” cx=“180”
stroke-width=“5” stroke=“darkred” fill=“red” id=“circle_disabled”/>
  <circle dsvg:zoomAndPan=“magnify” r=“30” cy=“200” cx=”350”
stroke-width=“5” stroke=“darkblue” fill=“#5f86B1” id=“circle_magnified”/>
  <text y=“330” x=“20” font-size=“10” id= “zoom_text”>dsvg:zoomAndPan
attributes applied to: Red circle (disabled) Blue circle
  (magnify)</text>
  <text y=“80” x=“50” font-size=“10” id=“zoom_text1”>Select the Zoom In /
Zoom Out
  buttons.</text>
</svg>
```

The ‘playSound’ Element

If the viewer 13 supports sound, then the playSound element may be implemented to plays an audio file. The following is the syntax for the ‘playSound’ element:

```
<dsvg:playSound
  id=“name”
  event=“String”
  xlink:href=“<uri>”
/>
```

The ‘id’ attribute is a standard XML attribute for assigning a unique “name” to an element. The ‘id’ attribute is optional. The ‘event’ attribute specifies the event that will trigger this action. The ‘xlink:href’ attribute specifies the audio file to play.

The Focus Element 25

Often in an application, a user desires to select an object or group of objects, via clicking or dragging a window around them, or even displaying a marquee around the selected object(s).

The ‘focus’ element defines a group of elements. Whenever an element, whose ‘focusGroup’ attribute is equal to the ‘id’ attribute of a ‘focus’ element, is clicked, the ‘focus’ element's child action elements will be executed, its ‘elementID’ attribute will be updated to reflect the ID of the element with focus, and its ‘elementName’ attribute will be updated to reflect the type of element with focus (e.g. ‘rect’, ‘circle’, etc.). As well, the ‘previousID’ and ‘previousName’ attributes are also stored for reference, so that the behaviors can be “undone” for the previously selected element.

| <!ENTITY % focusExt“” > | | |
|---|---|---|
| <!ELEMENT dsvg:focus (%Behaviors;) > | | |
| <!ATTLIST dsvg:focus | | |
| %stdBehaviorAttrs; | | |
| elementID | ID | #IMPLIED |
| elementName | %Text | #IMPLIED |
| previousID | ID | #IMPLIED |
| previousName | %Text | #IMPLIED > |

Attribute Definitions:

elementID=“name”

The ‘id’ attribute of the element currently with focus.

If this attribute is provided, the element with that ID will have the initial focus and the ‘focus’ element's child behaviors will be run.

elementName=‘<string>’

The name of the element currently with focus. e.g. ‘rect’, ‘circle’, etc.

previousID=“name”

The ‘id’ attribute of the element previously with focus.

previousName=‘<string>’

The name of the element previously with focus. e.g. ‘rect’, ‘circle’, etc.

FIGS. 12A and 12B show circle and text elements in different focus groups, each setting the other. The focuGroup attribute adds the ability to store the ID of similar type elements that are assigned to that group. Default focus can be given to an element by adding the focus attribute to that element. The example is provided below:

```
<?xml version=“1.0” standalone=“no”?>
<!DOCTYPE svg SYSTEM “../SVGdSVG.dtd”>
<svg xmlns:xlink=“http://www.w3.org/1999/xlink”
xmlns:dsvg=“http://www.corel.com/schemas/2002/dSVG11” height=“410px”
width=“744px” onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/focus.js”/>
  <script type=“text/ecmascript” xlink:href=“dsvg11/setAttribute.js”/>
  <script type=“text/ecmascript” xlink:href=“dsvg11/setStyle.js”/>
  <script type=“text/ecmascript” xlink:href=“dsvg11/setTransform.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
id=“text_1”>dSVG sample behavior: focus - with added attributes focusGroup and focus
  </text>
  <text y=“365” x=“20” font-size=“12” id=“content”>Content of file: dsvg:focus,
dsvg:setTransform, dsvg:setAttribute, dsvg:setStyle, (added attributes dsvg:focus,
dsvg:focusGroup)
  </text>
  <text y=“380” x=“20” font-size=“12” id=“expected”>The dsvg:focusGroup
attribute adds the ability to store the ID of similar type elements that are assigned to that
group.
  </text>
  <text y=“395” x=“20” font-size=“12” id=“depend”>Default focus can be given to
an element (red circle above) by adding the dsvg:focus attribute to that element.
  </text>
  <line y2=“340” x2=“744” y1=“340” x1=“0” stroke-width=“2” stroke=“#5f86B1”
fill=“#5f86B1” id=“bottom_line”/>
  <!-- adding behavior -->
  <text y=“250” x=“20” font-size=“12” id=“desc”>The red, blue, green circles are
part of the focusGroup. The orange circle is not.
  </text>
  <text y=“150” x=“200” font-size=“12” id=“desc_2”>Click on the red, green and
blue circles to set focus.
  </text>
  <text y=“170” x=“200” font-size=“12” id=“desc_3”>Hover over the ‘red’, ‘green’
and ‘blue’ text elements to set focus.
  </text>
  <dsvg:focus elementID=“redCircle” event=“onclick” id=“circleGroup”>
    <dsvg:setTransform scale=“1.2” vAlign=“middle” hAlign=“middle”
absolute=“true” elementID=“%circleGroup@elementID%”/>
    <dsvg:setTransform scale=“1” vAlign=“middle” hAlign=“middle”
absolute=“true” elementID=“%circleGroup@previousID%”/>
    <dsvg:setAttribute value=“%(circleGroup@elementID)@fill%Text”
attribute=“elementID” elementID=“textGroup”/>
  </dsvg:focus>
  <dsvg:focus event=“onmouseover” id=“textGroup”>
    <dsvg:setStyle value=“%(textGroup@elementID)@cdata%”
property=“fill” elementID=“%textGroup@elementID%”/>
    <dsvg:setStyle value=“black” property=“fill”
elementID=“%textGroup@previousID%”/>
    <dsvg:setAttribute value=“%(textGroup@elementID)@cdata%Circle”
attribute=“elementID” elementID=“circleGroup”/>
  </dsvg:focus>
  <circle dsvg:focus=“true” dsvg:focusGroup=“circleGroup” r=“30” cy=“100”
cx=“50” fill=“red” id=“redCircle”/>
  <circle dsvg:focusGroup=“circleGroup” r=“30” cy=“200” cx=“50” fill=“blue”
id=“blueCircle”/>
  <circle dsvg:focusGroup=“circleGroup” r=“30” cy=“100” cx=“150” fill=“green”
id=“greenCircle”/>
  <circle r=“30” cy=“200” cx=“150” fill=“orange” id=“orangeCircle”/>
  <text dsvg:focus=“true” dsvg:focusGroup=“textGroup” y=“80” x=“200”
id=“redText”>red</text>
  <text dsvg:focusGroup=“textGroup” y=“80” x=“250” id=“blueText”>blue</text>
  <text dsvg:focusGroup=“textGroup” y=“80” x=“300”
id=“greenText”>green</text>
  <text y=“80” x=“350”>orange</text>
</svg>
```

The Constraint Element 26

One feature missing from SVG markup is the concept of constraints. A designer may desire zoom-dependent visibility of labels on a map. Another desire may be to have the coordinates or dimensions of one element to be dependent on the coordinates or dimensions of another element.

The ‘constraint’ element 26 defines the rules for constraining anything about a target element, such as its attributes, style properties, bounding box and dimensions due to transformations, zoom and pan. The appropriate mutation event listeners are automatically set based on the attributes so that the ‘event’ attribute is not required.

| <!ENTITY % constraintExt “” > | | |
|---|---|---|
| <!ELEMENT dsvg:constraintEMPTY > | | |
| <!ATTLIST dsvg:constraint | | |
| %stdBehaviorAttrs; | | |
| elementID | ID | #IMPLIED |
| ancestorID | ID | #IMPLIED |
| numAncestors | %Integer; | #IMPLIED |
| attributeName | %Text; | #IMPLIED |
| propertyName | %Text; | #IMPLIED |
| value | %Text; | #IMPLIED |
| scaleImmunity | %Boolean; | “false” |
| scaleXImmunity | %Boolean; | “false” |
| scaleYImmunity | %Boolean; | “false” |
| preserveAspectRatio | %PreserveAspectRatio; | “false” |
| hAlign | %HAlign; | “none” |
| vAlign | %Valign; | “none” |
| width | %Length; | #IMPLIED |
| height | %Length; | #IMPLIED |
| left | %Coordinate; | #IMPLIED |
| right | %Coordinate; | #IMPLIED |
| top | %Coordinate; | #IMPLIED |
| bottom | %Coordinate; | #IMPLIED > |

Attribute Definitions:

elementID=“name”

The ‘id’ attribute of the target element.

If this attribute is not provided, the target element is the parent of the ‘constraint’ element.

ancestorID=“name”

The ‘id’ attribute of an ancestor of the target element. Used to calculate the cumulative transform between the ancestor element and the target element. The cumulative transform is the transformation matrix from the user coordinate system on the target element (after application of the ‘transform’ attribute) to the user coordinate system on the ancestor element (after application of its ‘transform’ attribute). This cumulative transform will be nullified if the ‘scaleImmunity’, ‘scaleXImmunity’ or ‘scaleYImmunity’ attribute is set to ‘true.

If this attribute is not provided, the ancestor element is assumed to be the target element's parent.

numAncestors=“<integer>”

The number of ancestors from the target element. Used instead of the ‘ancestorID’ attribute to locate the target element's ancestor when its ‘id’ attribute is not known.

If the ‘ancestorID’ is provided, this attribute is ignored. If this attribute is not provided, the ancestor element is assumed to be the target element's parent.

attributeName=‘<string>’

The name of the attribute to be constrained (e.g. ‘stroke-width’).

propertyName=‘<string>’

The name of the property, within a ‘style’ attribute, to be constrained (e.g. ‘stroke-width’).

value=‘<string>’

The value that the attribute or style property is to be given. If the constraint specifies scale or zoom immunity, this attribute will be ignored, as it will be calculated automatically to counteract the scale or zoom.

scaleImmunity=“(true|false)”

Specifies that the cumulative transform between the ancestor element and the target element is to be nullified. The cumulative transform is the transformation matrix from the user coordinate system on the target element (after application of the ‘transform’ attribute) to the user coordinate system on the ancestor element (after application of its ‘transform’ attribute). If neither the ‘attributeName’ nor the ‘propertyName’ is specified, then the cumlative transform will be counteracted with an equal but inverse transform applied to the target element. If either the ‘attributeName’ or the ‘prppertyName’ is specified, then the corresponding attribute or style property (e.g. ‘stroke-width’) of the target element will appear to be immune to scaling relative to the specified ancestor element. Essentially, the value of the attribute or style property will be modified so as to compensate for the scale factor of the cumulative transform. For non-uniform scaling, the larger of the two scale factors is compensated for. Note that applying scale immunity to an attribute or style property that is not of type <length> (e.g. ‘fill’) would not make sense.

scaleXImmunity=“(true|false)”

The same as ‘scaleimmunity’ except that for non-uniform scaling, the scale factor along the x-axis will be compensated for, instead of the larger of the two scale factors being compensated for.

scaleYImmunity=“(true|false)”

The same as ‘scalelmmunity’ except that for non-uniform scaling, the scale factor along the y-axis will be compensated for, instead of the larger of the two scale factors being compensated for.

preserveAspectRatio=“(vertical|horizontal|min|max|none)”

Specifies the dimension whose length is to be preserved, thus scaling the target element in the other dimension so as to preserve the original aspect ratio (unaltered by a transformation). If ‘vertical’, then the object will be scaled along the x-axis. If ‘horizontal’, then the object will be scaled along the y-axis. If ‘min’, then the scale factors along both axes will be examined and the greater of the two will be set to be equal to the lesser of the two. If ‘max’, then the scale factors along both axes will be examined and the lesser of the two will be set to be equal to the greater of the two.

If this attribute is not provided, its default is “none”, meaning that the aspect ratio will not be preserved.

hAlign=“(left|middle|right)”

The part of the target element, along the x-axis, that is to have its position preserved after executing the constraint. For example, preserveAspectRatio=“vertical” might cause the target element to be scaled along the x-axis, causing its horizontal position to change. Specifying hAlign=“right” would cause the right edge of the target element to remain at the same x-coordinate after the constraint is applied.

vAlign=“(top|middle|bottom)”

The part of the target element, along the y-axis, that is to have its position preserved after executing the constraint. For example, preserveAspectRatio=“horizontal” might cause the target element to be scaled along the y-axis, causing its horizontal position to change. Specifying vAlign=“top” would cause the top edge of the target element to remain at the same y-coordinate after the constraint is applied.

width=“<length>”

The width that the target element must be. For example, if the target element is a ‘g’ tag (a group) containing many elements, its bounding box is calculated, from which its total width is determined, and an appropriate scale factor is applied along the x-axis to achieve the specified width.

height=“<length>”

The height that the target element must be. For example, if the target element is a ‘g’ tag (a group) containing many elements, its bounding box is calculated, from which its total height is determined, and an appropriate scale factor is applied along the y-axis to achieve the specified height.

left=“<coordinate>”

The x-coordinate where the left edge of the target element must be. For example, if the target element is a ‘g’ tag (a group) containing many elements, its bounding box is calculated, from which the x-coordinate of its left edge is determined, and an appropriate translation is applied along the x-axis to achieve the specified position. If the ‘right’ attribute is also specified, both edges will be set, which will likely also require a scale transformation.

right=“<coordinate>”

The x-coordinate where the right edge of the target element must be. For example, if the target element is a ‘g’ tag (a group) containing many elements, its bounding box is calculated, from which the x-coordinate of its right edge is determined, and an appropriate translation is applied along the x-axis to achieve the specified position. If the ‘left’ attribute is also specified, both edges will be set, which will likely also require a scale transformation.

top=“<coordinate>”

The y-coordinate where the top edge of the target element must be. For example, if the target element is a ‘g’ tag (a group) containing many elements, its bounding box is calculated, from which the y-coordinate of its top edge is determined, and an appropriate translation is applied along the y-axis to achieve the specified position. If the ‘bottom’ attribute is also specified, both edges will be set, which will likely also require a scale transformation.

bottom=“<coordinate>”

The y-coordinate where the bottom edge of the target element must be. For example, if the target element is a ‘g’ tag (a group) containing many elements, its bounding box is calculated, from which the y-coordinate of its bottom edge is determined, and an appropriate translation is applied along the y-axis to achieve the specified position. If the ‘top’ attribute is also specified, both edges will be set, which will likely also require a scale transformation.

Other Elements

Other elements may be added to the system 20:

The ‘action’ Element

The ‘action’ element is a container used to group dSVG behaviors with common ‘event’ attribute values together so that the behavior elements do not actually need to specify the ‘event’ attribute themselves. It is also used to indirectly associate its child behaviors to an element; via the ‘listener’ element, allowing them to be reused.

<!ENTITY % actionExt “” >
<!ELEMENT dsvg:action (%Behaviors;) >
<!ATTLIST dsvg:action
%stdBehaviorAttrs; >

FIGS. 13A and 13B show a push button 161 and a circle 162, both with indirectly associated behaviors. The action element is a container for other behavior elements. Actions can be associated indirectly using a listener element, or they can be set up directly as a child of an observing element. The example is provided below:

<?xml version=“1.0” standalone=“no”?>
<!DOCTYPE svg SYSTEM “../SVGdSVG.dtd”>
<svg xmlns:xlink=“http://www.w3.org/1999/xlink”
xmlns:dsvg=“http://www.corel.com/schemas/2002/dSVG11” height=“410px”
width=“744px” onload=“init(evt)” viewBox=“0 0 744 410”>

<script type=“text/ecmascript” xlink:href=“dsvg11/dSVG.js”/>
<script type=“text/ecmascript” xlink:href=“dsvg11/baseUI.js”/>
<script type=“text/ecmascript” xlink:href=“dsvg11/constraint.js”/>
<script type=“text/ecmascript” xlink:href=“dsvg11/setAttribute.js”/>
<script type=“text/ecmascript” xlink:href=“dsvg11/button.js”/>
<script type=“text/ecmascript” xlink:href=“dsvg11/setData.js”/>
<!-- template -->
<g id=“template”>

<rect height=“40” width=“744” y=“0” x=“0” fill=“#5f86B1”

id=“title_rect”/>

<text y=“25” x=“20” font-weight=“bold” font-size=“18” fill=“white”

id=“text_1”>dSVG sample behavior: action and listener

</text>
<text y=“365” x=“20” font-size=“12” id=“content”>Content of file:

dsvg:action, dsvg:listener

</text>
<text y=“380” x=“20” font-size=“12” id=“expected”>The dsvg:action

element is a container for other dSVG behavior elements.

</text>
<text y=“395” x=“20” font-size=“12” id=“depend”>Actions can be

associated indirectly using a listener element, or they can be set up directly as a child of
an observing element.

</text>
<line y2=“340” x2=“744” y1=“340” x1=“0” stroke-width=“2”

stroke=“#5f86B1” fill=“#5f86B1” id=“bottom_line”/>

<text y=“85” x=“140” font-size=“12” id=“text_desc1”>1. Sample of an

indirect ‘action / listener’ observed by a UI Control.

</text>
<text y=“115” x=“140” font-size=“12” id=“text_desc2”>2. Sample of a

direct ‘action’ set up as child of the UI Control.

</text>
<text y=“205” x=“140” font-size=“12” id=“text_desc3”>3. Sample of an

indirect ‘action / listener’ observed by a basic SVG element.

</text>
<text y=“265” x=“140” font-size=“12” id=“text_desc4”>4. Sample of a

direct ‘action’ set up as a child of a basic SVG element.

</text>
<text y=“60” x=“20” font-weight=“bold” font-size=“12”

id=“text_desc3a”>Click the button(s) to execute the behaviors.

</text>
<text y=“160” x=“20” font-weight=“bold” font-size=“12”

id=“text_desc4a”>Mouseover the SVG shapes to execute the behaviors.

</text>
<text y=“70” x=“627” font-weight=“bold” font-size=“12”

id=“target_text”>Target circle

</text>

</g>
<!-- adding behavior -->
<g id=“actions”>

<dsvg:listener handler=“actionGreen” observer=“circle_1”

event=“mouseover” id=“listenerGreen”/>

<dsvg:listener handler=“actionRed” observer=“button_1” event=“callback”

id=“listenerRed”/>

<dsvg:action id=“actionGreen”>

<dsvg:setAttribute value=“green” attribute=“fill”

elementID=“circle_2” id=“dsvgUniqueID_3”/>

<dsvg:setData value=“# 3” elementID=“textNumber”

id=“dsvgUniqueID_12a”/>

</dsvg:action>
<dsvg:action id=“actionRed”>

<dsvg:setAttribute value=“red” attribute=“fill”

elementID=“circle_2” id=“dsvgUniqueID_13”/>

<dsvg:setData value=“# 1” elementID=“textNumber”

id=“dsvgUniqueID_12c”/>

</dsvg:action>

</g>
<dsvg:button xlink:href=“dsvg11/skinButton_Windows.svg#skinButton”

autoScale=“true” disabled=“false” selected=“false” toggle=“false” height=“18”
width=“100” y=“70” x=“20” label=“Fire action” id=“button_1”/>

<dsvg:button xlink:href=“dsvg11/skinButton_Windows.svg#skinButton”

autoScale=“true” disabled=“false” selected=“false” toggle=“false” height=“18”
width=“100” y=“100” x=“20” label=“Fire action” id=“button_2”>

<dsvg:action id=“actionOrange”>

<dsvg:setAttribute value=“orange” attribute=“fill”

elementID=“circle_2” id=“dsvgUniqueID_13”/>

<dsvg:setData value=“# 2” elementID=“textNumber”

id=“dsvgUniqueID_12b”/>

</dsvg:action>

</dsvg:button>
<circle r=“25” cy=“200” cx=“75” stroke-width=“5” stroke=“darkblue”

fill=“#5f86B1” id=“circle_1”/>

<circle r=“50” cy=“132” cx=“662” stroke-width=“5” stroke=“black” fill=“none”

id=“circle_2”/>

<rect height=“50” width=“50” y=“240” x=“50” stroke-width“5”

stroke=“darkblue” fill=“#5f86B1” id=“rect_1”>

<dsvg:action event=“onmouseover” id=“actionGold”>

<dsvg:setAttribute value=“#5f86B1” attribute=“fill”

elementID=“circle_2” id=“dsvgUniqueID_9”/>

<dsvg:setData value=“# 4” elementID=“textNumber”

id=“dsvgUniqueID_12”/>

</dsvg:action>

</rect>
<rect height=“150” width=“150” y=“50” x=“584” stroke-width=“2”

stroke=“black” fill=“none” id=“base_rect”/>

<text y=“145” x=“662” text-anchor=“middle” font-size=“36” fill=“white”

id=“textNumber”>#

</text>

</svg>

The ‘alias’ Element

The ‘alias’ element acts as a proxy, or representative, for some other value, such as an attribute of an element. An ‘alias’ element differs from a ‘variable’ element in that an alias has a 1:1 relationship with its reference, whereas a variable can be an equation made up of multiple references. This 1:1 relationship allows the reference's value to be changed by modifying the ‘alias’ element. An ‘alias’ element functions as a ‘variable’ element when posting with the ‘postURL’ element, except that ‘alias’ uses the value of its reference. If a server's response to the ‘postURL’ behavior contains ‘alias’ elements, their ‘initialValue’ attributes will be applied to their references. Thus an ‘alias’ element is used to bring data back into the document, e.g. for session management.

| <!ENTITY % aliasExt “” > | | |
|---|---|---|
| <!ELEMENT dsvg:alias EMPTY > | | |
| <!ATTLIST dsvg:alias | | |
| id | name | #IMPLIED |
| name | %Text; | #IMPLIED |
| initialValue | %Text; | #IMPLIED |
| reference | %Text; | #IMPLIED |
| saveState | %Text; | #IMPLIED |
| collection | %Text; | #IMPLIED > |

Attribute Definitions:

id=“name”

Standard XML attribute for assigning a unique name to an element.

name=‘<string>’

The identifier for the alias, used to access its value via the dSVG expression syntax.

initialValue=‘<string>’

The value to be applied to the reference at load time.

reference=‘<string>’

A specific attribute of a specific element, denoted using the dSVG expression syntax, e.g. %myComboBox@value%.

saveState=“(session|page|application)”

Indicates the purpose of the ‘alias’ element. When posting the alias to a server, the values of ‘page’, ‘application’ or ‘session’ are appropriate, & will be stored on the server for durations according to those categories.

collection=‘<string>’

An identifier used to group variables for scoping purposes. For example, collection1.myVar is different than collection2.myVar. Also, one can specify the collection name when posting to a server, which will send all variables in that collection.

The ‘listener’ Element

The ‘listener’ element listens for the specified event on the observer element and, if found, dispatches the event to the handler behavior element (typically an ‘action’ element) for processing. This is useful because the behaviors are not directly associated to the observer element, thus allowing them to be reused.

| <!ENTITY % listenerExt “” > | | |
|---|---|---|
| <!ELEMENT dsvg:listener (%Behaviors;) > | | |
| <!ATTLIST dsvg:listener | | |
| %stdBehaviorAttrs; | | |
| observer | ID | #IMPLIED |
| handler | ID | #IMPLIED > |

FIGS. 13A and 13B show a push button 161 and a circle 162, both with indirectly associated behaviors. The example is provided below:

<?xml version=“1.0” standalone=“no”?>
<!DOCTYPE svg SYSTEM “../SVGdSVG.dtd”>
<svg xmlns:xlink=“http://www.w3.org/1999/xlink”
xmlns:dsvg=“http://www.corel.com/schemas/2002/dSVG11” height=“410px”
width=“744px” onload=“init(evt)” viewBox=“0 0 744 410”>

<script type=“text/ecmascript” xlink:href=“dsvg11/dSVG.js”/>
<script type=“text/ecmascript” xlink:href=“dsvg11/baseUI.js”/>
<script type=“text/ecmascript” xlink:href=“dsvg11/constraint.js”/>
<script type=“text/ecmascript” xlink:href=“dsvg11/setAttribute.js”/>
<script type=“text/ecmascript” xlink:href=“dsvg11/button.js”/>
<script type=“text/ecmascript” xlink:href=“dsvg11/setData.js”/>
<!-- template -->
<g id=“template”>

<rect height=“40” width=“744” y=“0” x=“0” fill=“#5f86B1”

id=“title_rect”/>

<text y=“25” x=“20” font-weight=“bold” font-size=“18” fill=“white”

id=“text_1”>dSVG sample behavior: action and listener

</text>
<text y=“365” x=“20” font-size=“12” id=“content”>Content of file:

dsvg:action, dsvg:listener

</text>
<text y=“380” x=“20” font-size=“12” id=“expected”>The dsvg:action

element is a container for other dSVG behavior elements.

</text>
<text y=“395” x=“20” font-size=“12” id=“depend”>Actions can be

associated indirectly using a listener element, or they can be set up directly as a child of
an observing element.

</text>
<line y2=“340” x2=“744” y1=“340” x1=“0” stroke-width=“2”

stroke=“#5f86B1” fill=“#5f86B1” id=“bottom_line”/>

<text y=“85” x=“140” font-size=“12” id=“text_desc1”>1. Sample of an

indirect ‘action / listener’ observed by a UI Control.

</text>
<text y=“115” x=“140” font-size=“12” id=“text_desc2”>2. Sample of a

direct ‘action’ set up as child of the UI Control.

</text>
<text y=“205” x=“140” font-size=“12” id=“text_desc3”>3. Sample of an

indirect ‘action / listener’ observed by a basic SVG element.

</text>
<text y=“265” x=“140” font-size=“12” id=“text_desc4”>4. Sample of a

direct ‘action’ set up as a child of a basic SVG element.

</text>
<text y=“60” x=“20” font-weight=“bold” font-size=“12”

id=“text_desc3a”>Click the button(s) to execute the behaviors.

</text>
<text y=“160” x=“20” font-weight=“bold” font-size=“12”

id=“text_desc4a”>Mouseover the SVG shapes to execute the behaviors.

</text>
<text y=“70” x=“627” font-weight=“bold” font-size=“12”

id=“target_text”>Target circle

</text>

</g>
<!-- adding behavior -->
<g id=“actions”>

<dsvg:listener handler=“actionGreen” observer=“circle_1”

event=“mouseover” id=“listenerGreen”/>

<dsvg:listener handler=“actionRed” observer=“button_1” event=“callback”

id=“listenerRed”/>

<dsvg:action id=“actionGreen”>

<dsvg:setAttribute value=“green” attribute=“fill”

elementID=“circle_2” id=“dsvgUniqueID_3”>

<dsvg:setData value=“# 3” elementID=“textNumber”

id=“dsvgUniqueID_12a”/>

</dsvg:action>
<dsvg:action id=“actionRed”>

<dsvg:setAttribute value=“red” attribute=“fill”

elementID=“circle_2” id=“dsvgUniqueID_13”/>

<dsvg:setData value=“# 1” elementID=“textNumber”

id=“dsvgUniqueID_12c”/>

</dsvg:action>

</g>
<dsvg:button xlink:href=“dsvg11/skinButton_Windows.svg#skinButton”

autoScale=“true” disabled=“false” selected=“false” toggle=“false” height=“18”
width=“100” y=“70” x=“20” label=“Fire action” id=“button_1”/>

<dsvg:button xlink:href=“dsvg11/skinButton_Windows.svg#skinButton”

autoScale=“true” disabled=“false” selected=“false” toggle=“false” height=“18”
width=“100” y=“100” x=“20” label=“Fire action” id=“button_2”>

<dsvg:action id=“actionOrange”>

<dsvg:setAttribute value=“orange” attribute=“fill”

elementID=“circle_2” id=“dsvgUniqueID_13”/>

<dsvg:setData value=“# 2” elementID=“textNumber”

id=“dsvgUniqueID_12b”/>

</dsvg:action>

</dsvg:button>
<circle r=“25” cy=“200” cx=“75” stroke-width=“5” stroke=“darkblue”

fill=“#5f86B1” id=“circle_1”/>

<circle r=“50” cy=“132” cx=“662” stroke-width=“5” stroke=“black” fill=“none”

id=“circle_2”/>

<rect height=“50” width=“50” y=“240” x=“50” stroke-width=“5”

stroke=“darkblue” fill=“#5f86B1” id=“rect_1”>

<dsvg:action event=“onmouseover” id=“actionGold”>

<dsvg:setAttribute value=“#5f86B1” attribute=“fill”

elementID=“circle_2” id=“dsvgUniqueID_9”/>

<dsvg:setData value=“# 4” elementID=“textNumber”

id=“dsvgUniqueID_12”/>

</dsvg:action>

</rect>
<rect height=“150” width=“150” y=“50” x=“584” stroke-width=“2”

stroke=“black” fill=“none” id=“base_rect”/>

<text y=“145” x=“662” text-anchor=“middle” font-size=“36” fill=“white”

id=“textNumber”>#

</text>

</svg>

The ‘variable’ Element

The ‘variable’ element acts as a proxy or representative for some other value, such as an attribute of an element. A ‘variable’ element can have a 1:1 relationship with an attribute or be an equation made up of multiple attributes and constants. Variables are intended as a convenient way of storing data as well as building complex expressions that can be used anywhere via dSVG expressions. Note that it is the author's responsibility to not create self referential variables or circular variable references.

| <!ENTITY % variableExt “” > | | |
|---|---|---|
| <!ELEMENT dsvg:variable EMPTY> | | |
| <!ATTLIST dsvg:variable | | |
| id | ID | #IMPLIED |
| name | %Text; | #IMPLIED |
| value | %Text; | #IMPLIED |
| saveState | %Text; | #IMPLIED |
| collection | %Text; | #IMPLIED> |

Attribute Definitions:

id=“name”

Standard XML attribute for assigning a unique name to an element.

name=‘<string>’

The identifier for the variable, used to access its value via the dSVG expression syntax.

value=‘<string>’

The value to be applied to the reference at load time.

saveState=“(session|page|application)”

Indicates the purpose of the ‘variable’ element. When posting the variable to a server, the values of ‘page’, ‘application’ or ‘session’ are appropriate, & will be stored on the server for durations according to those categories.

collection=‘<string>’

An identifier used to group variables together, for scoping purposes. For example, collection1.myVar is different than collection2.myVar. Also, one can specify the collection name when posting to a server, which will send all variables in that collection.

FIGS. 14A and 14B show a variable set to be the sum of the width of two rectangles. The variable element is able to assume different values. Selecting the button 175 will set a new value for the ‘variable’ ($varRect). The example is provided below:

<?xml version=“1.0” standalone=“no”?>
<!DOCTYPE svg SYSTEM “../SVGdSVG.dtd”>
<svg xmlns:xlink=“http://www.w3.org/1999/xlink”
xmlns:dsvg=“http://www.corel.com/schemas/2002/dSVG11” height=“420px”
width=“760px” onload=“init(evt)” viewBox=“0 0 760 420”>

<script type=“text/ecmascript” xlink:href=“dsvg11/dSVG.js”/>
<script type=“text/ecmascript” xlink:href=“dsvg11/baseUI.js”/>
<script type=“text/ecmascript” xlink:href=“dsvg11/constraint.js”/>
<script type=“text/ecmascript” xlink:href=“dsvg11/button.js”/>
<script type=“text/ecmascript” xlink:href=“dsvg11/setAttribute.js”/>
<script type=“text/ecmascript” xlink:href=“dsvg11/setData.js”/><!-- template -->
<rect height=“40” width=“744” y=“0” x=“0” fill=“#5f86B1” id=“title_rect”/>
<text y=“25” x=“20” font-weight=“bold” font-size=“18” fill=“white”

id=“text_1”>dSVG sample behavior: variable

</text>
<text y=“365” x=“20” font-size=“12” id=“content”>Content of file: dsvg:variable
</text>
<text y=“380” x=“20” font-size=“12” id=“expected”>The dsvg:variable element is able

to assume different values.

</text>
<text y=“395” x=“20” font-size=“12” id=“depend”>Selecting the button will set a

new value for the ‘variable’ ($varRect).

</text>
<line y2=“340” x2=“744” y1=“340” x1=“0” stroke-width=“2” stroke=“#5f86B1”

fill=“#5f86B1” id=“bottom_line”/><!-- adding behavior -->

<dsvg:variable value=“%redRect@width + blueRect@width%” name=“varRect”

id=“variableRect”/>

<rect height=“50” width=“50” y=“100” x=“50” stroke=“darkred”

stroke-width=“5” fill=“red” id=“redRect”/>

<rect height=“50” width=“50” y=“180” x=“50” stroke=“darkblue”

stroke-width=“5” fill=“#5f86B1” id=“blueRect“/>

<text y=“95” x=“50” id=“textRedRect”>width = 50
</text>
<text y=“175” x=“50” id=“textBlueRect”>width = 50
</text>
<text y=“175” x=“150” id=“textDesc3”>Note: Once the button is selected,

setAttribute is applied to the blue rect so width=“previous ‘$varRect’ value”

</text>
<dsvg:button xlink:href=“dsvg11/skinButton_Windows.svg#skinButton”

autoScale=“true” height=“18” width=“100” y=“295” x=“50” label=“New Variable”
id=“dsvgUniqueID_1”>

<dsvg:setAttribute value=“%$varRect%” attribute=“width”

elementID=“blueRect” id=“setAttRect”/>

<dsvg:setData value=“width = %blueRect@width%”

elementID=“textBlueRect” id=“setTextBlueRect”/>

<dsvg:setData value=“$varRect = %$varRect%” elementID=“text1”

id=“setTextVar”/>

</dsvg:button>
<text y=“259” x=“50” id=“textDesc”>$varRect = redRect@width +

blueRect@width

</text>
<text y=“310” x=“170” id=“text1”>$varRect = 100
</text>

</svg>

The ‘share’ Element

The ‘share’ element is a container used to group any dSVG elements that are intended to be shared children of multiple SVG elements or dSVG UI controls. If an element has the dSVG attribute ‘share’, equal to the ‘id’ attribute of a dSVG ‘share’ element, then the children of that ‘share’ element are treated as children of the element with the ‘share’ attribute. Note that the children of the ‘share’ element are not copied—they exist only in one location and are shared, like “virtual” children.

<!ENTITY % shareExt “ ”>

<!ELEMENT dsvg:share (%UIControls;|%Behaviors;|dsvg:item)*>

<!ATTLIST dsvg:share

%stdBehaviorAttrs;>

FIG. 15 shows a listBox 190 and a comboBox 191, both sharing the same ‘item’ elements as their children. The share element is used to share a group of items with multiple elements. The document in this example shares the same set of items with the combo box and the list box. Associate a share element with other elements by adding a share attribute to the element that references the share element. The example is provided below:

<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“450px” width=“744px”
onload=“init(evt)” viewBox=“0 0 744 450”>

<script type=“text/ecmascript” xlink:href=“dsvg11/dSVG.js”/>
<script type=“text/ecmascript” xlink:href=“dsvg11/baseUI.js”/>
<script type=“text/ecmascript” xlink:href=“dsvg11/constraint.js”/>
<script type=“text/ecmascript” xlink:href=“dsvg11/listbox.js”/>
<script type=“text/ecmascript” xlink:href=“dsvg11/button.js”/>
<script type=“text/ecmascript” xlink:href=“dsvg11/contextMenu.js”/>
<script type=“text/ecmascript” xlink:href=“dsvg11/scrollbar.js”/>
<script type=“text/ecmascript” xlink:href=“dsvg11/slider.js”/>
<script type=“text/ecmascript” xlink:href=“dsvg11/combobox.js”/>
<script type=“text/ecmascript” xlink:href=“dsvg11/textbox.js”/>
<!-- Adding Template -->
<g id=“template”>

<rect height=“40” width=“744” y=“0” x=“0” fill=“#5f86B1”

id=“rect_Title”/>

<text y=“25” x=“20” font-weight=“bold” font-size=“18” fill=“white”

id=“TITLE”>dSVG sample: Share element

</text>
<line y2=“350” x2=“744” y1=“350” opacity=“1.0” stroke-width=“2”

stroke=“#5F86B1” fill=“#5F86B1” id=“bottomLine”/>

<text y=“370” x=“20” font-size=“12” id=“defaut_ex”>The share element is

used to share a group of items with multiple elements.

</text>
<text y=“395” x=“20” font-size=“12” id=“small_ex”>This document

shares the same set of items with the combo box and the list box.

</text>
<text y=“420” x=“20” font-size=“12” id=“large_ex”>Associate a share

element with other elements by adding a dsvg:share attribute to the element that
references the share element.

</text>

</g>
<!-- adding controls -->
<dsvg:share id=“share_1”>

<dsvg:item value=“STOP” data=“red” id=“item_1”>

<dsvg:itemData value=“Octagon” name=“shape”/>

</dsvg:item>
<dsvg:item value=“YIELD” data=“yellow” id=“item_2”>

<dsvg:itemData value=“Triangle” name=“shape”/>

</dsvg:item>
<dsvg:item value=“GO” data=“green” id=“item_3”>

<dsvg:itemData value=“Circle” name=“shape”/>

</dsvg:item>

</dsvg:share>
<dsvg:listBox dsvg:share=“share_1”

xlink:href=“dsvg11/skinListBox_Composite.svg#skinListBox” autoScale=“true”
height=“60” width=“198” y=“70” x=“50” label=“List box: (default attributes with the
added attribute dsvg:share)” id=“listbox_1”/>

<dsvg:comboBox dsvg:share=“share_1”

xlink:href=“dsvg11/skinComboBox_Composite.svg#skinComboBox” autoScale=“true”
height=“17” width=“217” y=“220” x=“50” label=“Combo box: (default attributes with the
added attribute dsvg:share)” id=“combobox_1”/>
</svg>

Passive Attributes 27

A common feature in a web application is to be able to zoom and pan on the content without the UI controls zooming and panning. This capability does not exist in SVG markup. Scripting is required to detect the SVGScale, SVGScroll and SVGResize events, and create a transformation on all elements that should be immune to zooming and panning, which will counteract the zoom or pan.

A passive attribute 27 is applied to one or more DOM elements for applying passive behavior to objects in a web application. By adding a passive attributes 27 to an element, other elements can then reference the passive attribute 27. Referencing attributes will be discussed below.

For example, if there is a legend placed in the bottom corner of the screen on a map, the ‘g’ (group) element that contains the legend subtree could be given the passive attributes zoom=“false” and pan=“false”. Thus, if the map were then zoomed or panned, the legend would continue to stay at the bottom corner of the screen.

The following attributes can be applied to an element in a DOM:

| <!ENTITY % stdDSVGAttrs” | | |
|---|---|---|
| dsvg:drag | %Boolean | “false” |
| dsvg:focus | %Boolean | “false” |
| dsvg:focusGroup | ID | #IMPLIED |
| dsvg:share | ID | #IMPLIED |
| dsvg:zoomAndPan | (disable \| magnify) | “magnify” > |

drag=“(true|false)”

Specifies whether the element is movable (true) or not (false) by clicking and dragging it with the mouse.

focus=“(true|false)”

Specifies whether the element has been selected or not. Selecting any object which has the ‘focusGroup’ attribute, via the event specified in the ‘focus’ element (e.g. onmouseover, onclick, etc.), does the following: causes its ‘focus’ attribute to be set to “true”, sets the ‘focus’ attribute of other elements belonging to the same focusGroup to “false” and sets the ‘focus’ element's ‘elementID’ to be the ID of the element with focus.

focusGroup=“name”

Specifies the ‘id’ attribute of the associated ‘focus’ element. Selecting any object which has the ‘focusGroup’ attribute, via the event specified in the ‘focus’ element (e.g. onmouseover, onclick, etc.), causes its ‘focus’ attribute to be set to “true”, sets the ‘focus’ attribute of other elements belonging to the same focusGroup to “false” and sets the ‘focus’ element's ‘elementID’ to be the ID of the element with focus.

share=“name”

Specifies the ‘id’ attribute of an existing ‘share’ element, causing the share element's children to be treated as children of this element as well. The children are not copied—they are instead used, or shared, by multiple elements.

zoomAndPan=“(disable|magnify)”

Specifies whether the element is immune to zooming and panning (disable) or not (magnify).

The ‘drag’ Attribute

The ‘drag’ attribute specifies whether the element is movable (true) or not (false) by clicking and dragging it with the mouse. FIGS. 16A and 16B show a circle 201 and button 202 that are draggable, as well as a circle 203 and button 204 that are not draggable. The drag attribute is applied to elements to set the drag to either true or false. The example is provided below:

<?xml version=“1.0” standalone=“no”?>
<!DOCTYPE svg SYSTEM “../SVGdSVG.dtd”>
<svg dsvg:drag=“true” xmlns:xlink=“http://www.w3.org/1999/xlink”
xmlns:dsvg=“http://www.corel.com/schemas/2002/dSVG11” height=“420px”
width=“760px” onload=“init(evt)” viewBox=“0 0 760 420”>

<script type=“text/ecmascript” xlink:href=“dsvg11/dSVG.js”/>
<script type=“text/ecmascript” xlink:href=“dsvg11/baseUI.js”/>
<script type=“text/ecmascript” xlink:href=“dsvg11/constraint.js”/>
<script type=“text/ecmascript” xlink:href=“dsvg11/button.js”/>
<script type=“text/ecmascript” xlink:href=“dsvg11/attributeDrag.js”/>
<!-- template -->
<rect height=“40” width=“744” y=“0” x=“0” fill=“#5f86B1” id=“title_rect”/>
<text y=“25” x=“20” font-weight=“bold” font-size=“18” fill=“white”

id=“text_1”>dSVG sample: drag (added attribute)

</text>
<text y=“365” x=“20” font-size=“12” id=“content”>Content of file: dsvg:drag
</text>
<text y=“380” x=“20” font-size=“12” id=“expected”>The dsvg:drag attribute is

applied to elements to set the drag to either true or false.

</text>
<text y=“395” x=“20” font-size=“12” id=“depend”/>
<line y2=“340” x2=“744” y1=“340” x1=“0” stroke-width=“2” stroke=“#5f86B1”

fill=“#5f86B1” id=“bottom_line”/>

<!-- adding behavior -->
<circle dsvg:drag=“true” r=“30” cy=“150” cx=“100” stroke-width=“5”

stroke=“darkblue” fill=“#5f86B1” id=“circle_true”/>

<circle dsvg:drag=“false” r=“30” cy=“270” cx=“100” stroke-width=“5”

stroke=“darkred” fill=“red” id=“circle_false”/>

<dsvg:button dsvg:drag=“true”

xlink:href=“dsvg11/skinButton_Windows.svg#skinButton” autoScale=“true”
disabled=“false” selected=“false” toggle=“false” height=“18” width=“100” y=“140”
x=“300” label=“drag (true)” id=“button_true”/>

<dsvg:button dsvg:drag=“false”

xlink:href=“dsvg11/skinButton_Windows.svg#skinButton” autoScale=“true”
disabled=“false” selected=“false” toggle=“false” height=“18” width=“100” y=“260”
x=“300” label=“drag (false)” id=“button_false”/>

<text y=“110” x=“20” id=“text_true”>Blue circle has drag=“true”
</text>
<text y=“230” x=“20” id=“text_true2”>Red circle has drag=“false”
</text>
<text y=“110” x=“300” id=“text_true3”>Button has drag=“true”
</text>
<text y=“230” x=“300” id=“text_true4”>Button has drag=“false”
</text>
<text y=“70” x=“20” id=“text_true5”>Select each of the objects and attempt to

drag to another position.

</text>

</svg>

The ‘focus’ Attribute

The ‘focus’ attribute specifies whether the element has been selected or not. Selecting any object which has the ‘focusGroup’ attribute, via the event specified in the ‘focus’ element (e.g. onmouseover, onclick, etc.), does the following: causes its ‘focus’ attribute to be set to “true”, sets the ‘focus’ attribute of other elements belonging to the same focusGroup to “false”, and sets the ‘focus’ element's ‘elementID’ to be the ID of the element with focus.

FIGS. 17A and 17B show circle and text elements in different focus groups, each setting the other. The example is provided below:

```
<?xml version=“1.0” standalone=“no”?>
<!DOCTYPE svg SYSTEM “../SVGdSVG.dtd”>
<svg xmlns:xlink=“http://www.w3.org/1999/xlink”
xmlns:dsvg=“http://www.corel.com/schemas/2002/dSVG11” height=“410px”
width=“744px” onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/focus.js”/>
  <script type=“text/ecmascript” xlink:href=“dsvg11/setAttribute.js”/>
  <script type=“text/ecmascript” xlink:href=“dsvg11/setStyle.js”/>
  <script type=“text/ecmascript” xlink:href=“dsvg11/setTransform.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
id=“text_1”>dSVG sample behavior: focus - with added attributes focusGroup and focus
  </text>
  <text y=“365” x=“20” font-size=“12” id=“content”>Content of file: dsvg:focus,
dsvg:setTransform, dsvg:setAttribute, dsvg:setStyle, (added attributes dsvg:focus,
dsvg:focusGroup)
  </text>
  <text y=“380” x=“20” font-size=“12” id=“expected”>The dsvg:focusGroup
attribute adds the ability to store the ID of similar type elements that are assigned to that
group.
  </text>
  <text y=“395” x=“20” font-size=“12” id=“depend”>Default focus can be given to
an element (red circle above) by adding the dsvg:focus attribute to that element.
  </text>
  <line y2=“340” x2=“744” y1=“340” x1=“0” stroke-width=“2” stroke=“#5f86B1”
fill=“#5f86B1” id=“bottom_line”/>
  <!-- adding behavior -->
  <text y=“250” x=“20” font-size=“12” id=“desc”>The red, blue, green circles are
part of the focusGroup. The orange circle is not.
  </text>
  <text y=“150” x=“200” font-size=“12” id=“desc_2”>Click on the red, green and
  blue circles to set focus.
  </text>
  <text y=“170” x=“200” font-size=“12” id=“desc_3”>Hover over the ‘red’, ‘green’
  and ‘blue’ text elements to set focus.
  </text>
  <dsvg:focus elementID=“redCircle” event=“onclick” id=“circleGroup”>
    <dsvg:setTransform scale=“1.2” vAlign=“middle” hAlign=“middle”
  absolute=“true” elementID=“%(circleGroup@elementID%”/>
    <dsvg:setTransform scale=“1” vAlign=“middle” hAlign=“middle”
  absolute=“true” elementID=“%circleGroup@previousID%”/>
    <dsvg:setAttribute value=“%(circleGroup@elementID)@fill%Text”
  attribute=“elementID” elementID=“textGroup”/>
  </dsvg:focus>
  <dsvg:focus event=“onmouseover” id=“textGroup”>
    <dsvg:setStyle value=“%(textGroup@elementID)@cdata%”
  property=“fill” elementID=“%textGroup@elementID%”/>
    <dsvg:setStyle value=“black” property=“fill”
  elementID=“%textGroup@previousID%”/>
    <dsvg:setAttribute value=“%(textGroup@elementID)@cdata%Circle”
  attribute=“elementID” elementID=“circleGroup”/>
  </dsvg:focus>
  <circle dsvg:focus=“true” dsvg:focusGroup=“circleGroup” r=“30” cy=“100”
  cx=“50” fill=“red” id=“redCircle”/>
  <circle dsvg:focusGroup=“circleGroup” r=“30” cy=“200” cx=“50” fill=“blue”
  id=“blueCircle”/>
  <circle dsvg:focusGroup=“circleGroup” r=“30” cy=“100” cx=“150” fill=“green”
  id=“greenCircle”/>
  <circle r=“30” cy=“200” cx=“150” fill=“orange” id=“orangeCircle”/>
  <text dsvg:focus=“true” dsvg:focusGroup=“textGroup” y=“80” x=“200”
  id=“redText”>red</text>
  <text dsvg:focusGroup=“textGroup” y=“80” x=“250” id=“blueText”>blue</text>
  <text dsvg:focusGroup=“textGroup” y=“80” x=“300”
  id=“greenText”>green</text>
  <text y=“80” x=“350”>orange</text>
  </svg>
```

The ‘focusGroup’ Attribute

The ‘focusGroup’ attribute specifies the ‘id’ attribute of the associated ‘focus’ element. Selecting any object which has the ‘focusGroup’ attribute, via the event specified in the ‘focus’ element (e.g. onmouseover, onclick, etc.), does the following: causes its ‘focus’ attribute to be set to “true”, sets the ‘focus’ attribute of other elements belonging to the same focusGroup to “false”, and sets the ‘focus’ element's ‘elementID’ to be the ID of the element with focus.

The ‘share’ Attribute

The ‘share’ attribute specifies the ‘id’ attribute of an existing ‘share’ element, causing the child elements of the ‘share’ element to be treated as children of this element as well. The children are not copied—they are instead used, or shared, by multiple elements. FIG. 15 shows a listBox 190 and a comboBox 191, both sharing the same ‘item’ elements as their children. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“450px” width=“744px”
onload=“init(evt)” viewBox=“0 0 744 450”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/listbox.js”/>
  <script type=“text/ecmascript” xlink:href=“dsvg11/button.js”/>
  <script type=“text/ecmascript” xlink:href=“dsvg11/contextMenu.js”/>
  <script type=“text/ecmascript” xlink:href=“dsvg11/scrollbar.js”/>
  <script type=“text/ecmascript” xlink:href=“dsvg11/slider.js”/>
  <script type=“text/ecmascript” xlink:href=“dsvg11/combobox.js”/>
  <script type=“text/ecmascript” xlink:href=“dsvg11/textbox.js”/>
  <!-- Adding Template -->
  <g id=“template”>
    <rect height=“40” width=“744” y=“0” x=“0” fill=“#5f86B1”
id=“rect_Title”/>
    <text y=“25” x=“20” font-weight=“bold” font-size=“18” fill=“white”
id=“TITLE”>dSVG sample: Share element
    </text>
    <line y2=“350” x2=“744” y1=“350” opacity=“1.0” stroke-width=“2”
stroke=“#5F86B1” fill=“#5F86B1” id=“bottomLine”/>
    <text y=“370” x=“20” font-size=“12” id=“defaut_ex”>The share element is
used to share a group of items with multiple elements.
    </text>
    <text y=“395” x=“20” font-size=“12” id=“small_ex”>This document
shares the same set of items with the combo box and the list box.
    </text>
    <text y=“420” x=“20” font-size=“12” id=“large_ex”>Associate a share
element with other elements by adding a dsvg:share attribute to the element that
references the share element.
    </text>
    </g>
    <!-- adding controls -->
  <dsvg:share id=“share_1”>
    <dsvg:item value=“STOP” data=“red” id=“item_1”>
      <dsvg:itemData value=“Octagon” name=“shape”/>
    </dsvg:item>
    <dsvg:item value=“YIELD” data=“yellow” id=“item_2”>
      <dsvg:itemData value=“Triangle” name=“shape”/>
    </dsvg:item>
    <dsvg:item value=“GO” data=“green” id=“item_3”>
      <dsvg:itemData value=“Circle” name=“shape”/>
    </dsvg:item>
  </dsvg:share>
  <dsvg:listBox dsvg:share=“share_1”
xlink:href=“dsvg11/skinListBox_Composite.svg#skinListBox” autoScale=“true”
height=“60” width=“198” y=“70” x=“50” label=“List box: (default attributes with the
added attribute dsvg:share)” id=“listbox_1”/>
  <dsvg:comboBox dsvg:share=“share_1”
xlink:href=“dsvg11/skinComboBox_Composite.svg#skinComboBox” autoScale=“true”
height=“17” width=“217” y=“220” x=“50” label=“Combo box: (default attributes with the
added attribute dsvg:share)” id=“combobox_1”/>
</svg>
```

The ‘zoomAndPan’ Attribute

The ‘zoomAndPanAttribute’ attribute specifies whether the element is immune to zooming and panning (disable) or not (magnify).

FIGS. 18A and 18B shows two circles 205 and 206, one of which 205 is immune to zooming and panning. The zoom element will zoom in/zoom out by the amount specified in the scale attribute. The example is provided below:

```
<?xml version=“1.0” standalone=“no”?>
<!DOCTYPE svg SYSTEM “../SVGdSVG.dtd”>
<svg xmlns:dsvg=“http://www.corel.com/schemas/2002/dSVG11”
xmlns:xlink=“http://www.w3.org/1999/xlink” height=“410px” width=“744px”
onload=“init(evt)” viewBox=“0 0 744 410”>
  <script type=“text/ecmascript” xlink:href=“dsvg11/dSVG.js”/>
  <script type=“text/ecmascript” xlink:href=“dsvg11/baseUI.js”/>
  <script type=“text/ecmascript” xlink:href=“dsvg11/constraint.js”/>
  <script type=“text/ecmascript” xlink:href=“dsvg11/zoom.js”/>
  <script type=“text/ecmascript” xlink:href=“dsvg11/attributeZoomAndPan.js”/>
  <script type=“text/ecmascript” xlink:href=“dsvg11/button.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
  id=“text_1”>dSVG sample: zoomAndPan (added attribute)
  </text>
  <text y=“365” x=“20” font-size=“12” id=“content”>Content of file: dsvg:zoom,
  dsvg:zoomAndPan
  </text>
  <text y=“380” x=“20” font-size=“12” id=“expected”>The dsvg:zoom element will
  zoom in / zoom out by the amount specified in the scale attribute.
  </text>
  <text y=“395” x=“20” font-size=“12” id=“depend”/>
  <line y2=“340” x2=“744” y1=“340” x1=“0” stroke-width=“2” stroke=“#5f86B1”
  fill=“#5f86B1” id=“bottom_line”/>
  <!-- adding behavior -->
  <dsvg:button dsvg:zoomAndPan=“magnify”
xlink:href=“dsvg11/skinButtonZoomIn.svg#skinButtonZoomIn” autoScale=“true”
disabled=“false” selected=“false” toggle=“false” height=“21” width=“20” y=“100”
x=“120” label=“zoom in” id=“button_in”>
    <dsvg:zoom type=“relative” cy=“50.5” cx=“50.5” scale=“2”
id=“dsvgUniqueID_2”/>
  </dsvg:button>
  <dsvg:button xlink:href=“dsvg11/skinButtonZoomOut.svg#skinButtonZoomOut”
autoScale=“true” disabled=“false” selected=“false” toggle=“false” height=“21”
width=“20” y=“100” x=“170” label=“zoom out” id=“button_out”>
    <dsvg:zoom type=“relative” cy=“50.5” cx=“50.5” scale=“0.5”
id=“dsvgUniqueID_3”/>
  </dsvg:button>
  <circle dsvg:zoomAndPan=“disable” r=“30” cy=“200” cx=“180”
stroke-width=“5” stroke=“darkred” fill=“red” id=“circle_disabled”/>
  <circle dsvg:zoomAndPan=“magnify” r=“30” cy=“200” cx=“350”
stroke-width=“5” stroke=“darkblue” fill=“#5f86B1” id=“circle_magnified”/>
  <text y=“330” x=“20” font-size=“10” id=“zoom_text”>dsvg:zoomAndPan
attributes applied to: Red circle (disabled) Blue circle (magnify)
  </text>
  <text y=“80” x=“50” font-size=“10” id=“zoom_text1”>Select the Zoom In / Zoom
Out buttons.
  </text>
</svg>
```

Other items may be added to the collection of designated items. For example, behavior elements and user interface control elements may be added along with their associated scripts.

In the example described above, the function was dynamically generated, i.e., a string was created, having the same prefix as the designated element (without the colon) and the same name as the designated element (except with the first letter capitalized) and with the designated element's object and the trigger event object passed in as two parameters. The associated script 38 or set of instructions for the operations of the generated function is stored in a predetermined format either in the document text file or in a separate text file on a file system or webserver, and is loaded into memory by the viewer at load time. Alternatively, the initialization function may search for elements that begin with the “dsvg:” prefix and, using an ‘if’ or ‘switch’ statement, determine the appropriate predetermined function to call, which again are expected to have been already loaded in memory by the viewer.

It is advantageous, though, for the function names to be generated dynamically, so that the main script file containing the initialization function 21 does not need to be updated whenever a new type of designated element 39 has been created and is available for use.

As well, while the functions 38 that handle each type of designated element 38 could be stored all in one file, it is advantageous to store them in separate files and reference them in the document only if their corresponding designated element 38 is being used, so that only the code that is required is actually transmitted.

In order for designated elements 38 to execute desired actions, behavior elements may be inserted as children of the designated elements 38 (the observer elements). The behavior element will be executed sequentially for each behavior element whose ‘event’ attribute's value matches the observer element's event (e.g., onmouseover, onclick, etc.). If the ‘event’ attribute is not provided, the behavior will default to be run on the ‘onclick’ event. In the example below, clicking on the ‘buttonZoomIn’ button will cause the processing of the child elements of the button, and the zoom behavior will be executed, scaling the document by a factor of 2, while clicking on the ‘buttonZoomOut’ button will scale the document by a factor of 0.5.

```
<dsvg:button id=“buttonZoomIn” x=“10” y=“10” label=“Zoom In”
xlink:href=“#skinZoomInButton”>
  <zoom scale=“2”/>
  </dsvg:button>
  <dsvg:button id=“buttonZoomOut” x=“10” y=“40” label=“Zoom Out”
  xlink:href=“#skinZoomOutButton”>
    <zoom scale=“0.5”/>
  </dsvg:button>
```

Alternatively, the behavior elements may be grouped as children of an <action> element (or behavior element), which can be hooked up to the observer element using a <listener> element. For example:

```
<dsvg:button id=“buttonZoomIn” x=“10” y=“10” label=“Zoom In”
xlink:href=“#skinZoomInButton”/>
<dsvg:button id=“buttonZoomOut” x=“10” y=“40” label=“Zoom Out”
xlink:href=“#skinZoomOutButton”/>
<dsvg:action id=“zoomIn”>
  <zoom scale=“2”/>
</dsvg:action>
<dsvg:action id=“zoomOut”>
  <zoom scale=“0.5”/>
</dsvg:action>
<dsvg:listener event=“onclick” observerElementID=“buttonZoomIn”
handlerID=“zoomIn”/>
<dsvg:listener event=“onclick” observerElementID=“buttonZoomOut”
handlerID=“zoomOut”/>
```

Thus, during the document load, the onclick event of the buttonZoomOut element is associated with the zoomOut action, via the listener that identifies observerElementID=“buttonZoomOut”. When this button is clicked, the children of the zoomOut action will be processed, scaling the document by a factor of 0.5.

FIG. 19 shows an example of a method of extending the interactivity of a presentation markup language at load time (40) in accordance with the SVG interactivity extension system 20, 30. At load time, after the viewer has finished building the DOM and loading the script, the method (40) begins with an initialization function being run by the viewer's script interpreter, which determines if the first DOM element is a designated element (41). If a designated element is found (42), then the name of the function associated with the designated element is automatically generated (43) (in accordance with a predetermined function naming convention) and called (44). Preferably, the predetermined function naming convention is similar to the predetermined element naming convention. If a designated element is not found (42), or after a generated function is called (44), the method determines if there are more elements in the DOM to search (45). If there are more elements in the DOM (45), the method determines if the next sibling element is a designated element (46). The process is repeated until all elements in the DOM are searched. Once there are no more elements in the DOM to search (45), then the method is done (47).

FIG. 20 shows an example of a method of extending the interactivity of presentation markup languages (50) (e.g., SVG, HTML), in accordance with the SVG interactivity extension system 20, 30. The method (50) manipulates a DOM of a web application in response to an event. The event may be the “onload” event when a DOM is loaded into a viewer 13. The SVG interactivity extension system 20, 30 is built on top of an event-driven architecture, such as SVG and XML. Once an event occurs on an SVG element (i.e., the observer element), the method (50) begins with passing the event object to a handler function (51). The handler function determines if the first child element of the SVG element associated with the object is a designated element (52). If a designated element is found (53), then the handler function determines if the event attribute 24 of the designated element is equal to the event that has occurred (54). If the event attribute 24 of the designated element is equal to the event which triggered this method (50), then the name of the function associated with the designated element is automatically generated (55) (in accordance with a predetermined function naming convention) and called (56). Preferably, the predetermined function naming convention is similar to the predetermined element naming convention. If a designated element is not found (53), or if the event attribute 24 of the designated element does not match the trigger event (54), or after a generated function is called (56), the event handler determines if there are more child elements of the observer element to search (57). If there are more child elements of the observer element (57), the event handler determines if the next child is a designated element (58). Steps (53) to (58) are repeated until all child elements of the observer element are searched. Once there are no more child elements to search (57), then the handler function is done (59).

An initialization file may be added to also search for designated attributes in SVG elements. Instructions 38 may be created and associated with the ‘dsvg’ attribute in the same manner as with UI control elements. Instructions (or script functions) 38 for ‘dsvg’ attributes only operate on the object associated with the existing element to which a ‘dsvg’ attribute is added. A designer may add the ‘dsvg’ attribute in an SVG file, or any other XML file to be parsed by the viewer 13.

FIG. 21 shows another example of an method of extending the interactivity of presentation markup languages (60) (e.g., SVG, HTML), in accordance with the SVG interactivity extension system 20, 30. The method (60) manipulates a DOM of a web application. After a user (or designer) marks up an SVG file using the markup syntax of the SVG interactivity extension system 20, 30 and the SVG file is loaded into a viewer 13, the viewer 13 creates an “onload” event which is received by an <svg> element. The method (60) begins with an initialization function. A dsvgInit( ) initialization function 21 is called (61) by the viewer's script interpreter 14, which traverses the nodes of the DOM of the SVG file. The initialization function determines if the first DOM element is a designated element 29, 39 (62). If a designated element 39 is found (63) and the ‘event’ attribute of the designated element 28 is set to “onload” (64), then the name of the function or instruction 38 associated with the designated element 29, 39 is automatically generated (65) (in accordance with a predetermined function naming convention) and called (66). Preferably, the predetermined function naming convention is similar to the predetermined element naming convention. If a designated element 29, 39 is not found (63), the initialization function determines if the regular SVG element contains any designated attributes 27 (67) (which begin with the “dsvg:” prefix). If any designated attributes 27 are found (67) (e.g., dsvg:toolTip=“#skinTooltip_traditional”), then the names of the functions 37 associated with the designated attributes are automatically generated (68) (again, in accordance with a predetermined function naming convention) and called (69).

If a designated attribute 27 is not found (67), then the initialization file determines if the regular SVG element has any child elements (70). If the regular SVG element has a child element (70) and the child element is a designated element 29, 39 (71), then the initialization file determines the value of the designated element's ‘event’ attribute (i.e., the event that will trigger the execution of the designated element's associated function) and adds that event listener to the parent SVG element (72) (via the addEventListener( ) DOM API). If the child element is not a designated element 29, 39 (71), then the initialization file determines if there are any other children of the regular SVG element (73). If there are more children (73), then the initialization file searches the next child of the regular SVG element (74). Steps (71) to (74) repeat until there are no more children of the regular SVG element.

If there are no more children of the regular SVG element (73), or after a generated function is called (76, 79), or if the event attribute of a designated element is not equal to “onload” (74), or there are no more child elements in a regular SVG element to search (70), the initialization file determines if there are more elements in the DOM to search (75). If there are more elements in the DOM (75), the initialization file determines if the next sibling element is a designated element (76). Steps (73) to (76) are repeated until all elements in the DOM are searched. Once there are no more elements in the DOM to search (75), then the initialization function is done and the viewer 13 waits for an event to occur (77).

Once an event occurs on an SVG element (i.e., the observer element), that event object is passed to a handler function with which it has been associated (78). The handler function determines if any child of the observer element is a designated element 29, 39 (79). The event handler function calls the appropriate code or script 28, 38 (as described in FIG. 6) for any child of the observer element that is a designated element 29, 39 (80). Once all children of the observer element are processed (80), then the event handler function is done and the viewer waits for another event to occur (77).

Referencing Attributes

To create an application, a designer often desires to reference the current value of another element's attributes. An expression syntax is created to allow the attribute values of elements to be dynamic. With expressions, attribute values can be dependent on the real-time values of other attributes in the DOM. This syntax is intended to be simpler to use than XPath and ECMAScript, and to provide a subset of their most commonly used features.

In one embodiment of an expression syntax, expressions are denoted by the %% characters. Whatever is contained with the % characters gets evaluated. The basic unit of reference is elementID@attributeName. For example, %myRectangle@width% would be resolved to the numeric value of the width attribute of the element //.[@id=“myRectangle”] (as denoted with the XPath expression). This syntax is therefore intended to be used in documents where elements have unique ID's. Note that the attributeName can have a namespace prefix for any namespace declared in the document.

Preferably, the following unit pattern is used for the expression syntax:

```
    elementID@attributeName | elementID@nameSpace:attributeName
  Some behaviors, like ‘loadXML’, can create document fragments. These are
named at the time of creation and can be referred to within %% expressions, as follows:
      docID.elementID@nameSpace:attributeName
  Special attribute extensions include a bounding box, CDATA (the text between
the opening and closing tags, e.g. <text>This is the CDATA</text>), and event attributes.
The bounding box extensions include the following:
```

| | |
|---|---|
| elementID@bbox.x : | returns the x-coordinate of the element's bounding box (i.e. |
| | the left) |
| elementID@bbox.y : | returns the y-coordinate of the element's bounding box (i.e. |
| | the top) |

```
  elementID@bbox.width : returns the width of the element's bounding box
  elementID@bbox.height : returns the height of the element's bounding box
A CDATA extension includes:
  elementID@cdata : returns the text content of the element
Event Attribute extensions included the following:
```

| | |
|---|---|
| @event.type: | returns the type of event that triggered the behavior (e.g. |
| | ‘mouseover’, ‘SVGResize’, ‘keypress’, etc.) |

| | |
|---|---|
| @event.targetNodeName: | returns the nodeName of the element that was the |
| | target of the event that triggered the behavior |

| | |
|---|---|
| @event.targetID: | returns the ‘id’ attribute of the element that was the target of |
| | the event that triggered the behavior |

| | |
|---|---|
| @event.currentTargetNodeName: | returns the nodeName of the element that |
| | observed the event that triggered the |
| | behavior |

| | |
|---|---|
| @event.currentTargetID: | returns the ‘id’ attribute of the element that observed |
| | the event that triggered the behavior |

| | |
|---|---|
| @event.shiftKey: | returns ‘true’ if the Shift-key is pressed, ‘false’ otherwise. |
| @event.ctrlKey: | returns ‘true’ if the Ctrl-key is pressed, ‘false’ otherwise. |
| @event.keyCode: | returns the keyCode attribute of the ‘keydown’ or ‘keyup’ |
| | event that triggered the behavior. |
| @event.keyID: | returns the key identifier--a string representation of the |
| | keyCode attribute of the ‘keydown’ or ‘keyup’ event that |
| | triggered the behavior (e.g. ‘Space’, ‘Enter’, ‘a’). |
| @event.charCode: | returns the charCode attribute of the ‘keypress’ event that |
| | triggered the behavior. |

| | |
|---|---|
| @event.char: | returns the string representation of the charCode attribute of the |
| | ‘keypress’ event that triggered the behavior (e.g. ‘A’ or ‘a’). |

The real event object has ‘target’ and ‘currentTarget’ attributes, which are node objects. Since these would only be useful in a scripting environment, the “virtual” event attributes ‘targetNodeName’, ‘targetID’, ‘currentTargetNodeName’ and ‘currentTargetID’ are provided.

A keyCode event attribute may be automatically generated in response to the ‘keydown’ and ‘keyup’ events. For ease of authoring, dSVG offers a “virtual” event attribute called ‘keyID’, which is a string identifier for the various keys. These keyID's resemble, as closely as possible, the key identifiers listed in the W3C Working Draft of the DOM Level 3 Events Specification (http://www.w3.org/TR/2003/WD-DOM-Level-3-Events-20030331/keyset.html).

An attribute consists of constant string data concatenated with evaluated expressions delimited by % symbols (a double %% acts as an escape). For example:

attribute=“constant_one% expression_one %constant_two% expression_two %constant_three”

Each resolution expects an expression of the form:

% complex_expression %

where complex_expression can be of the form:

% simple_expression % or:

% simple_expression (complex_expression) simple_expression %

Parentheses are resolved from innermost to outermost. Note that open parentheses require leading whitespace to distinguish them from functions.

An example of a simple expression is:

simple_expression=[string, Unit_Pattern, function, Variable] (OpCode [string, Unit_Pattern, function, variable])*

An esxample of a string is:

string=‘some string data’ resolves to some string data

An example of a function is:

function=functionName(params): resolves to a function return value

The following ECMA math functions are available:

abs; acos; asin; atan; atan2; ceil; cos; exp; floor; log; max; min; pow; random; sin; sqrt; and tan.

Other available functions are:

factorial;
doublefactorial;
gcd (greatest common divisor);
ln;
log10;
if( boolean expression , if_true_expression , if_false_expression );
substring( string, index_start, index_end ); and
length( string ).

An example of a variable is:

variable (form: $variableName)=% expression %

Variables refer to ‘variable’ elements and are intended as a convenient way of building and (re)using complex expressions, or simply for storage. It is the author's responsibility to not create self referential variables or circular variable references.

Operation codes (OpCodes) include:

+ : addition
− : subtraction
* : multiplication
/ : division
, : list separator (ie. for parameters)
== : boolean equals
>= : boolean greater than or equal to
<= : boolean less than or equal to
!= : boolean not equal to

Expressions using opcodes resolve any Unit_Patterns, functions, variables and strings and then follow standard ecma expression rules.

### SYNTAX EXPRESSION EXAMPLE #1

```
<?xml version=“1.0” standalone=“no”?>
<!DOCTYPE svg SYSTEM “../SVGdSVG.dtd”>
<svg xmlns:xlink=“http://www.w3.org/1999/xlink”
xmlns:dsvg=“http://www.corel.com/schemas/2002/dSVG” height=“410px”
width=“744px” onload=“init(evt)” viewBox=“0 0 744 410”>
  <script type=“text/ecmascript” xlink:href=“dsvg/dSVG.js”/>
  <script type=“text/ecmascript” xlink:href=“dsvg/baseUI.js”/>
  <script type=“text/ecmascript” xlink:href=“dsvg/constraint.js”/>
  <script type=“text/ecmascript” xlink:href=“dsvg/focus.js”/>
  <script type=“text/ecmascript” xlink:href=“dsvg/setAttribute.js”/>
  <script type=“text/ecmascript” xlink:href=“dsvg/setStyle.js”/>
  <script type=“text/ecmascript” xlink:href=“dsvg/setTransform.js”/>
  <!-- template -->
  <rect height=“40” width=“744” y=“0” x=“0” fill=“#5f86B1” id=“title_rect”/>
  <text y=“25” x=“20” font-weight=“bold” font-size=“18” fill=“white”
  id=“text_1”>dSVG sample behavior: focus - with added attributes focusGroup and
  focus</text>
  <text y=“365” x=“20” font-size=“12” id=“content”>Content of file: dsvg:focus,
  dsvg:setTransform, dsvg:setAttribute, dsvg:setStyle, (added attributes dsvg:focus,
  dsvg:focusGroup)</text>
  <text y=“380” x=“20” font-size=“12” id=“expected”>The dsvg:focusGroup
  attribute adds the ability to store the ID of similar type elements that are assigned to that
  group.</text>
  <text y=“395” x=“20” font-size=“12” id=“depend”>Default focus can be given to
  an element (red circle above) by adding the dsvg:focus attribute to that element.</text>
  <line y2=“340” x2=“744” y1=“340” x1=“0” stroke-width=“2” stroke=“#5f86B1”
  fill=“#5f86B1” id=“bottom_line”/>
  <!-- adding behavior -->
  <text y=“250” x=“20” font-size=“12” id=“desc”>The red, blue, green circles are
  part of the focusGroup. The orange circle is not.</text>
  <text y=“150” x=“200” font-size=“12” id=“desc_2”>Click on the red, green and
  blue circles to set focus.</text>
  <text y=“170” x=“200” font-size=“12” id=“desc_3”>Hover over the ‘red’, ‘green’
  and ‘blue’ text elements to set focus.</text>
  <dsvg:focus elementID=“redCircle” event=“onclick” id=“circleGroup”>
    <dsvg:setTransform scale=“1.2” vAlign=“middle” hAlign=“middle”
  absolute=“true” elementID=“%circleGroup@elementID%”/>
    <dsvg:setTransform scale=“1” vAlign=“middle” hAlign=“middle”
  absolute=“true” elementID=“%circleGroup@PreviousID%”/>
    <dsvg:setAttribute value=“%(circleGroup@elementID)@fill%Text”
  attribute=“elementID” elementID=“textGroup”/>
  </dsvg:focus>
  <dsvg:focus event=“onmouseover” id=“textGroup”>
    <dsvg:setStyle value=“%(textGroup@elementID)@cdata%”
  property=“fill” elementID=“%textGroup@elementID%”/>
    <dsvg:setStyle value=“black” property=“fill”
  elementID=“%textGroup@previousID%”/>
    <dsvg:setAttribute value=“%(textGroup@elementID)@cdata%Circle”
  attribute=“elementID” elementID=“circleGroup”/>
  </dsvg:focus>
  <circle dsvg:focus=“true” dsvg:focusGroup=“circleGroup” r=“30” cy=“100”
  cx=“50” fill=“red” id=“redCircle”/>
  <circle dsvg:focusGroup=“circleGroup” r=“30” cy=“200” cx=“50” fill=“blue”
  id=“blueCircle”/>
  <circle dsvg:focusGroup=“circleGroup” r=“30” cy=“100” cx=“150” fill=“green”
  id=“greenCircle”/>
  <circle r=“30” cy=“200” cx=“150” fill=“orange” id=“orangeCircle”/>
  <text dsvg:focus=“true” dsvg:focusGroup=“textGroup” y=“80” x=“200”
id=“redText”>red</text>
  <text dsvg:focusGroup=“textGroup” y=“80” x=“250” id=“blueText”>blue</text>
  <text dsvg:focusGroup=“textGroup” y=“80” x=“300”
id=“greenText”>green</text>
  <text y=“80” x=“350”>orange</text>
</svg>
```

Hovering the mouse over the ‘text’ element with id=“blueText causes the behaviors within the second ‘focus’ element to be run. When the first ‘setStyle’ behavior is run, its ‘value’ attribute, which is equal to:

%(textGroup@elementID)@cdata%

resolves to:

%blueText@cdata%

which then further resolves to:

blue

Syntax Expression Example #2
<dsvg:button xlink:href=“dsvg/skinButton_Windows.svg#skinButton” autoScale=“true”
disabled=“false” selected=“false” toggle=“false” height=“18”

width=“100” y=“70” x=“80”

label=“Evaluate” id=“button1”> <dsvg:alert message=“%button1@label

== ‘false’, ‘is selected’, ‘is not

```
selected’) %”/></dsvg:button>
  Pushing the button will run the ‘alert’ behavior. Its ‘message’ attribute, which is
equal to:
    message=“%button1@label + ‘button’ + if(button1@selected == ‘false’,
    ‘is selected’, ‘is not selected’)
which resolves to:
    ”button1@label + ‘button’ + if(false, ‘is selected’, ‘is not selected’)
```

which further resolves to:

Evaluate button is selected

The expression syntax allows a user to refer to real-time values of any attribute of any element in any accessible document or documentFragment easily without a complex syntax like XPath and without script. It also allows a user to manipulate them with mathematical operators and functions, as well as to concatenate them with strings. For instance, if a user had a circle element with id=“myCircle” and a dSVG textbox element with id=“myTextBox”, the user could set the circle's fill colour to be the value of the textBox as follows: <dsvg:setAttribute elementID=“myCircle” attribute=“fill” value=“%myTextBox@value%”/>.

There are many advantages to the SVG interactivity extension system 20, 30. The SVG interactivity extension system 20, 30 assists web designers with no programming skills to create dynamic, interactive web applications. It also aids experienced programmers to create dynamic, interactive web applications much more easily and rapidly. Because the SVG interactivity extension system 20, 30 involves an XML markup language (as opposed to just script functions), the attributes and data and even the elements themselves can be made to be data-driven at run-time, using (at design-time) existing or new software that allows one to visually map input XML markup to output XML markup, resulting in an extensible stylesheet language transformation (XSLT) code (or any other language useful for XML transformations) which will actually modify the designated elements 29, 39 based on the input XML data/markup.

The SVG interactivity extension system 20, 30 can also be natively-implemented, accessing the exposed DOM API's in the same manner as the script implementation. A native implementation could be much faster because unlike script, which gets interpreted at run-time, native code (e.g., C++ or C) gets interpreted at compile time and gets optimized by the compiler. The natively-implemented SVG interactivity extension system 20, 30 could also access any unexposed, lower-level object model API's directly, rather than the exposed higher-level DOM API's, which could further improve performance. If natively implemented, the amount of data needed to be transferred may be greatly reduced, since there is no script that needs to be transmitted, which is especially beneficial for wireless devices with low bandwidth and small memory. Using a markup language for the designated elements 29, 39 is also beneficial because it allows for the possibility of further reducing the file size by creating a binary version of the markup language that employs opcodes-predetermined arrangements of bits (1's and 0's) that correspond to particular element names and attributes. Unlike textual markup, which must be parsed (compared to predetermine strings/text to establish the meaning of the text) in order to create the DOM, binary opcodes can be compared to identical binary opcodes, which is much faster than string comparisons, in order to build the DOM much faster.

The SVG interactivity extension system 20, 30 according to the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A system for extending interactivity of a presentation markup language, the system comprising:
a collection of designated elements, each designated element comprising:
a namespace; and
attributes for describing features of the designated element; and
a collection of associated instructions for performing functions to elements in the document object model, the instructions associated with the designated elements.

2. The system as claimed in claim 1, further comprising an initialization function for directing the processing one or more designated elements in the document object model, having instructions for traversing each node in the document object model and for searching and calling functions associated with designated elements having names following a predetermined naming convention.

3. The system as claimed in claim 1, wherein the designated element is associated with an extensible markup language element.

4. The system as claimed in claim 1, further comprising:
a collection of designated attributes applied to one or more of the document object model elements for applying passive behavior to objects in the web application; and
a collection of associated instructions for performing functions associated with the designated attributes.

5. The system as claimed in claim 4, wherein the collection of designated attributes comprises one or more of:
a ‘drag’ attribute for specifying whether the element is movable by clicking and dragging it with the mouse;
a ‘pan’ attribute for specifying whether the element is immune to panning;
a ‘zoom’ attribute for specifying whether the element is immune to zooming;
a ‘selected’ attribute for specifying whether the element has been selected; and
a ‘selectionGroup’ attribute for specifying an ‘id’ attribute of a <selection> element that this element is associated with.

6. The system as claimed in claim 1, wherein the collection of designated elements comprises one or more of:
flow control elements for controlling statement flow of the web application;
coordinate mapping elements for manipulating coordinates of objects in the web application;
behavior elements for manipulating viewer behavior with respect to the web application;
a focus element for selecting a group of elements in the web application; and
a constraint element for constraining manipulable attributes of an element in a web application.

7. The system as claimed in claim 6, wherein the flow control elements comprise one or more of:
an if element for defining a simple conditional statement which, when it evaluates to true, results in its child elements being executed or rendered;
a switch element for defining a conditional statement, and for comparing one value to other values defined in child <case> elements;
a case element for defining the value to compare to a ‘value’ attribute of the switch element;
a default element for containing action elements to be executed; and
a loop element for defining a repeated sequence of actions.

8. The system as claimed in claim 6, wherein the coordinate mapping elements comprise one or more of:
a mousePosition element for defining a container for holding current mouse coordinates;
a mapCoords element for defining an object used for mapping coordinates in one space to another space, via a polynomial transformation, whose coefficients are determined by the coordinates of point-pairs;
a pointPair element for defining x-y coordinates for a same location in two different coordinate spaces; and
a mapProj element for defining an object used for mapping coordinates in one projection system to another.

9. The system as claimed in claim 6, wherein the viewer behavior elements comprise one or more of:
a zoom element for scaling a document by a factor;
a pan element for translating a document by an amount; and
a playSound element for playing an audio file.

10. A method of extending interactivity of presentation markup languages, the method comprising one or more of the following:
controlling statement flow of a web application, the method comprising the steps of:
searching for a flow control element in a document object model of the web application;
generating a function name associated with the flow control element;
calling the generated function name; and
processing child elements of the flow control element;
coordinate mapping of a web application, the method comprising the steps of:
searching for a coordinate mapping element in a document object model of the web application;
generating a function name associated with the coordinate mapping element; and
calling the generated function name;
manipulating viewer behavior with respect to a web application, the method comprising the steps of:
searching for a viewer behavior element in a document object model of the web application;
generating a function name associated with the viewer behavior element; and
calling the generated function name;
focussing a group of elements in a web application, the method comprising the steps of:
searching for a focus element in a document object model of the web application;
generating a function name associated with the focus element; and
calling the generated function name;
constraining manipulable attributes of an element in a web application, the method comprising the steps of:
searching for a constraint element in a document object model of the web application;
generating a function name associated with the constraint element; and
calling the generated function name; and
applying passive behavior to an element of a web application, the method comprising the steps of:
searching for a designated attribute of the element in a document object model of the web application;
generating a function name associated with the designated attribute; and
calling the generated function name.

11. A method of extending interactivity of a presentation markup language, the method comprising the steps of:
searching for a designated control element in a document object model; and
calling a function associated with the designated control element.

12. The method as claimed in claim 11, wherein the step of searching includes the steps of:
traversing each node in the document object model; and
determining whether an element has a name which follows a designated naming convention.

13. The method as claimed in claim 11, wherein the step of calling a function includes the steps of:
dynamically generating a function name associated with the designated element;
passing an object associated with the designated element as a parameter of the generated function;
retrieving the attributes of the object; and
performing a function stored in memory having the generated function name.

14. The method as claimed in claim 13, wherein the step of dynamically generating includes the steps of:
determining if the name of the designated element contains a designated prefix;
generating a function name comprising of the name of the designated element;
assigning an object associated with the designated element as the parameter of the function; and
assigning predetermined instructions of the designated element as steps for the function to perform.

15. The method as claimed in claim 11, wherein the step of calling a function includes the steps of:
determining which script in a collection of scripts is associated with the designated element; and
calling the script.

16. The method as claimed in claim 11, further comprising the steps of:
searching for a designated attribute in an element in a document object model; and
calling a script associated with the designated attribute.

17. The method as claimed in claim 16, wherein the step of searching for a designated attribute comprises the steps of:
searching attributes of an element in a document object model;
determining whether an element attribute has a name which follows a designated naming convention.

18. The method as claimed in claim 16, wherein the step of calling a script includes the steps of:
determining if the name of the designated attribute contains a designated prefix;
generating a function name comprising of the name of the designated attribute;
assigning an object associated with the designated attribute as the parameter of the function name; and
assigning predetermined instructions of the designated attribute as steps for a function having the function name to perform.

19. The method as claimed in claim 16, wherein the step of calling a script includes the steps of:
dynamically generating a function name associated with the designated attribute;
passing an object associated with the designated attribute as a parameter of the generated function name;
receiving the attributes of the object; and
performing a function stored in memory having the generated function name.

20. The method as claimed in claim 19, wherein the step of dynamically generating comprises the steps of:
determining if the name of the designated attribute contains a designated prefix;
generating a function name comprising of the name of the designated attribute;
assigning an object associated with the designated attribute as the parameter of the function; and
assigning predetermined instructions of the designated attribute as steps for the function to perform.

21. The method as claimed in claim 19, wherein the step of calling a script includes the steps of:
determining which script in a collection of scripts is associated with the designated attribute; and
calling the script.

22. A method of extending interactivity of a presentation markup language by controlling user interface features of a web application, the method comprising the steps of:
adding a behavior element as a child of a designated element;
receiving an event which is equal to an event attribute setting in the behavior element; and
calling a script associated with the behavior element.
